(19) United States
(12) Patent Application Publication
(10) Pub. No.: US 2018/0101762 A1
(43) Pub. Date: Apr. 12, 2018

(54) Graphical interfaced based intelligent automated assistant

(71) Applicant: Pablo Gutierrez, San Rafael Mendoza (AR)

(72) Inventor: Pablo Gutierrez, San Rafael Mendoza (AR)

(21) Appl. No.: 15/837,427

(22) Filed: Dec. 11, 2017

Related U.S. Application Data
(60) Provisional application No. 62/265,668, filed on Dec. 10, 2015.

(51) Int. Cl. G06N 3/00; G06F 3/0488; G06F 3/0485; G06F 9/44; G06F 3/0484

(52) U.S. Cl. CPC G06N 3/006; G06F 3/04886; G06F 3/04847; G06F 9/4446; G06F 3/0485

(57) ABSTRACT

The present invention is an Intelligent Automated Assistant that can be implemented using any of a number of graphical interface operated platforms such as a smartphone to facilitate user interaction with the device by a unique adaptive graphical interface, to manage functionalities of: mathematical calculations; telephony, Smart Dial; Speed Dial of phone numbers, Apps and actions; input of text; definition, Calculation and Management of Time values and their utilization in the creation or edition of Calendar Events, Schedule Reminders/Tasks, Timers and Alarms.

### CROSS-REFERENCE TO RELATED APPLICATIONS

This Patent Cooperation Treaty patent application claims priority to U.S. Provisional Application No. 62/265,668, filed Dec. 12, 2016, and titled “Graphical interface based intelligent automated assistant” the contents of which are incorporated herein by reference in their entirety.

### FIELD OF THE INVENTION

The present invention refers to the Management of Calendars, Reminders, Alarms, Timers, Calculators, Telephony, Virtual Keyboards/Keypads, Smart Dial, Speed Dial and calculation of time, in graphical managing electronic devices; and input methods in digital devices and for classes of applications for intelligent automated assistants.

### BACKGROUND

The development of the present invention results from the analysis of the user experience as he or she interacts with the device (focusing mainly in mobile phone devices).

These interactions are produce mainly:

(a) because the User desires: (1) to input a number (being this number a phone number, a date, etc.), to input a text (either to send a message through any available service, to write a note, to perform a search of any kind, etc.), (3) to talk (either start a voice communication, or impart a voice order to a voice recognition service or a voice recorded for a given purpose, (4) to listen (either listen to a song or a voice from any available source), (5) to see (photos, videos, graphical information, etc., from any available source), (6) to get involved in an experience offered by an App in particular (a game, etc.).

(b) Because the User is interrupted either from a local notification of any service or from an external source like an incoming call of the type and source that the device supports.

In Operating Systems (OS) based on a graphical or touch screen interfaces, the way the user interacts with the device in the above cited cases 1, 2, 3, 4, and 5, is the Conventional Interaction via Objects (CIO)

In the context of this explanation, Objects are icons that represent shortcuts to services or to specific Applications which are installed on the device. For example: to write a new email the user needs to find the icon (Object) that represents the email App, then select it in order to launch the email application, then touch the “new email” button to finally be able to write the new email as the user wanted; to look at a photo the user needs to find the icon (object) that represents the desired photo management App and by resources of that App he or she tries to find the desire photo; or the user could create a shortcut (object) to an specific URL to access a web page. In the cited examples, the icons that represents the shortcuts for both Email and photo Apps are Objects.

In Operating Systems based on Conventional Graphic Interface through objects (CIO), the diversity of designs and colors of Application icons involved (Objects), added to the quantity of icons that fit in the device “home” screens, and also considering the capability of the user to re arrange icon localizations and to group icons in folders, generally ends in confusion and visual noise, stressing the user in the process of identification of icon that the user wants to locate.

Thus, any alternative method that could reduce user stress in both the quantity and types of steps to be carry out by the user to satisfy his or her intentions (“a” type of the interactions as previously explained) should be taken into account.

One of this alternative methods to interact with the device in “a” type interactions (previously explained), is through Voice Recognition based Automated Assistants with the capability to understand user's request via voice and to perform consequent actions as required. Siri in iOS or Google Now in Android are examples of Specific Instruction Interaction (SII) methods.

Beyond both Google Now and Siri are Voice interface based, the user does not have to first appeal to specific objects (icons of an App of Reminders, Messages, Email, etc.), but instead he or she will appeal to the voice recognition capable Automated Assistant to impart an specific voice instruction. For example, send a message to Enrique telling him that I am coming soon, Post . . . to Facebook, Wake me up tomorrow at 7“, Which is Ana's mobile phone number?”, Create Event at 9 PM, etc.

From the User experience point of view, the Specific Instruction Interaction (SII) method is notably more versatile, efficient and quicker than the Conventional Graphic Interface method through objects (CIO).

However Siri and Google Now are “SII”, they have the limitation to be operated via voice, and in many real life circumstances, mostly due to privacy concerns, the user “can't” or does not want to talk to the device. In this cases the user does not have an alternative “SII” method or Assistant so he or she does not have any other alternative to interact with the device rather than dealing with the Conventional Graphic Interface interaction through objects (CIO) method.

B) In another approach, before the touch screen graphical interface revolution in the field of mobile telephony, started mainly by the iPhone and its iOS Operating System, the man-machine interface was based on: physical buttons, a display, a speaker and a microphone.

On one hand, physical buttons allow a limited quantity of actions (single touch and long press) and some other combined actions. For example, in the Windows OS for PCs, using a Qwerty Keyboard to interface with the device, single press on the “delete” button erases the character which is placed on the cursor position, while a long press on the same button erases the character located on the cursor position but also erases, in a persistent, way characters located after the cursor producing that this process of deletion to continue until the user stops pressing the delete button; finally, “CTRL+ALT+Delete” being pressed simultaneously, triggers the Windows Task Manager to be executed.

On the other hand, in graphical interface Operating Systems like Windows, Mac OS, etc., or Touch Screen ones like Android, iOS, Windows phone, etc., it is possible to graphically define buttons and also change their functionality and appearance for a different purpose. Being well designed, this changes of appearance and functionality are perceived by the user according to the context where the button is shown. For instance, in graphical interfaced software calculators, it is common to see the “AC” (Clear All) button after the “CE” (Clear Entry) button was previously selected.

C) Finally, from another approach, it is observed that almost all touch screen interfaced mobile phones, tablets, etc., are sold with preloaded Applications (Apps) related to time management (Calendar, Alarm, Timer), to mathematical calculations (Calculator), storage and management of Contacts, Messages, Mail, mainly. In addition, other Apps can be downloaded and installed from electronic online Stores as is the case of the App and Play Stores.

In the device, the interaction between installed Apps and the OS which managed them, supposes a passage of specific type of data between the Apps and the OS services. For instance, in Android OS, the interaction tool is the “Intent” which serves to transport data to the system and to ask the System for data or to perform an action. The OS responds to those “Intents” in an appropriate way. Data can be an URL, text, number, dates, etc., and actions can be “launch an App”, “dial this phone number”, etc.

Each OS has its own way to interact with the Apps and with the User. For example, according to the kind of user inputs, Android 4.4 OS analyzes which of the installed Apps are able to process those kind of user inputs forcing the user to choose an App after which he desires to continue or terminate the process then originated. If there are three Apps installed that allow the management of photos and the user wants to open an attached photo of a received email, Android, by a dialog box, will force the user to choose among these three apt Apps to visualize photo the desired photos.

In the case of iOS 7.1, while the OS knows which Apps are apt to process each kind of inputs, it does not contemplate the routine to offer the user to choose among available installed Apps to start, continue or finish a process. Thus, every App that pretends to deliver process able data to another App, should now first where to give that specific data in a common language to both those Apps and the OS. In iOS a way to define what to deliver and where to deliver are called URL Schemes. Unlike Android, any App claiming to deliver specific data to another App, must know first the URL Scheme which allows it, after iOS does not offer to the installed Apps URLS to choose from not being the case of Android where by a dialog box the OS gives the user the possibility to start processes in one App to later proceed or finish them by another App.

As will be demonstrated, the present invention, unlike via a Conventional Graphic User Interfaces through objects (CIO), allows the user an Specific Instruction Interaction (SII) experience managed by a new nature of graphical interface Input method (Interface 2000), allowing the user to manage functionalities as: mathematical calculations, telephony, Smart Dial, Speed Dial (not only of phone numbers but also actions), text input, and about the definition and calculation of parameters and values of Time necessary to create Calendar Events, Schedule Task or Reminders, Alarms and Timers.

### SUMMARY

According to various embodiments of the present invention, a Graphical Interface based Intelligent Automated Assistant is implemented on an electronic device, to facilitate user interaction with a device, and to help the user more effectively engage with local and/or remote services. In various embodiments, the present invention engages with the user by an adaptive graphical Interface, and invokes external services when appropriate to obtain information or perform various actions.

According to various embodiments, the present invention integrates and coordinates a variety of capabilities provided by different software components to offer intelligent interfaces and useful functionality to users.

According to various embodiments of The Present Invention, intelligent automated assistant Software components are designed to provide different types of operations, functionalities, and/or features, and/or to combine a plurality of features, operations, and applications of an electronic device on which it is installed. In some embodiments, The Present Invention can perform any or all of: actively eliciting input from a user, interpreting user intent, disambiguating among competing interpretations, requesting and receiving clarifying information as needed, and performing (or initiating) actions based on the discerned intent. Actions can be performed, for example, by activating and/or interfacing with other Software Applications or services that may be available on the electronic device. In various embodiments, such activation of external services can be performed via APIs or by any other suitable mechanism. In this manner, The Present Invention systems of various embodiments of the present invention can unify, simplify, and improve the user's experience with respect to different applications and functions of an electronic device of the like of: mathematical calculations, telephony, Smart dial, Speed dial (not only of phone numbers but also actions), text input, and the definition and calculation of parameters and values of time involved in the creation of Calendar Events, Schedule Reminders/Task, Alarms and Timers.

The invented interface managed by the invented system provide a unified input method to interface and manage Time functionalities of the likes of: Alarms, Timers, Schedule/Tasks Reminders, Calendar and new kind of functionalities or applications related to time. According to the invention, understanding of Time is about moments (Date and Time) along a Timeline, being those moments precisely defined by a “Triple Time Input Method System” which is a new nature of input method with three different approaches to input values of time while having context during the process of time or date definition. Input Method 1 is by the numerical Keypad combined with “/” and “:” time operators; Method 2 by the numerical keypad combined with the period operator; Method 3 touching the Time line panel 32 acting as Panel of dates 32A, Panel of months 32B or Panel of Years 32F; or by the “Period” functionality 332.

In addition, the advanced Time Management functionalities of the “to”, “+”, “−”, “and” Time functions and how the invented Assistant and Interface allows the definition of Time parameters involved in the process of creation and edition of Calendar Events and Schedule Reminders/tasks.

The Present Invention internal processes & software components adapts its graphical interface which becomes a proper Context for the user to continue with his or her inputs or to execute actions in the area of The Present Invention capabilities. Requests for additional input can also be presented as process flow. The system can be implemented using any of a number of different of graphical interface based platforms, such as device APIs. Short and long term memory can be engaged so that the user's input can be interpreted in proper context given previous User inputs, System outputs and available services within a given session.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings illustrate several embodiments of the invention and, together with the description, serve to explain the principles of the invention according to the embodiments. One skilled in the art will recognize that the particular embodiments illustrated in the drawings are merely exemplary. And are not intended to limit the scope of the present invention.

FIG. 1 is a block diagram depicting Assistant 1000 System.

FIG. 2 illustrates Interface 2000 initial view.

FIG. 3 illustrates the sectors of Interface 2000.

FIG. 4 shows the action produced after the user touches any of the five buttons of the Side Dock of Interface 2000.

FIG. 5 is an example of the process of linking a Calendar App with Assistant 1000 in Android 4.4 Operating System.

FIG. 6 exemplifies Vertical Scroll Implementation of the Timeline Panel of Interface 2000 and how it is an informative means for the user about time related events.

FIG. 7 exemplifies Horizontal Scroll implementation of the Timeline Panel of Interface 2000.

FIG. 8 exemplifies how Assistant 1000 by its Interface 2000 reacts to user's action of scroll on the Timeline Panel.

FIG. 9 exemplifies how the user can define a date through the Panel of Dates or by the Numerical Keypad combined with the Date Bar “/” operator.

FIG. 10 exemplifies how the user can define a date after the Period functionality.

FIG. 11 is an example of Process Flow and Context Achieved which results after a date has been defined by the user.

FIG. 12 exemplifies how the user can enter a Time after a date has previously defined.

FIG. 13 exemplifies how the user starts its inputs defining a time by the Numerical Keypad combined with the Time Dots “:” operator and next define a Date through the Panel of Dates.

FIG. 14 exemplifies subsequent actions related “Calendar” Management after Time values have been defined by the user.

FIG. 15 exemplifies subsequent actions related “Schedule Reminders” Management after Time values have been defined by the user.

FIG. 16 exemplifies how the user can enter a phone number by Interface 2000 and subsequent actions.

FIG. 17 exemplifies how the user can use Assistant 1000 and its Interface 2000 to dial a phone number to call it by Skype.

FIG. 18 exemplifies how the user can use Assistant 1000 and its Interface 2000 to perform Mathematical Calculations and also shows Interface 2600 (Calculator Mode).

FIG. 19 exemplifies how the user can execute shortcuts by Assistant 1000 and its Interface 2000.

FIG. 20 exemplifies how the user can create shortcuts about phone numbers and App related actions.

FIG. 21 shows the initial view of interface 2100 in a product definition where the “TextStart” functionality were enabled.

FIG. 22 exemplifies how Assistant 1000 and its Interface 2100 handles user inputs when the “TextStart” feature is enabled.

FIG. 23 shows the Text Input Interface of Assistant 1000 and how it is accessed through interface 2100 (TextStart functionality enabled).

FIG. 24 shows the initial view of Interface 2200 after the user has defined a date and the functionalities of Advance Time Management Operators available.

FIG. 25 exemplifies how the user can get value of the “To” Time Operator to define two Dates and subsequent Calendar Actions that can be performed.

FIG. 26 exemplifies how the user can get value of the “To” Time Operator to define a Date and also a start and end times and subsequent Calendar Actions that can be performed.

FIG. 27 exemplifies how the user can get value of the “+” Time Operator to add a Period of time to a predefined Date and subsequent Calendar Actions that can be performed.

FIG. 28 exemplifies how the user can get value of the “+” Time Operator to add a Period of time to add a period of time to a predefined Date-Time string.

FIG. 29 exemplifies how the user can get value of the “−” Time Operator to subtract a period of time from a predefined date and subsequent Calendar Actions that can be performed.

FIG. 30 exemplifies how the user can get value of the “and” Time Operator to group dates or dates/times and subsequent Calendar Actions that can be performed.

FIG. 31 synthetizes the consequent actions the user can perform through Assistant 1000 after previously defined a date.

FIG. 32 shows the Time related parameters involved in the Creation of Calendar Events that can be defined through Assistant 1000.

FIG. 33 exemplifies how the user can define and Manage Event Alerts through Assistant 1000. This figure also shows the initial views of Interface 2300 (Event Creation Mode and Interface 2400 (Event Alert Mode)

FIG. 34 exemplifies how the user can define and Manage Event Alerts through Assistant 1000.

FIG. 35 exemplifies how the user can define and Manage Event Alerts through Assistant 1000. This figure also shows the initial view of Interface 2500 (Event Repetition Mode).

FIG. 36 exemplifies how the user can define and Manage “Event Repetition Schemes” through Assistant 1000.

FIG. 37 exemplifies how the user can define and Manage “Event Repetition Schemes” through Assistant 1000.

FIG. 38 exemplifies how the user can define and Manage “Event Repetition Schemes” through Assistant 1000.

FIG. 39 shows a sample panel of New Event Creation of the iOS 7 Calendar App for iPhone 5 where it has been added a button to access Interface 2000 to get benefit of Assistant 1000 to Edit the Time parameters involved in previously created Calendar Events.

FIG. 40 shows the initial view of “Interface 2700 (Month/Year Management functionality).

FIG. 41 exemplifies how the user can get value of Assistant 1000 and its Interface 2700 (Month/Year Management functionality).

FIG. 42 exemplifies the “Restore” functionality of Assistant 1000.

FIG. 43 shows Interface 2000 Full Calendar View.

FIG. 44 shows the Multiple Event Creation Panel and its interaction with Assistant 1000 and Calendar App.

### DETAILED DESCRIPTION (OR DETAIL DESCRIPTION OF THE EMBODIMENTS)

Headings of sections provided in this patent application and the title of this patent application are for convenience only, and are not to be taken as limiting the disclosure in any way.

Various techniques will now be described in detail with reference to a few example embodiments thereof as illustrated in the accompanying drawings. In the following description, numerous specific details are set forth in order to provide a thorough understanding of one or more aspects and/or features described or reference herein. It will be apparent, however, to one skilled in the art, that one or more aspects and/or features described or reference herein may be practiced without some or all of these specific details. In other instances, well known process steps and/or structures have not been described in detail in order to not obscure some of the aspects and/or features described or reference herein.

As it will be demonstrated in this patent application the present invention is a Graphical Interface Based Intelligent Automated Assistant which interfaces with the user through a Smart Adaptive Keypad Interface. For a better handling and understanding of terms, “Interface 2000 and its variations 2100, 2200, 2300, 2400, 2500 and 2700” will refer to the Smart Adaptive Keypad Interface; and “Assistant 1000” will refer to the Intelligent Automated Assistant Internal Processes and Software Components as a System.

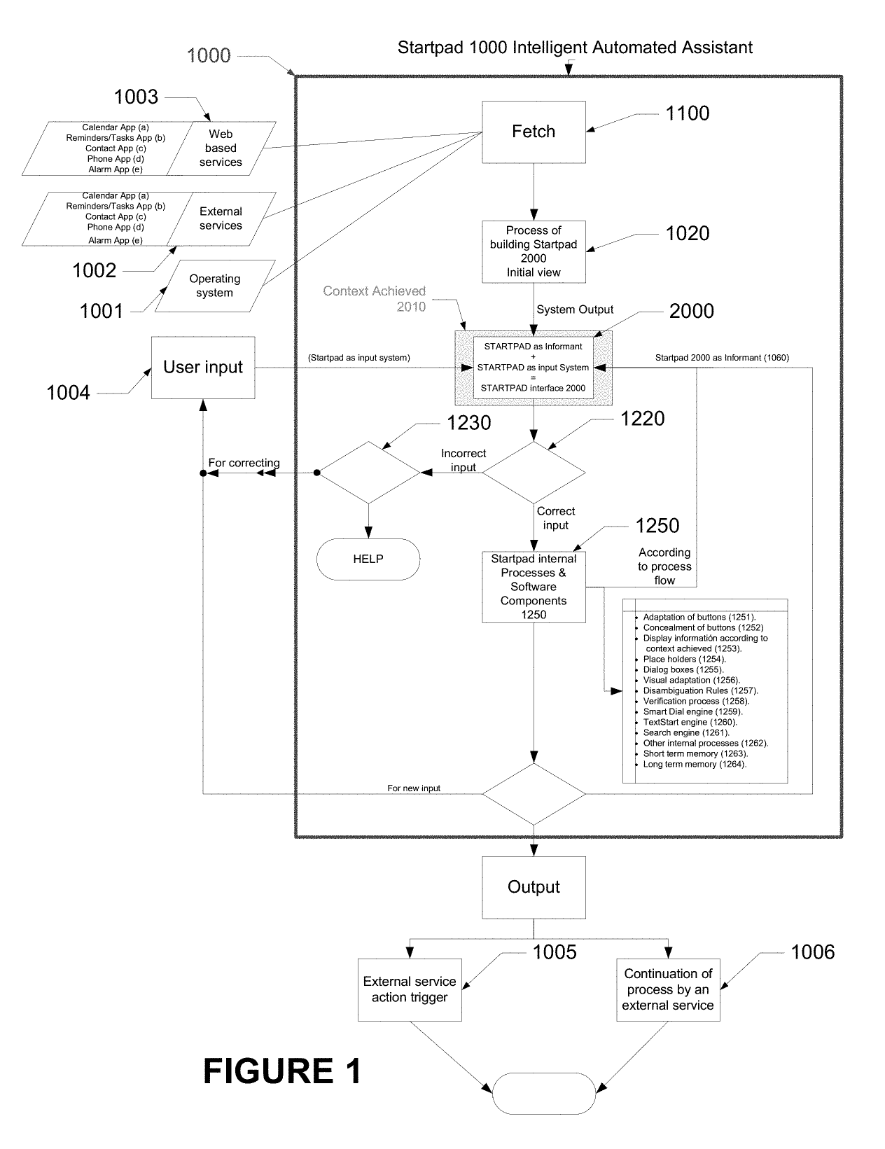

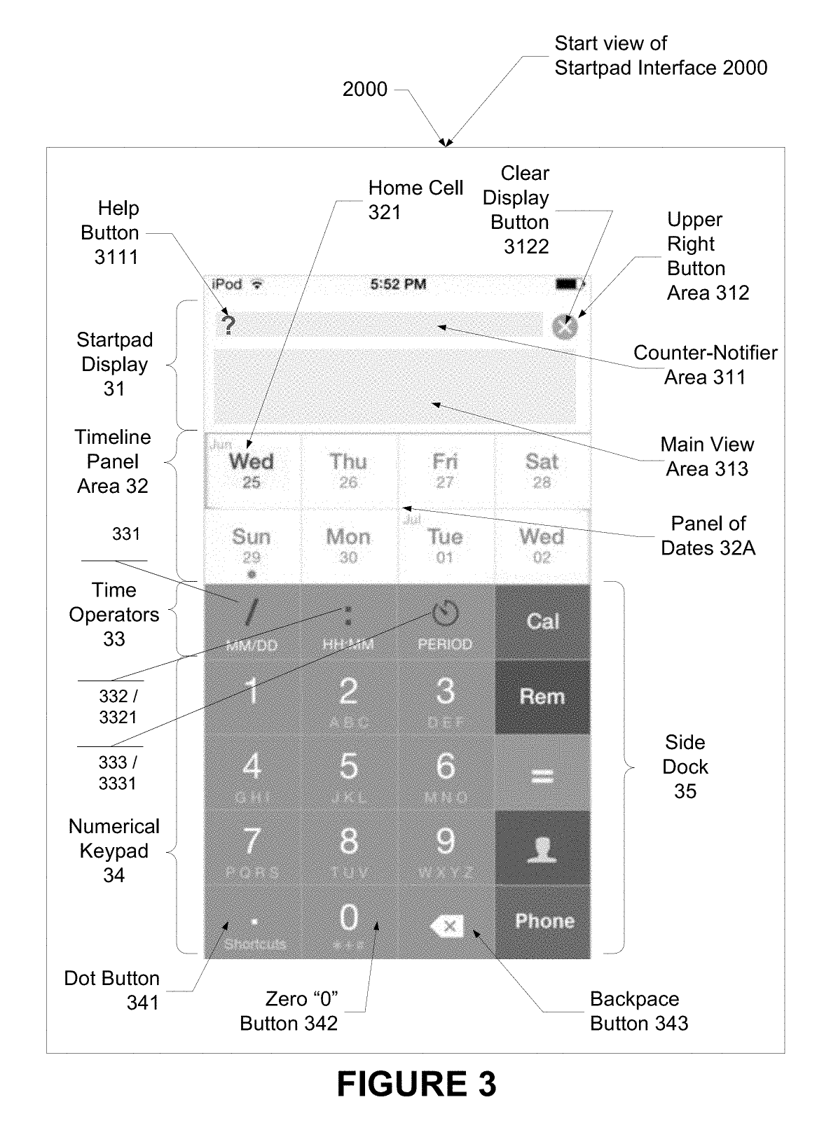

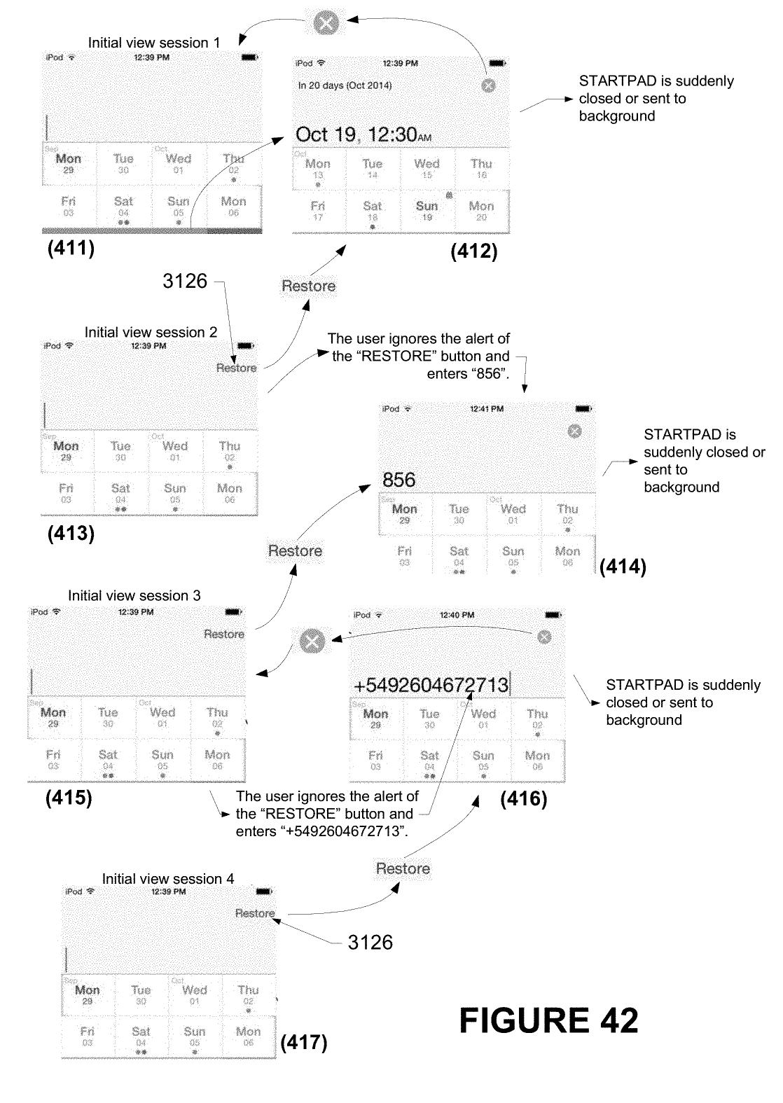

For better understanding of this Patent Application, the references for objects (Screenshots, etc.) shown from FIG. 1 to FIG. 42 are referred as numbers in brackets. Numbers which are not shown in brackets are references assigned to easily identify and locate essential parts (buttons, views, initial views, etc.) of Interface 2000 Smart Adaptive Keypad Interface and or stages, processes, etc. of Assistant 1000. It is recommended to have FIG. 1 and FIG. 3 on hand as they include references in the detailed description of this patent application.

FIG. 1 shows Assistant 1000 which has the capacity of interaction (1100): with the OS (1001), with external services (1003), local (1002) and/or web based (1003) Apps/Services in order to provide necessary information for Assistant 1000 to perform the startup initial process (1020) to consequently build the Interface 2000 initial view which will result to the user both in an informative means and also in a new nature of input method.

User inputs 1004 will be interpreted by Assistant 1000 according to type and quantity criteria 1220.

On one hand, notwithstanding Assistant 1000 adapts Interface 2000 to allow only correct inputs, sometimes leads the user to correct wrong inputs, or to get value of system Help 1230.

On the other hand, correct inputs will be processed 1250 to adapt Interface 2000 as process flow achieving its double functionality of being itself both an Information Means and also an Input Method for the user additional inputs 1004 to continue with her or his intentions.

According to Process Flow and Context Achieved 2010 (further explained), new nature of functions could be available in Interface 2000 which could constitute themselves in new kind of user inputs 1004.

When needed, Interface 2000 will change the appearance and/or functionality of some of its buttons adapting them to the Context Achieved 2010 (further explained); while preserving its unique visual display layout in order to avoid disruption to the user.

The Context Achieved 2010 is a result of process flow and it is built after: (a) concealment of then unnecessary buttons 1252, (b) the transformation of other buttons into others 1251 to allow necessary or optional additional user inputs 1004 according to Context Achieved 2010, (c) Place holders 1254 which is a text string resource used by Interface 2000 to suggest the User one or more possible inputs according to the Context Achieved 2010, (d) Dialog boxes 1255 which are used according to Context Achieved 2010 to avoid inappropriate wrong user inputs, (e) Interface 2000 Display information (further explained), (f) other Software Components 1262, (g) short term memory 1263, (h) Long term memory (Intersessions Memory) 1264.

According to process flow and Context Achieved 2010 (further explained), Interface 2000 is a means of information itself 1060 according to Context Achieved 2010 so the information it provides could be enough to satisfy user's desires, so Interface 2000 could be interpreted as a kind of System output.

Assistant 1000 other outputs are about an external service or OS action trigger (1005) or the continuation of process by an external service (1006) with which the user will interacts.

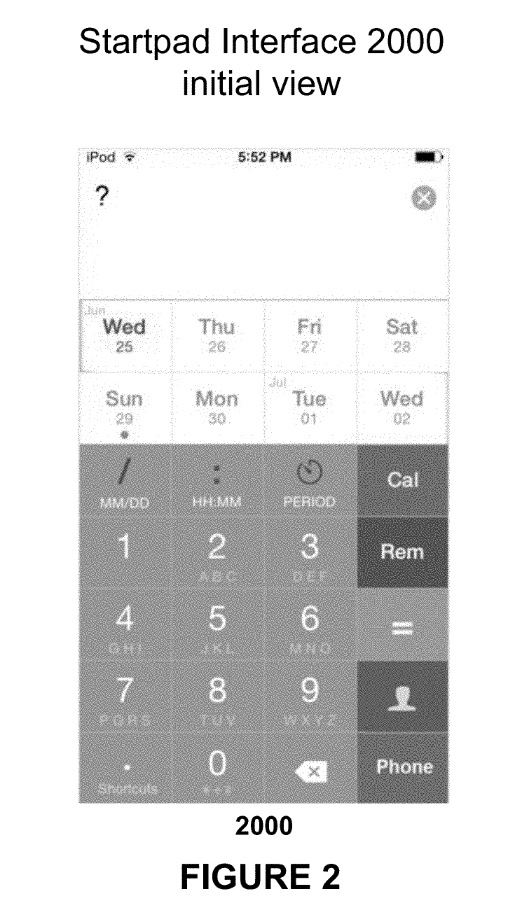

FIG. 2 shows Interface 2000 initial view:

As will be demonstrated, from and through a unique smart adaptive keypad interface 2000, Assistant 1000 allows the user to manage functionalities of mathematical calculations, of telephony, of smart dial, of speed dial of phone numbers and actions, of text input, and the definition and calculation of time parameters necessary for the creation of Calendar Events, schedule Reminders/Tasks, Timers and Alarms.

Linking Apps with Assistant 1000

As was explained in FIG. 1, Assistant 1000 fetches data 1100 from the OS 1001 for: (a) Accessing data as Date, Time, Location, etc.; (b) Accessing the needed information to perform related processes, as it is the case of accessing Contacts information which were stored in Device or in a remote server; (c) accessing Apps 1002 and 1003 with the aptitude to be linked to Assistant 1000, as for example Apps that allow the management of the stored Contacts in Device, as to execute or perform certain actions 1005 such as placing a phone call, send an email, etc. (Further explained).

The first time Assistant 1000 is executed, it will start an internal process needed to identify the available services and Apps 1002 and 1003 according to the Assistant 1000 capabilities to consequently fetch 1100 data as required.

Primary Linked Apps

As part of this presentation, Primary linked Apps refers to those Apps which are able to process values of time, as Calendar, Reminders/Tasks, Alarms and Timer; Calculator Apps; Contacts Management Apps; and conventional or IP based Telephony Apps. As it will further explained, the five buttons of the side dock 35 will be assigned to Primary linked Apps.

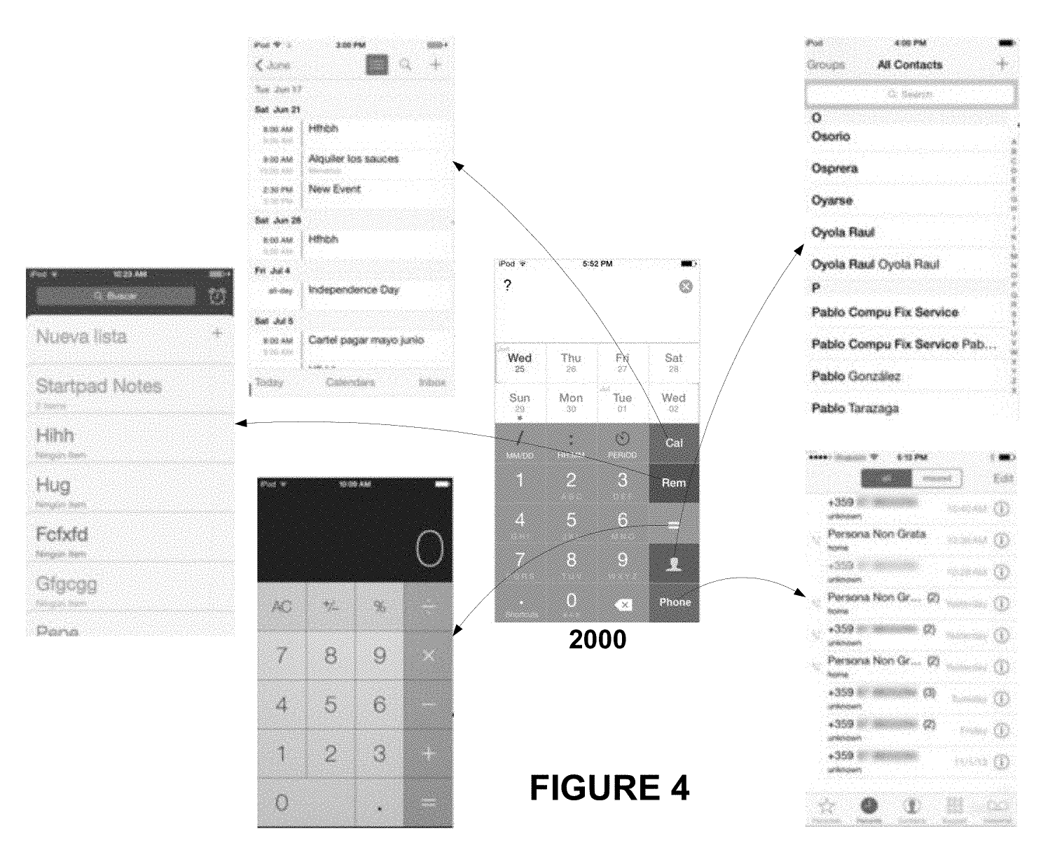

Each time Assistant 1000 is executed, having the user previously entered no value, touch any button of the side dock 35 (further explained) of Interface 2000 initial view, will produce the linked App to be opened (FIG. 4).

The process of linking Applications to Assistant 1000 depends on the own characteristic of the OS where Assistant 1000 and the OS privileges granted to Assistant 1000.

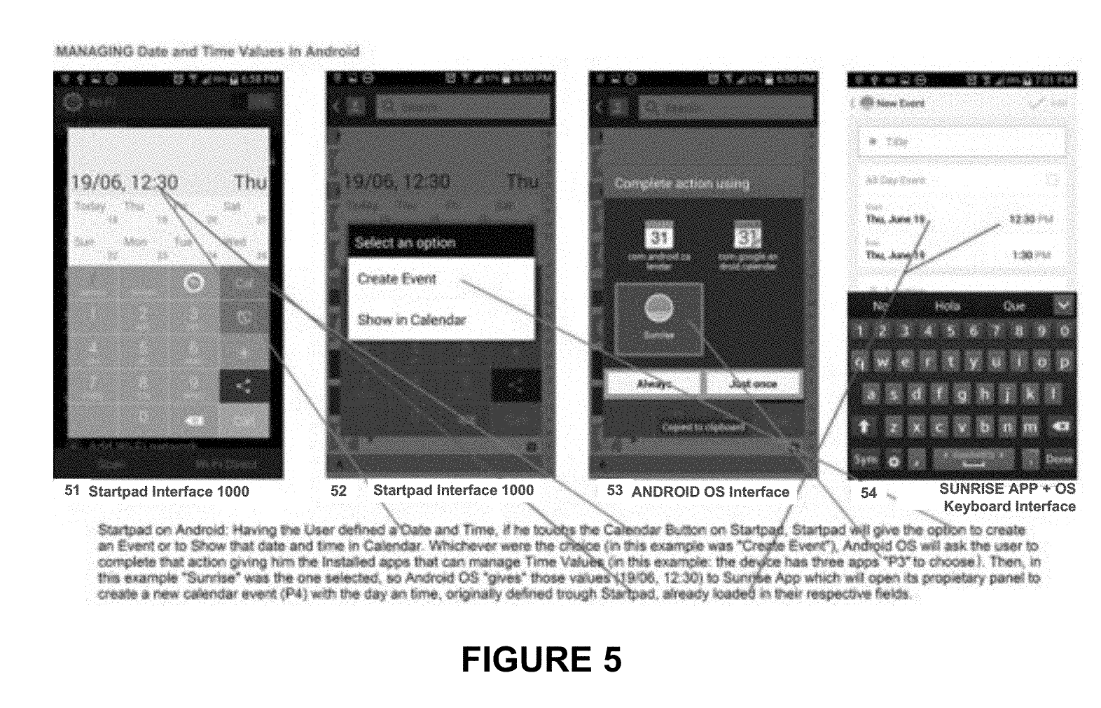

FIG. 5 “Managing Date and time values in Android” is an example of the process of linking a Calendar App with Assistant 1000 where (51) shows the process after which Android OS, having the user previously defined a date and time string by Interface 2000 (process that will be further explained) and subsequently choosing “Create Event” in the Dialog Box 1255 showed in (52). After this Assistant 1000 petition to the OS, Android OS interface will show a dialog box (53) giving the user the possibility to choose which of the installed calendar Apps he or she desires to complete the action with. This way and through the dialog box showed by Android interface (53), the user will choose the App that will be linked to Software Assistant Module 1000 to its Interface 2000 “Calendar Button” 351 of The Side Dock 35, to the extent that choice is always. If in (53) the user chooses “just once”, this same dialog box will be showed by Android each time a similar situation occurs. (54) shows the resultant view of having the user chosen “Google Calendar” App in (53) what will make Android launch the Google Calendar App proprietary interface to create a New Event showing preloaded the Date and Time “19/06, 12:30” that the user had entered with Interface 2000.

In the case of iOS Operating System, due to its modus operandi, the possibility of Assistant 1000 to access applications will depend on granted permissions and privileges. In iOS, by the management of URL Schemes, necessary links can be created but it is not the Operating system (iOS) which asks the user (unlike Android) to choose the App. Instead, Assistant 1000 will have to, find among installed Apps which of those are enable Apps to received data/values pre-loaded/processed by Assistant 1000, values that will be necessary delivered according its respective URL Schemes. By what has been said, each time Assistant 1000 is executed, in the background Assistant 1000 will require the OS to check if the linked Apps remain installed. Having a previously linked Application been uninstalled from the OS, Interface 2000 will give the user the possibility to choose an App among the others available including Apps that were installed after the previous session of Assistant 1000.

As previously explained, the majority of touch screen interface OS devices are sold with preloaded Apps with which Assistant 1000 needs to interact, as it is the case of Calendar, Reminders, Alarms, Timers, Contacts, and Telephony Apps, mainly. Guaranteed access to the information that Assistant 1000 needs to work, as for example access to the Contacts that are stored in the device, but not guaranteed the usage of the corresponding Apps graphical interfaces, in this cases graphical interfaces should be built.

For example, a definition of Interface 2000 could assume that the Calculator Functionality and interface (further explained) were built as Assistant 1000 so Assistant 1000 won't need to link a Calculator App to perform mathematical calculations after values preloaded by Interface 2000 (further explained”).

According to the quantity and quality of permissions and privileges that every OS grants to Assistant 1000 and also those of the App that the user desire to link to Assistant 1000, it will result the final characteristic of the user experience achieved by Assistant 1000, while some processes started by Assistant 1000 can or must be finished in App with a proprietary interface or of those of the linked Apps. What has been said does not affect at all the characteristic of Assistant 1000 and its Interface as inventions.

1) Sectors of Interface 2000 (FIG. 3):

The Interface 2000 can be Graphical or touch screen based and it is composed by the following sectors:

Display 31, Timeline Panel 32, Time Operators 33, Numerical Keypad 34 and the Side Dock 35.

1.1) Display 31:

It has three subsectors: the Counter/Notifier 311, the upper right button 312, and the main view Area 313.

The main view area 313 shows both the User's input and Visual System outputs.

The counter/notifier 311: It's a system text string which contextually informs user inputs and system outputs. In Interface 2000 initial view, it could be showed as the “Help” button 3111.

The appearance of the Upper Right button 312 varies according to Process Flow. The majority of the times its function and appearance is as “Clear Display” button 3121, though according to the Context Achieved 2010 it could also become a different purpose button.

1.2) Time Operators 33:

This area is composed by three buttons: The “Date Bar” button 331 represented by “/”, the “Time Dots” button 332 represented by “:” and the “Period” button 333.

The Date Bar “/” button 331 allows the user to define date values utilizing the 4×3 grid numerical Keypad. For example, 06/18 means “June 18” to Assistant 1000 System.

The Time Dots “:” button 332 allows the user to define time values utilizing the 4×3 grid numerical Keypad, fur example, 12:30;

The “/” and “:” buttons becomes AM 3321 and PM 3331 buttons respectively according to the regional format of Date and Time set in the OS where Assistant 1000 were running and also according to Assistant 1000 Internal processes 1250 and Context Achieved 2010 (further explained). This symbols may varies according to regional formats though its functionality remains the same. Same reasoning is about how to show the string of date, time.

1.3) Numerical Keypad 34

The numerical Keypad 34 can be configured according the kind of product to be built. For instance, for T9 functionality, the Telephone 4×3 Dial pad with letters labels bellow numbers should be adopted, if not, a calculator layout placing button number 1 in the bottom left sector of the keypad could be adopted. In graphical or touch screen Operating Systems, the action that produces each button of this Keypad is function of the kind of touch that the user performs on it, could be single touch, long press, up/down vertical scroll (Swipe), left/right horizontal scroll (swipe) or any other method that could be available . The effect produced by each of those actions on a given button are configurable (further explained). In a dial pad configuration, labels are shown in the bottom sector of each button of the numerical Keypad 34, which by default are the conventional letters found in 4×3 Telephone Grid Keypads. Interface 2000 can also show names assigned to “Shortcuts” that the user had assigned to those buttons (further explained). The dot button “.” 341 is accessed by single touch on it while a long press could become the “Shortcut” button 3411. The zero “0” button 342 is accessed by single touch on it while a long press would become the “#+*” buttons 3421 needed for phone dialing. Touching the Backspace button 343 produces the deletion of the last character entered by the numerical keyboard.

1.4) Side Dock 35:

This dock of buttons are those assigned to “Primary Linked Apps” with which Assistant 1000 interacts to complete actions or continue processes through them. Primary linked Apps buttons can be also used as a direct access to those Apps when are touched having previously entered no value. Depending on the modus operandi of each OS and or the incorporation of a specific functionality of Assistant 1000 (for example: Smart Dial, Text writing and Search) it will be the definition of the specific function assigned to each button of the Side Dock 35.

1.5) Timeline Panel 32

It's Interface 2000 graphical representation of Time where the user will go back and forward through time by scrolling on a grid of cells. Each time unit corresponds to a unique cell.

1.5.1) Timeline Panel 32 physiognomy:

The Timeline Panel 32 can be defined in different ways, for instance according to the own characteristic of the OS with respect to the kind of scroll that the OS allows and appropriate to the ergonomics of the OS, as to the size of the screen of the devices where Assistant 1000 were installed. The amount of cells and rows where these cells are distributed does not affect the nature of the Interface 2000 unique multipurpose interface being solely a variation of its visual display layout.

In this Patent Application, the Timeline Panel that is taken as an example is the Standard Timeline Panel” 32 configuration which is composed by a grid of eight cells located in two rows and with two different kind of scroll movement through Time, being one vertical scroll and the other horizontal scroll.

The Standard layout of Interface 2000 results in an appropriate balance between the quantity of elements involved in the graphical interface and the information provided by those elements (mainly by the Timeline Panel 32).

As it will be further explained, the Interface 2000 Timeline Panel 32 can be shown as Panel of dates 32A, Panel of months 32B, Panel of Years 32C, and also will be presented with other variations to be able to define Alerts and set Repetition Schemes in the creation of Calendar Events through Assistant 1000 by its interface 2000.

The Standard layout of Interface 2000 shows in the Timeline Panel 32 as the Panel of Dates 32A assigning the Date which correspond to Present Time “Today” in the “Home cell” 321 plus seven dates in advance (one week) which results in a total of eight elements (8 cells/dates) becoming an ergonomically convenient real life context of present time. According to the kind of user experience that wanted to be achieved, Interface 2000 initial view can be defined after a Panel of Dates 32A showing Monday on cell 1, Tuesday on 2, Wed on cell 3, Thu on Cell 4, Fri on Cell 5, Sat on cell 6, Sun on cell 7 and next Monday in Cell 8 and “Today” on the correspondent cell (day of the week which is Present Time).

As it is shown in FIG. 3, the “Home cell” 321 is the Cell located In the upper left corner of the Timeline Panel 32A and it is the cell which date refers the “Counter/notifier” 311 which in this Context Achieved indicates how far from present time is the date that it is shown on the “home cell” 321 of the Panel of dates 32A. In this patent application, examples will show red font to distinguish Today from the rest of the dates and Black font to identify both the selected date and the date which is shown in home cell 321 (but Today which is always shown in red), as it will be further explained. Font for the rest of the dates will be shown in gray color.

1.5.2) Scroll: Interface 2000 admits two different configuration of scroll movement of the Timeline Panel 32: a Vertical Scroll and a Horizontal scroll. To adopt one or the other will depend on the characteristic of the product to be defined after the present invention as also of the actions that triggers the different kind of movements of swipe in the different Operating Systems.

For example, being Assistant 1000 defined as widget in Android OS, the scroll must be necessarily defined as Vertical Scroll, after in Android the action of horizontal scroll does not produce effect inside a widget but it reacts as Scroll to another “Android Home Screen”. Thus, in Android as widget, the scroll of the Timeline Panel 32 should be defined by Vertical Scroll movement.

This two modalities of Scroll, horizontal or vertical, don't make sense to be both operable in a same definition of product as it would produce two different kind of visual perceptions of the same output of the system what would end confusing the user. Consequentially, in a same definition of product of Assistant 1000, the Scroll functionality of the Timeline Panel 32 must define as vertical or horizontal, but not both at the same time.

1.5.2.1) Vertical Scroll:

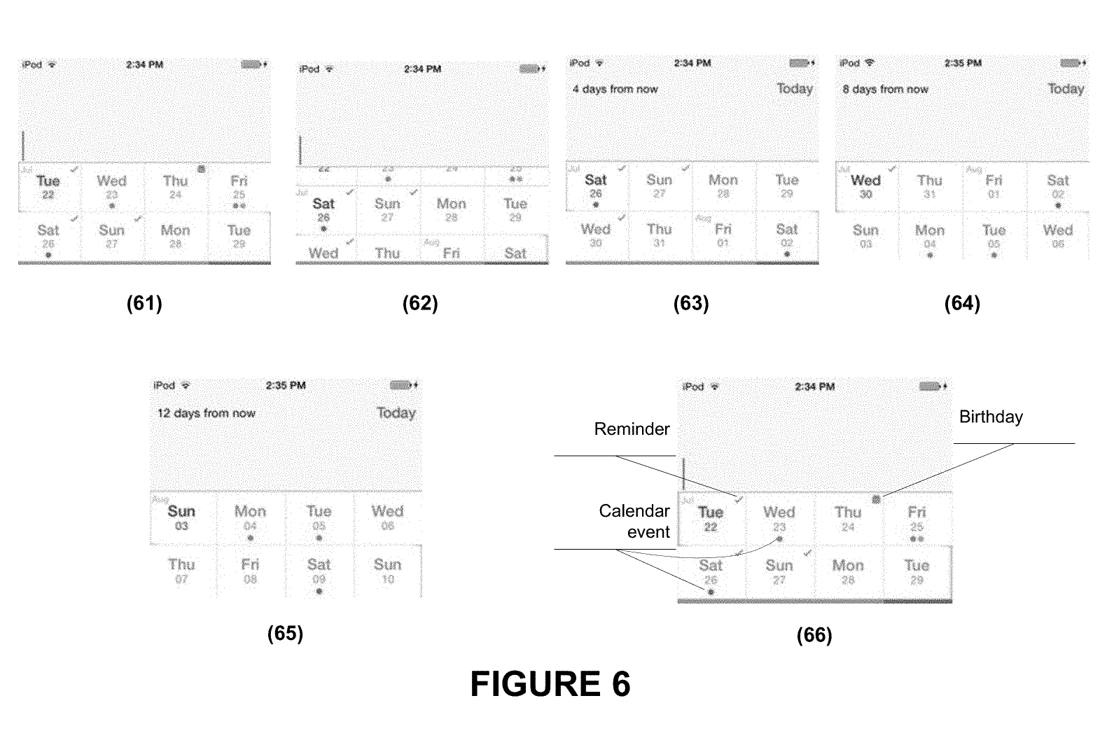

In FIG. 6, the Timeline Panel 32 is shown as Panel of Dates 32A.

(61) shows the Panel of Dates 32A in Interface 2000 initial view showing “Today” in cell 1.

(62) shows the transition after a vertical scrolling from (61) to (63).

(62) shows the status of the Panel of Dates 32A when by a soft vertical scroll the Panel of Dates 32A ends in central area at mid distance, what will produce an automatic relocation by proximity to match the exact central area. The “counter/notifier” 311 will refer to cell 1 “home cell” 321 of center line “Sat 26”.

(64) and (65) shows how views results by the user's action of vertical scrolling and the consequent reference of the counter/notifier 311.

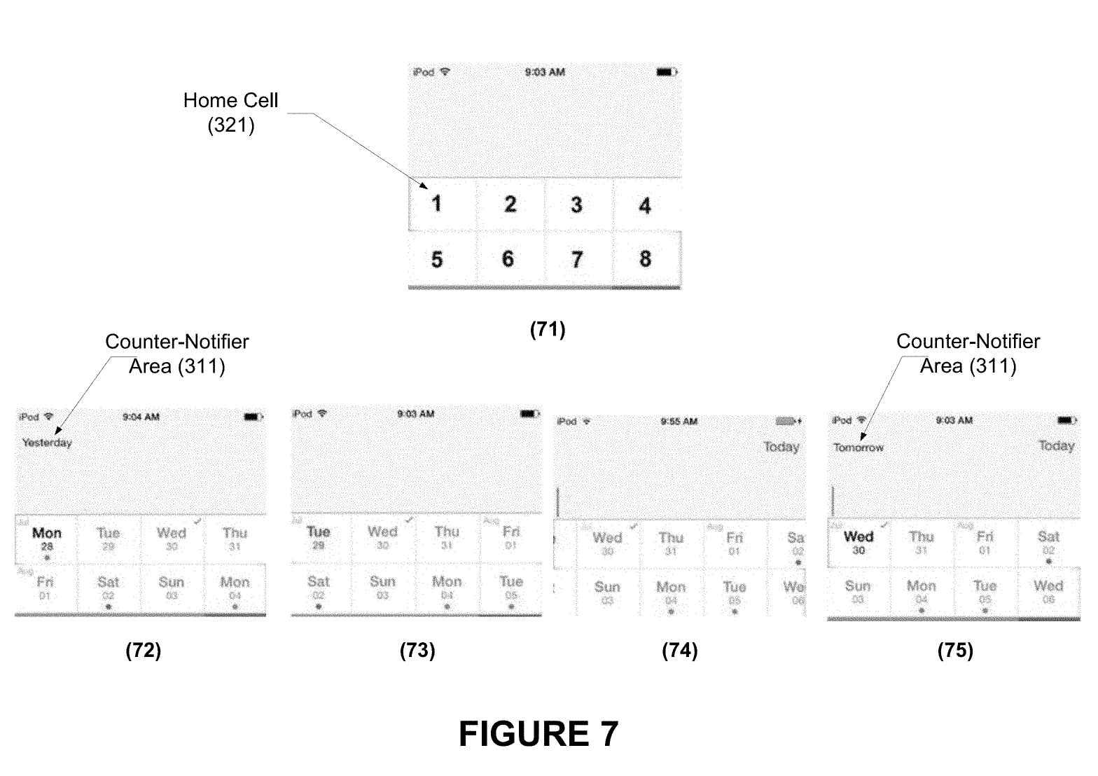

1.5.2.2) Horizontal Scroll: FIG. 7

From here on, all examples and explanations about Panel of Dates 32A suppose the Standard layout of Interface 2000 of the Timeline Panel 32 consisting of 8 cells distributed in two rows, showing “Today” in the home cell 321 and with horizontal scroll as the way to go forward and backward in time.

Horizontal Scroll, behavior:

In Interface 2000 initial view, “Today” is shown in Home Cell 321 which is Cell 1 (71).

(75) shows the case where the user scrolls the Panel of Dates 32A to the left in (73) moving only one cell, what makes that Today “Tue 29” is not visible anymore and where “cell 1” (71) is occupied by the date which was previously located in “Cell 2” in (73) “Wed 30”. As the Counter/notifier 311 refers to Cell no 1, in (75) informs “Tomorrow”.

(74) shows the transition from (73) to (75) which results after scrolling by just one cell. The Date “Sat 02”, which was previously located in Cell 5 is now located in Cell 4 (75). (74) also shows that “Sat 02” is not visible anymore in Cell 5 at the same time it start being visible in Cell 4 generating a visual sensation of continuity of the scroll between the upper and lower rows of the Panel of Dates 32A.

(72) shows the case where the user makes horizontal scroll to the right, what “brings” the date which belong to Yesterday “Mon “to Cell 1 which will be highlighted and consequently moving Today “Tue 29” to cell 2 . Then, the counter/notifier 311 will refer as always to the date which is in Cell 1 “Yesterday”. Thus, “Fri 01” is not visible anymore in Cell 4 at the same time it starts being visible in Cell 5.

Every time the Panel of Dates 32A is scrolled, the “upper right button” 312 becomes the “Today” button 3121, the counter/notifier 311 will inform how far from present time is “located” the date that is shown in “Cell 1”also indicating month and year.

In Interface 2000, the advance in time of the Panel of Dates 32A as results of swipe actions is according to how fast the swipe action is made by the user because of touch screen graphical interfaces with the aptitude to process swipe gestures, the action of scrolling fast breaks the visual context previously shown, so it is helpful that when the scroll stops, the resultant view be quickly understood by the user. That is why after a swipe action Interface 2000 always stops the scroll showing a “Monday” in home cell 321 (Cell 1) what results in 1 week in advance starting always on Monday, what is a life like context for the user.

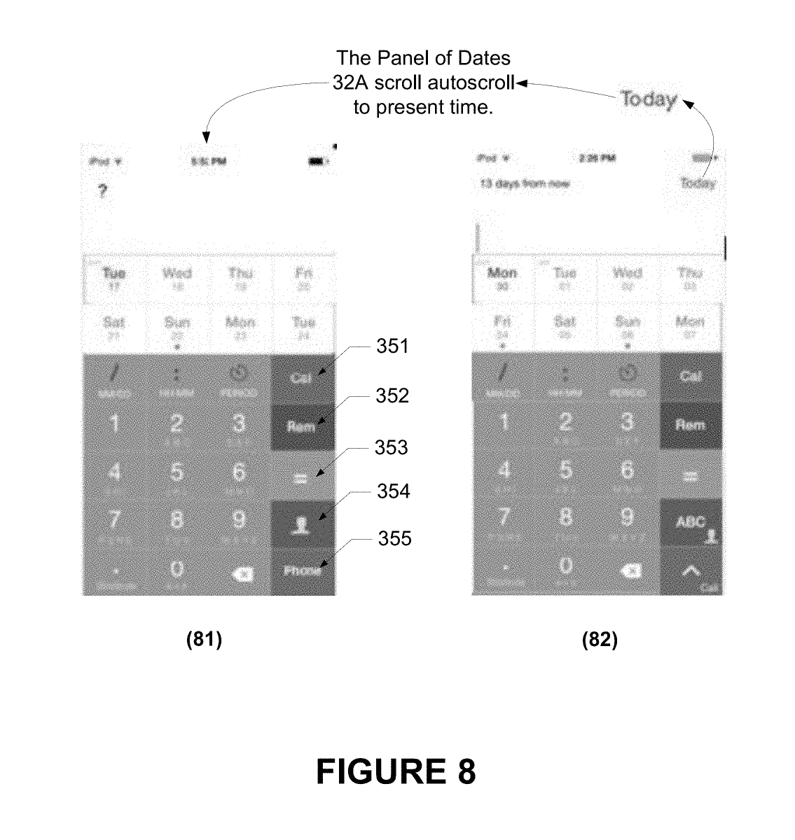

In FIG. 8, (81) shows the initial view of Interface 2000 where Today it is supposed to be “Tue 17 of June” of present year. (82) shows this situation where in (81) by a scroll or swipe action to the future, the 30^{th} of June ends in home cell 321 (Cell 1) so the counter/notifier 311 indicates “13 days from now”. If consequently in (82) the user touches the “Today” Button 3121, the Panel of Dates 32A will scroll itself backward in time to show (81).

Scrolling the Panel of Dates 32A but not selecting a specific date (further explained), although it shows a past/present Context, it is not considered as start point of any process yet by the system. That's why all the buttons of Interface 2000 remain visible and available with all its capabilities.

1.5.3) The Panel of Dates 32A as Notifier:

The Panel of Dates 32A, in addition to be a means of selection, it is also a notifier of Calendar Events, Schedule Reminders and Birthdays of the Calendar App linked to Assistant 1000 and with which Assistant 1000 interacts. This notifications are represented by different icons and colors which allow the user to distinguish Calendar events, Schedule Reminders, Birthdays, Holidays, etc.

In FIG. 6 (66) shows the initial view of the Panel of Dates 32A of the Standard layout of Interface 2000. Today is shown in Cell 1, consequently the label of Today is in red “Tue 22”.

(66) shows how The Panel of Dates 32A is also a media of notifications. The Schedule Reminders of the linked App are represented by checks; calendar events of the linked Calendar App are represented by colored dots according to the color of each calendar; and birthdays are represented by an icon of a present package.

This way, without being necessary to open the linked Apps, the user can have an idea of days with Events, Schedule Reminders and/or Birthdays and also free days.

The Panel of Dates 32A of the Standard layout of Interface 2000 (shown in FIG. 3) results appropriate in displays from 3.5 inches and larger, as it allows to display those icons and fonts in legible size.

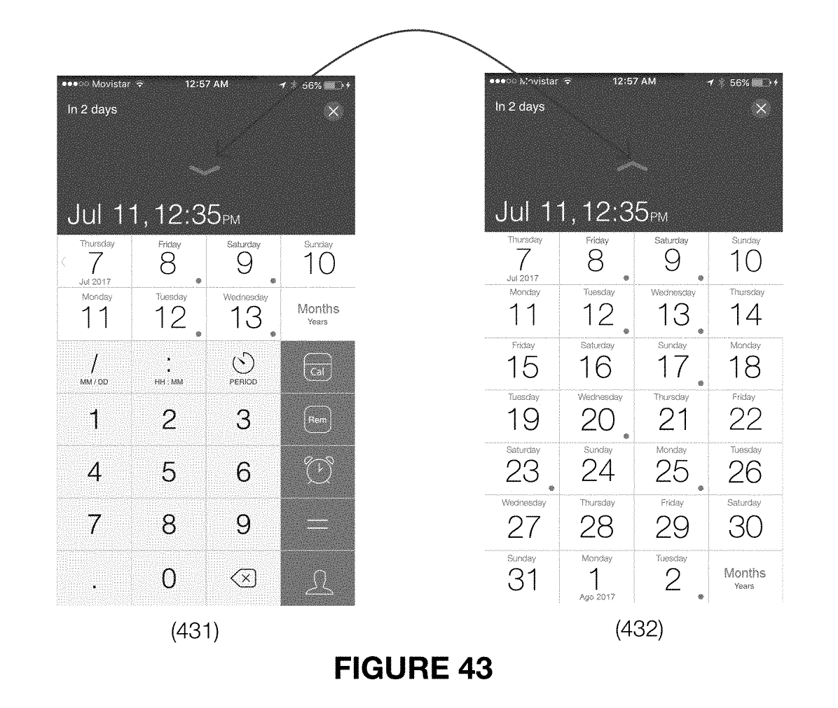

1.5.4) The Panel of dates 32A Full Calendar View (FIG. 43):

For a better comprehension of context of time, the Panel of Date could be expanded to reach Full Calendar View. This effect is achieve touching a dedicated button placed in display main view area 313, or by swiping down on the Main View area 313. Doing this action, all the buttons of Interface 2000 located below the panel of dates, will become additional cells of the panel of dates 32A so the context of time will be better in terms of dates shown. The Scroll of the panel of dates 32A will remain the same. This full calendar view could be closed by touching the dedicated button placed in Display Main Area 313 to establish regular view.

2) Time Management Through Assistant 1000:

The Triple Time Input Method System:

2.1) Definition of Dates through Interface 2000:

The Definition of Dates through Interface 2000 can be done in three different ways. a) Using the Panel of Dates 32A, b) Using the Numerical Keypad 34 combined with the Date bar “/” 331, c) Through the “Period” functionality 333 combined with the numerical keypad 34.

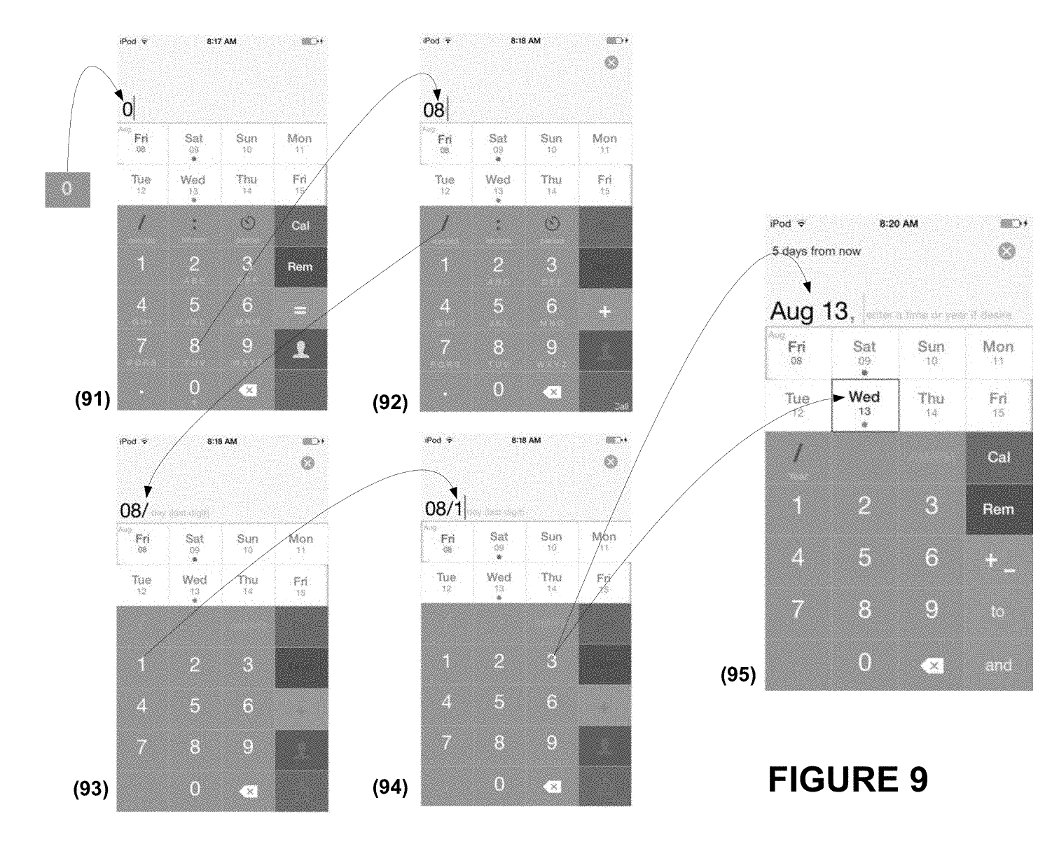

a) Single touch in any cell of the Panel of Dates 32A, is enough for Assistant 1000 to consider that date as a user input to the system. In FIG. 9, (95) shows the case where the user defines Date “Aug 13” touching the corresponding cell in the Panel of Dates 32A making the counter/notifier 311 informs how far from present time is “Aug 13”.

b) The second way to define dates in Interface 2000 is through the numerical Keypad 34 combined with the date bar “/” 331. The user will be able to define any past or future date being also possible to define a year. This way the user could define a date string as “12/9/2016”.

Dates which belongs to present year can be entered with or without defining the year, as Assistant 1000 will assume that a date string without a year belongs to present year. For example “12/09” is interpreted by Assistant 1000 as “12/09/2014” (being 2014 the present year). This “smart” interpretation of Assistant 1000 results in quicker inputs when defining dates during present year.

FIG. 9 shows a sequence of inputs to define a Date through the numerical Keypad 34 combined with the Date bar “/” button 331. Pay attention in (95) that the entered date is displayed as “Aug 13” and not as “08/13” as it was entered as explained from (91) to (94). This automatic change of format is made by Assistant 1000 every time it recognizes a well-defined date string corresponding to the present year. This makes inure human the System output of Dates.

Backspace deletion: As the user is defining the date, he or she could use the “Backspace button 343 of Interface 2000 numerical Keypad 34 to erase the previous entered characters. As backspace button 343 is touched, Assistant 1000 will restore previously hidden buttons of Interface 2000 backward adapting them according to Process Flow and Context Achieved 2010 resulting of input data not erased yet and that consequently were still visible in Display Main View Area 313.

Regional format of Dates: Nowadays, Operating Systems provides their regional format settings to installed Apps, so Assistant 1000 gets benefit of that not being necessary for the user to set a regional format as the OS System date format is the one adopted by Assistant 1000.

c) The third way that Interface 2000 allows to define a date is after defining a period of time. It is a frequent real life situation to think about the future in terms of a period of time and not in terms of a specific date or time. For example, “See you in ten days . . . ”, “in one hour . . . ” etc. These real life situations are perfectly process able by Assistant 1000.

The user will be able to define a date after defining a “period of time from now” which will result in a specific future date and time.

Period buttons are minutes 3511, hours 3522, days 3535, weeks 3544 and months 3545. More kind of period could be enable in Interface 2000 as years or nights, weekdays, workweeks (not exemplified).

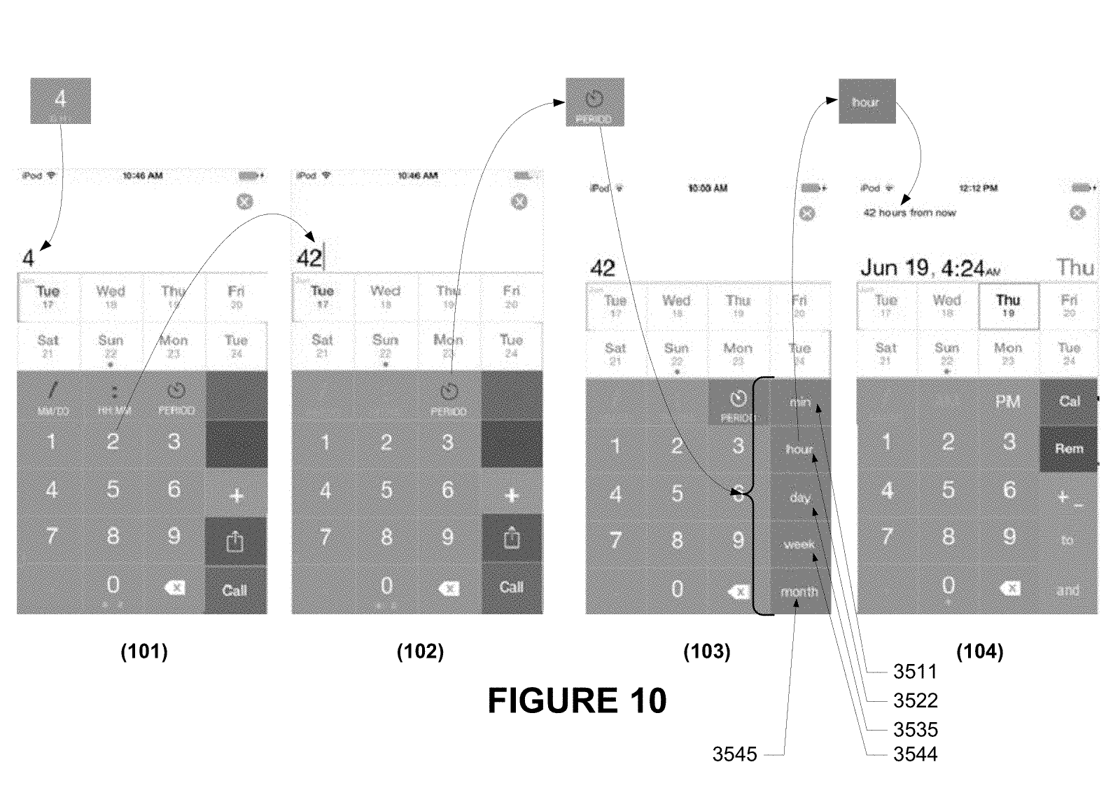

FIG. 10 shows the period option buttons on the side dock 35, but those buttons could also be placed on the panel of dates that becomes panel of periods when the period button 333/3331 is touch. This way, the user eliminates the visual notice of the panel of dates at the time of processing periods of time.

FIG. 10 shows a sequence where, assuming that present time is Tue 17 of June, if the user enters number “42” via de Numerical Keypad 34 and then, he or she touches the “Period button” 333 and then chooses the “hours” button 3522, Interface 2000 would display in the Main view Area 313 which date and time corresponds to that period of time from now “Jun 19, 4:24AM” and the counter/notifier 311 would inform that the date and time displayed in Main view Area 313 corresponds to a period of 42 hours from present time (104).

As time value outputs defined via “Period” 333 are strings of date and time “Jun 19, 4:24 AM”, from that Context Achieved 2010 the user could modified the time value of the string erasing (via backspace 343) and entering a different time but not changing the date, or to modify the date (choosing another date through the Panel of Dates 32A) but maintaining the resultant time according the period defined.

The Panel of Days 32A as slave: In the cases that the user enters values of date through the numerical Keypad 34 combined with the date bar “/” 331 or through the “Period” functionality 333, The Panel of Dates 32A will be slave to this requirements and it will auto scroll to past or future time as appropriate, showing the defined date.

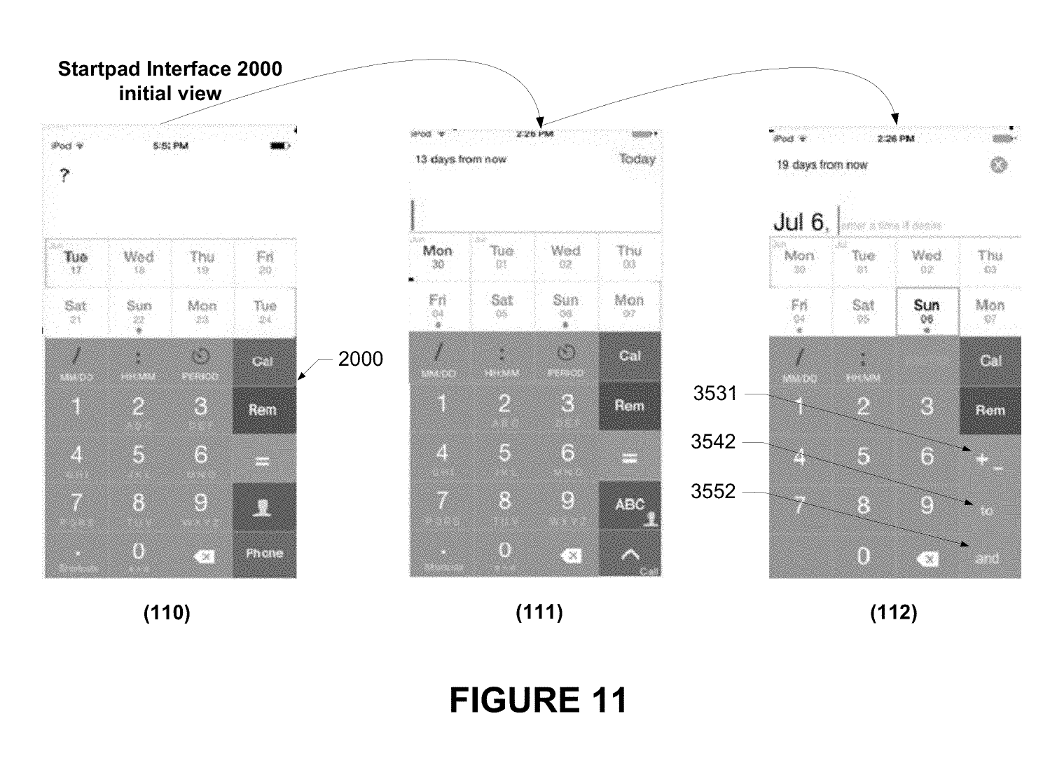

In FIG. 11, (112) shows the Process Flow and Context Achieved 2010 after the user scrolled The Panel of Dates 32A in the initial view of Interface 2000 which results in (111) where: The upper right button 312 appears as “Today” button 3121, the counter/notifier 311 informs “13 days from now” referring to how far from Present Time is the Date displayed on the home cell 321 “Jul, Mon 30” and the home cell 321 is shown with borders and fonts in black to make the user understand that is the cell which refers the counter/notifier 311.

(112) is an example of how some Assistant 1000 Internal Processes & Software Components 1250 works: (a) Concealing buttons 1252 as the “Period” Button 333 is hidden, the “dot” button 341 and the labels bellow numbers in the numerical Keypad 34 are also hidden as they are now out of context achieved 2010; (b) Adapting buttons 1251 as the Upper Right Button 312 becomes the Clear Display “x” button 3122, and the Contact button 354 and Phone button 355, not being options anymore, become the “+ −” button 3531, the “to” button 3542 , “and” button 3552 which are possible inputs according to the context achieved so far 2010 (further explained), the Date bar “/” 331, having been defined a date (Jul 6), is now an available button to enter a Year through the “Year” button 3535; (c) producing a Visual Adaptation 1256 as the selected day is remarked with lines and fonts in black; (d) showing the Place Holders 1254 “enter a time or year if desire” and the “Cursor” indicating the user that there are available inputs according to Context Achieved 2010; (e) Displaying Information 1253 as the selected date “Jul 6” is shown in Main View Area 313 and the Counter/Notifier 311 “19 days from now” informs how far the selected date “Jul 6” is from present time.

Deletion of Dates (FIG. 11):

Whether defined a date (112) via The Panel of Dates 32A (a), through the numerical Keypad 34 combined with time operators “/” 331, “:” (b) 332, or through the numerical Keypad 34 combined with the “Period” button 333(c), the user could delete the whole inputs touching the upper right button 312 which in this context is shown as the Clear Display button “x” 3122 to suggest the user that through it the screen will be all cleared. I his will result in the date previously defined won't be shown as selected anymore in the panel of dates 32A which will result in (111). As (111) shows, as no date is now selected, the panel of dates 32A does not scroll itself to present time and it will remain there (then) showing the same range of dates that showed (112) with the purpose of preserving the Context of time Achieved 2010, being possible to the user to choose another date in that context of time 2010. While no date is selected in (111), the Counter Notifier 311 will refer then to the home cell 321. In (111), the Upper Right Button 312 becomes “today” button 3121, that if touched will produce an auto scroll of the Panel of Dates 32A to Present Time what will result in Interface 2000 initial view (110).

2.2) Entering Time After a Date has been Previously Defined:

Regional format of time: Nowadays, Operating Systems provides their regional format settings to installed Apps, so Assistant 1000 get benefit of that not being necessary for the user to set a time format as the OS System date format is the one adopted by Assistant 1000.

Inputs of time can be done through the Numerical Keypad 34 combined with Time operator “:” 332 for separating hours from minutes.

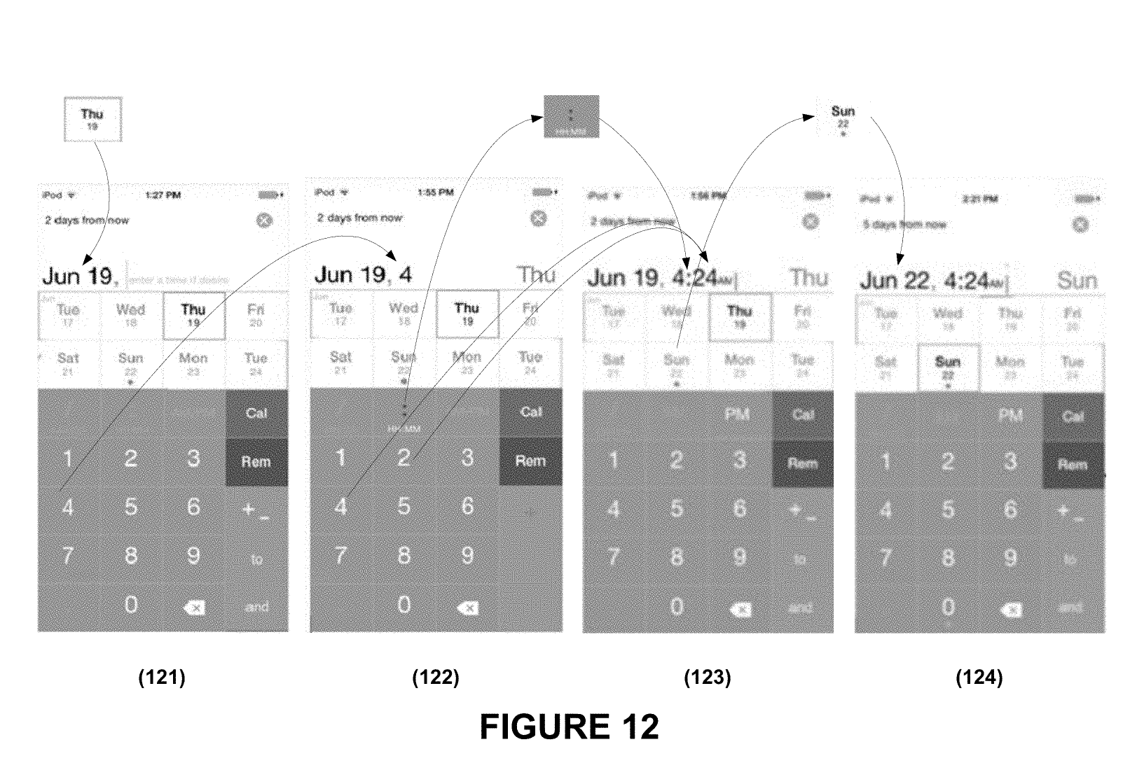

FIG. 12 shows a sequence of time input having the user previously entered a date. (123) shows how the “Period Button 333 becomes “PM” button 3331 allowing the user to change from “AM” that was initially suggested according Assistant 1000 Disambiguation Rules 1257. Interface 2000 allows entering an hour and then defining a date, or vice versa, or having entered the date and/or time, change the time or date in any order but preserving the input of the unchanged value while changing the other. For example, from (121) to (123) the date “Jun 19, 4:24 AM was defined, then if in (123) the user touches the cell where Sunday 22 of June is located, It will result in (124) where the date was change but the time was preserved being also possible to erase via backspace 343 to change and modify the original time.

This versatility is helpful in lots of real life situations as it avoids to re-enter a whole string of time and date value or vice versa.

Automatic comma: It is a system output shown after the user has defined a date or time, and with the purpose of visually separate time from date or vice versa. This automatic comma is not a user editable character. For example, if in (122) the user touches the “Backspace” button 343 on the time entered, number 4 will be deleted and if the user touches the backspace button 343 again, this action will erase the automatic comma and number 9 simultaneously.

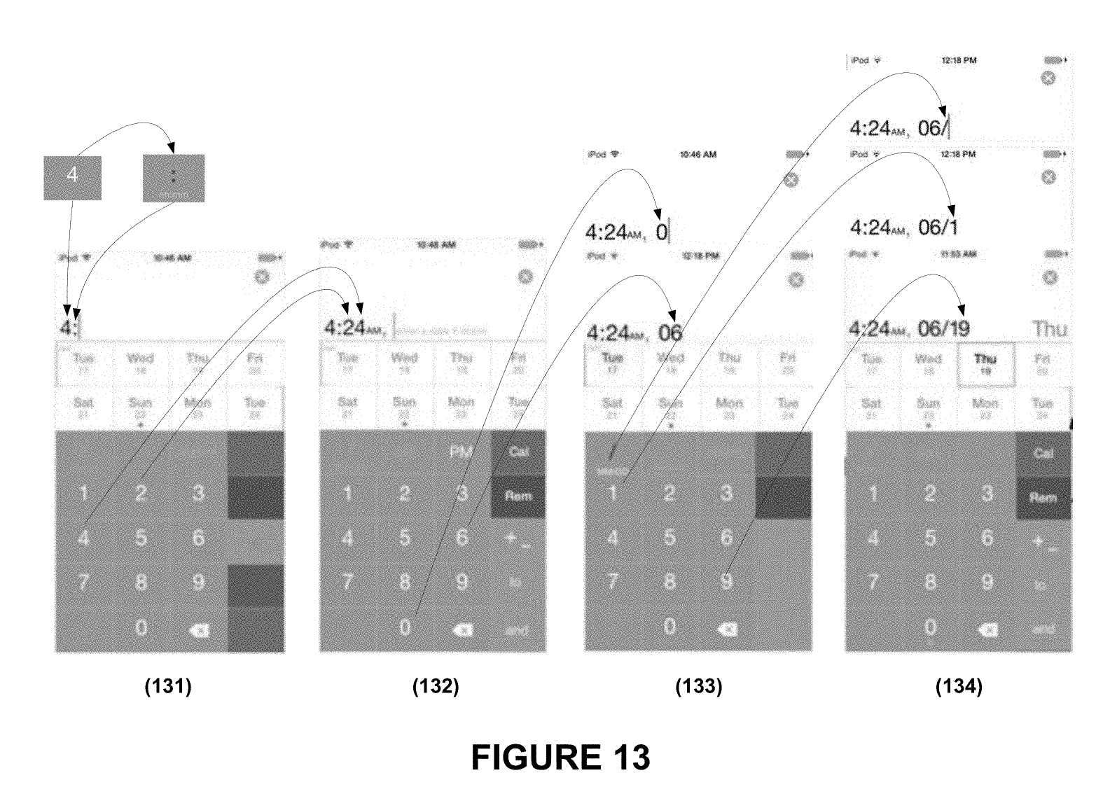

FIG. 13 shows a sequence where, being present time “Tue Jun 2014”, the user had started entering a time using the Numerical Keypad 34 combined with the Dots “:” button 332 and later through the Numerical Keypad 34 combined with the “/” date button 331 ended defining a date and time string.

2.3) Subsequent Actions After Defined Time Values

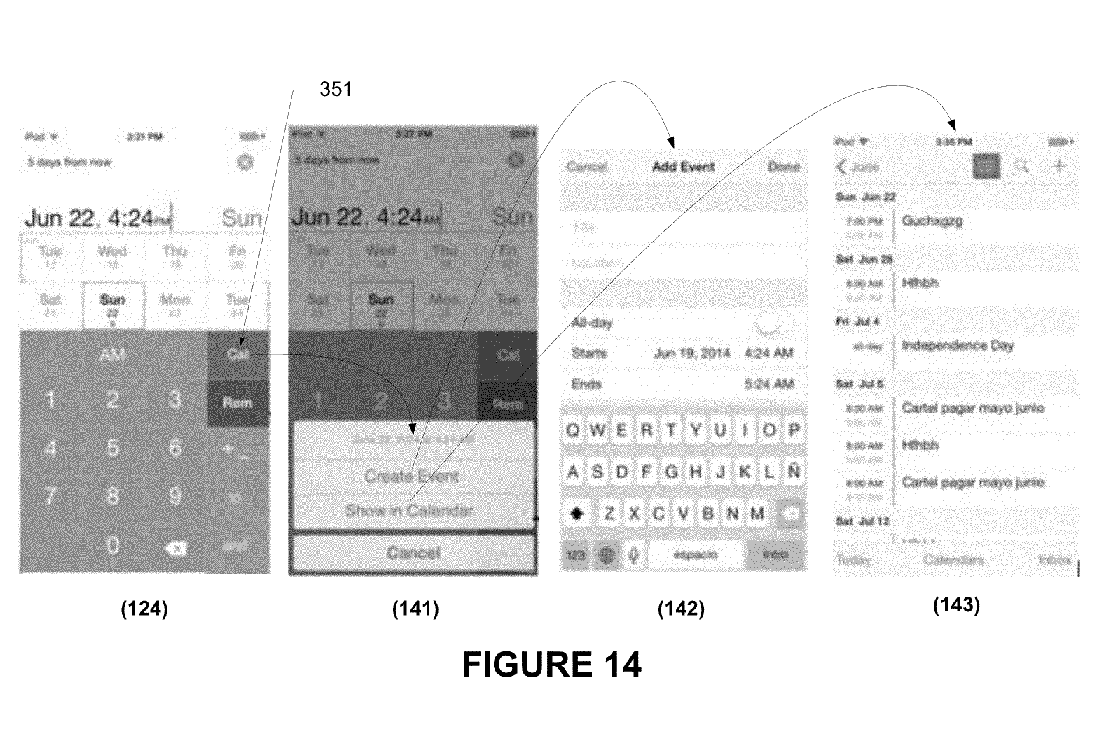

In FIG. 14, (124) shows a Process Flow and Context Achieved 2010 which results of having the user previously defined a date and time. If in (124) the user touches the Calendar button 351 on the side dock 35, this action will trigger Assistant 1000 Internal Processes & Software Components 1250 to show a Dialog Box 1255 giving the options to create a calendar event or to show that date and time in the Linked Calendar App (1002a or 1003a), what is shown in (141). If in (141) the user touches “Create Event”, the New Event Creation proprietary Panel of the linked Calendar App (1002a or 1003a) will be shown to the user with the original date and time values entered via Interface 2000 already preloaded, then, the user will be able to define additional parameters to the New Event in their correspondent fields, such the case of “Event Title” by using the proprietary interface of the linked Calendar App. (1002a or 1003a). According to the OS kind of functionality, the user could also cancel the new event creation process returning to Interface 2000 which would show the entered string of date and time.

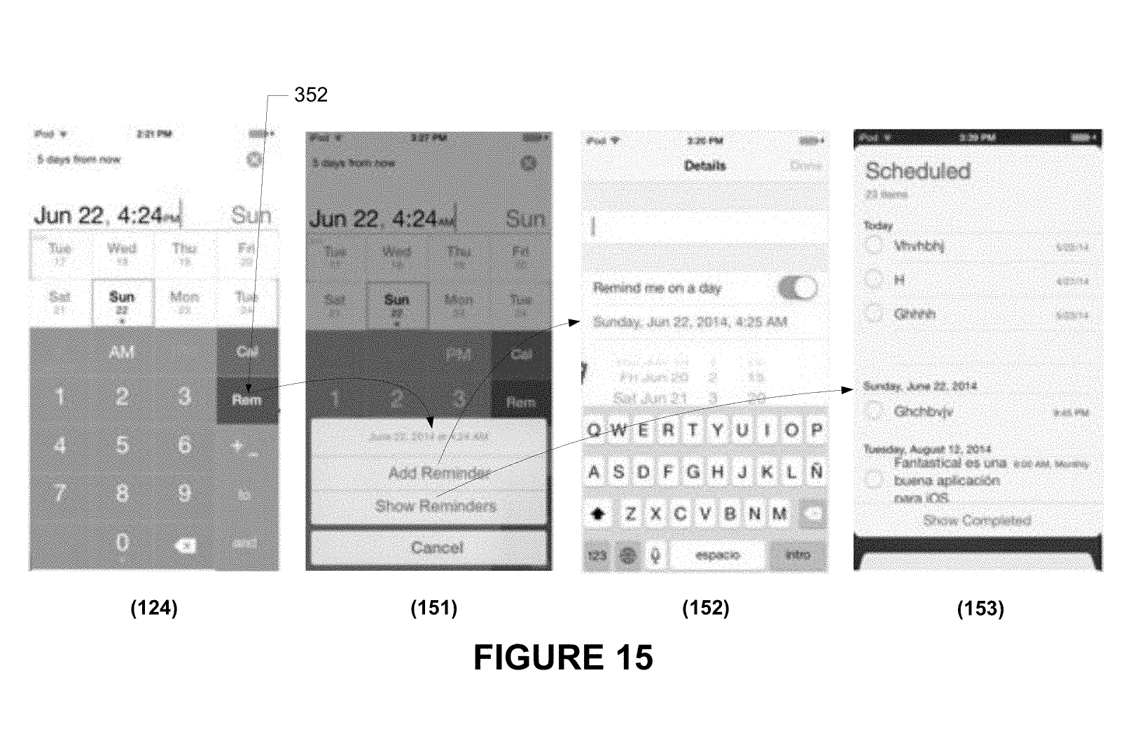

Alternative subsequent actions once defined a time and/or date string via Interface 2000 are also options in the Context Achieved 2010, as the creation of a Schedule Reminder, an Alarm or a Timer. FIG. 15 is an example where the User, after having defined a date and time (124), touched the Reminders linked App Button 352 on the side dock 35 so Assistant 1000 will show a dialog box 1255 (151) and through it the user could Create an Schedule Reminder in the linked Reminders App (1002b or 1003b) (152) or see the Schedule Reminders list on the date previously required by the user. FIG. 15 is an example where the iOS 7 Calendar App was linked to Assistant 1000 (153).

It is important to add that every OS has specific URL schemes available and some others not available. For example, in IOS 7, it is not available an URL Scheme to preload a time value to later create an alarm with the iOS 7 Alarm App while in Android this URL is available. This restrictions have not altered the value of the present invention, but the level of functionality of the application of the present invention in a given OS. So, according to the privileges and permissions given by the OS to Assistant 1000, this kind of limitations could be banned as desire.

Additional functions of Assistant 1000 related to the management of time will be further explained in this document.

3) Assistant 1000 Managing Phone Numbers:

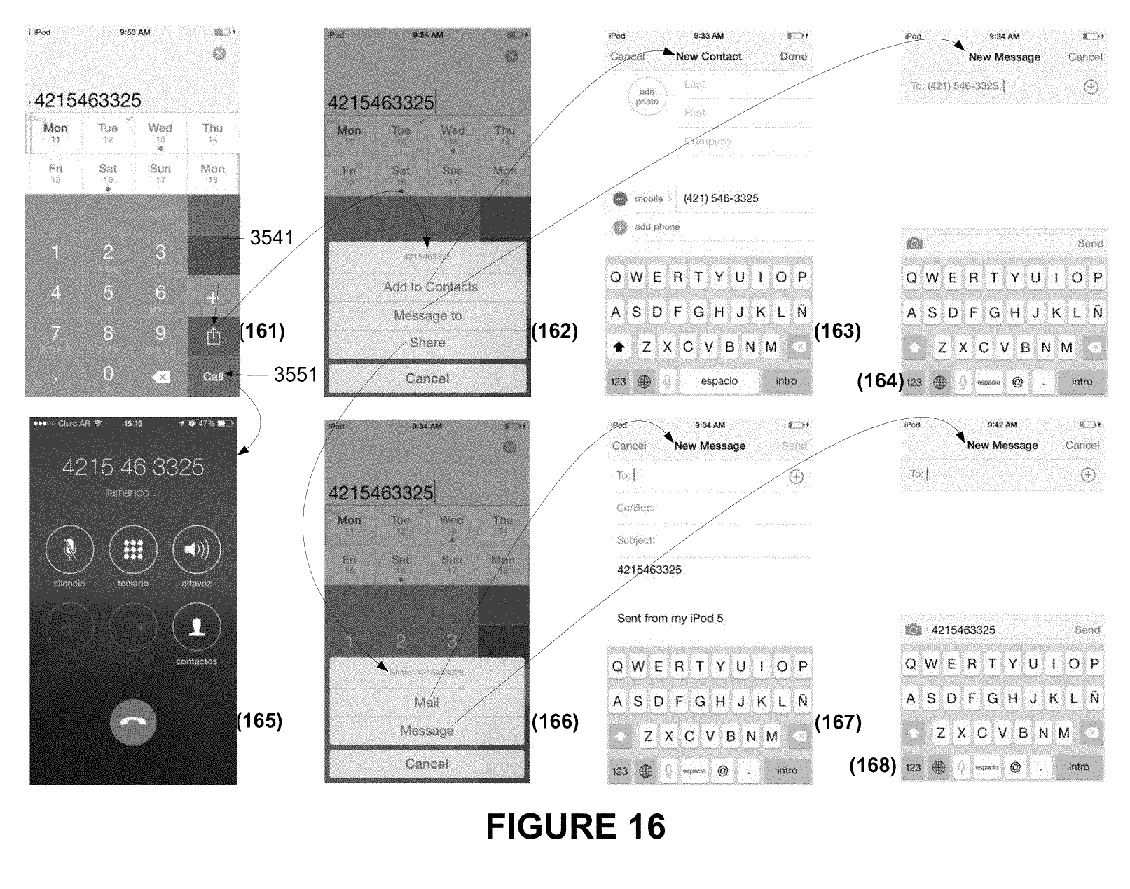

Assistant 1000 by is Interface 2000 is also a means to manage phone numbers allowing the user to perform actions after previously entered numbers that Assistant 1000 Software Component of Disambiguation 1258 has determined apt to be considered phone numbers. In FIG. 16, (161) shows the process whereby Interface 2000 initial view the user entered the number “4215463325” (161).

Pay attention in (161) how and according to the kind of input of the user (in this case number “4215463325)”, Assistant 1000 conceals from Interface 2000 the Time Operators buttons “:” 332, “/” 331 and the Reminders 352 and the Calendar 351 buttons as they are not options anymore in the Context Achieved 2010 due to the kind of user inputs and after Assistant 1000 Disambiguation Process 1258 that determined that this input is not about a date or time value.

Among the possible actions after the user having entered number “4215463325” will be those in the context of telephony actions such the case of placing a phone call to that number, message to that number, share, or save as contact, and some other. According to Assistant 1000 Internal Processes & Software Components 1250 such the case of Disambiguation Rules 1258 after the user defined a number possible to be processed as a phone number, the Phone Button 355 which in initial view of Interface 2000 is “Phone” (needed to open the linked Phone App (1002d or 1003d) through Interface 2000) now becomes the “Call” button 3551 instead as showed in (161) of FIG. 16. (165) shows the case where the user made a phone call by Interface 2000 touching the “Call” Button 3551, so the linked phone App (1002d or 1003d) (in the example it is iOS 7 Phone App) will execute the phone call.

(162) shows the case where the user touches the “Actions” button 3541 so Assistant 1000 will show a Dialog Box 1255 to allow the user to choose among other actions available according to Context Achieved 2010 about the phone number entered, actions or processes that could be started from there and which will be terminated or continued by the respective Services or Apps offered by the OS according to the kind of data involved and Services available for the OS, such are the cases of sharing that number via Facebook, WhatsApp, Twitter, etc. Apps.

In FIG. 16, if in (162) the user touches “Add to Contacts”, through an additional Dialog Box 1255 (not shown in FIG. 16) Assistant 1000 will ask the user if he or she wants to add the entered number to an existing contact or to create a new one after it, so showing another Dialog Box 1255 the user will be asked if the number represents a mobile, work, etc. phone number. Then via an specific URL Scheme, Assistant 1000 will require the OS to show the linked Contact App (1002c or 1003c) for the user to continue filling the desire fields of the Contact created after number “4215463325” which will be shown preloaded in the linked Contacts App (1002c or 1003c) interface to finish the process (163).

If in the Dialog Box 1255 (162), the user touches “Message to”, Assistant 1000 will require the OS via an URL to bring the Message App interface showing preloaded number “4215463625” in the Recipients “To” field and from where the user would complete the other desire or needed field to be ready to send the message (164).

If in the Dialog Box 1255 (162), the user touches “Share”, Assistant 1000 will ask the user through another Dialog Box 1255 to choose the service with which he desires to share number “4215463325” (166). If in the Dialog Box 1255 (166) the user touches “mail”, Assistant 1000 will require the OS via a specific URL Scheme to show the Mail App having preloaded number “4215463325” in the body of the new email created (167). Then, the user will have to define the recipient and the subject field of the new email created and finish the process with the interface of the email App.

If in dialog box 166 the user touches “message”, Assistant 1000 will require the OS via an URL scheme, to open the Message App showing number “4215463325” preloaded in the body of the new message created and the user will have to end the process with the interface of the Message App (168).

To the extent that the device had the capacity to make calls through Skype or another IP telephony service and there were available the URL schemes to preload numbers to later require Skype to call that number, this kind of actions could also be started via Interface 2000.

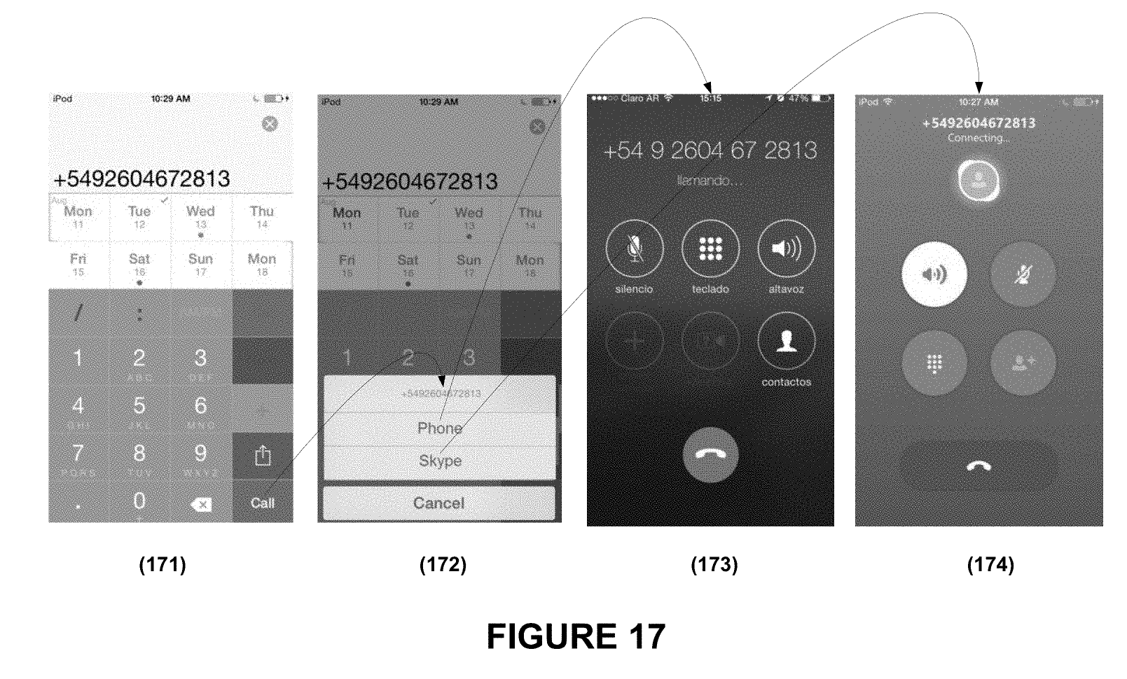

After a phone number to call by Skype must be entered preceded by “+”, long pressing “0” on Interface 2000, the “+” symbol will be entered, then Assistant 1000 internal Process of Verification 1258 will validate if the numbers entered after the “+” symbol matches a real international country phone code, Assistant 1000 internal Verification Process 1258 would then allow that number to be considered as a possible phone number defined by the user. In FIG. 17, (171) shows the case in which the user entered a number starting with + and the first values matched the international phone code area for Country Argentina “+54”, and as five digits have been entered, Assistant 1000 internal Verification Process 1258 will consider this number “+5492604672813” apt to be a phone number. This way, if the user touches the Call button 3551 (172), Interface 2000 will show a Dialog Box 1255 to allow the user to choose the desired service to make the phone call what are exemplified in (173) and (174).

4) Assistant 1000 as a Means to Manage Mathematical Calculations:

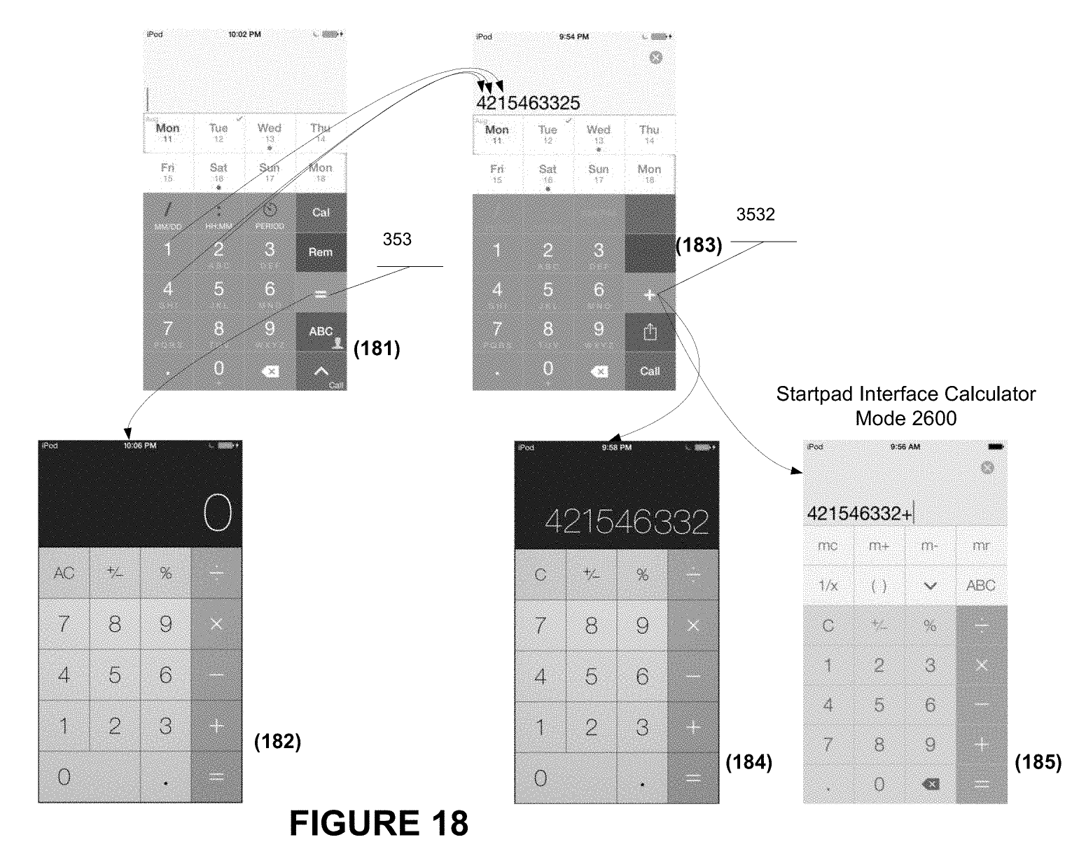

Assistant 1000 is also a means to manage mathematical Calculations. In FIG. 18, (183) results of the user having entered number “4215463325”, consequently “Concealing buttons Software Component 1252” hides the “/” 331, “:” 332, Calendar Button 351 and Reminders buttons 352 from Interface 2000 as they are not possible inputs according to the process flow and Context Achieved 2010 after the entered number; at the same time, Assistant 1000 Software Component of Adaptation of Buttons 1251 will change the Calculator Button from “=” 353 to “+” 3532.

If the intention of the user were to make a mathematical calculation after number “4215463325”, in (183) single touch in the “+ Calculator” button 3532, makes Assistant 1000 requires the OS to open the linked Calculator App (184) where the user will be able to proceed with the mathematical calculation.

In FIG. 18, (185) shows “Interface 2600 (Calculator Mode)” where it can be shown as the Interface 2000 grid is exactly preserved in “Interface 2600 (Calculator Mode)”, the layout of the numerical buttons could be also the same starting with 1 above left, and that the size and location of numbers are exactly the same in both screens. In addition, Interface 2000 own Calculator shows the mathematical operator “+” which was originally entered through Interface 2000 (183) showing it preloaded in “Interface 2600 (Calculator Mode)” (as operator “+” is the most commonly used math operator). For the case that the user had in mind another math operator, he or she should easily touch the desire symbol in Interface 2600 Calculator Mode (185), action that will substitute the preloaded operator“+” for a new operator as selected by the user.

As previously explained and after the ability of graphical based interfaces of been able to instantly change the appearance and functionality of buttons, and after Interface 2000 is designed for graphical interfaces, the transition from Interface 2000 to “Interface 2600 (Calculator Mode)” allows an unpublished user experience mainly considering that the number initially entered through Interface 2000 remains visible and unaltered when the transition to Interface 2000 Calculator View occurs.

(182) shows what happens if the user, without having entered a number by the initial view of Interface 2000, touches the calculator button 353 in the side dock 35 (represented in Interface 2000 initial view as symbol “=”) (181), what makes Assistant 1000 to request the OS to open the linked Calculator App 182 (the example shown supposes the iOS Calculator App is linked to Assistant 1000).

5) Assistant 1000 as a Means to Manage Shortcuts:

In spite of Interface 2000 reserves the side dock 35 buttons to the primary linked Apps (Cal 351, Rem 352, Calculator 353, Contacts 354 and Phone 355).

By Interface 2000 initial view, having the user entered no values, single touch on any of the side dock 35 buttons would make Assistant 1000 requests the OS to launch the correspondent linked App. FIG. 4 exemplifies how the side dock 35 buttons act as shortcuts to the primary linked Apps.

After graphical interface Operating Systems, mainly those Touch Screen interface based, allow to modify the name and/or appearance of a button and also to be able to perform swipe movements in different directions starting from a button to perform or trigger different kind of actions according to the kind of movement involved (also force touch technology could or alike could also be suitable). Assistant 1000 gets value of these functionalities of Touch Screen Operating Systems and combines them to management of URL schemes in order to allow the user to assign shortcuts to the numerical keypad 34 of Interface 2000.

A kind of this functionality was historically known as “Speed Dial” which allows the user to execute a default action mainly assigned to make a direct Call to a phone number by long pressing the assigned button of the phone dialer, whether this number were stored or not as Contact in the given mobile phone device.

Assistant 1000 takes this concept to a next level of functionality allowing the user to assign more than one action per button of the numerical keypad of Interface 2000, being these actions related not only to speed dial phone numbers but also to typical or specific actions according to commonly used routines of the Apps involved and also hybrid actions. For example, a typical Facebook action is to post while a general action related to Facebook is to launch the Facebook App.

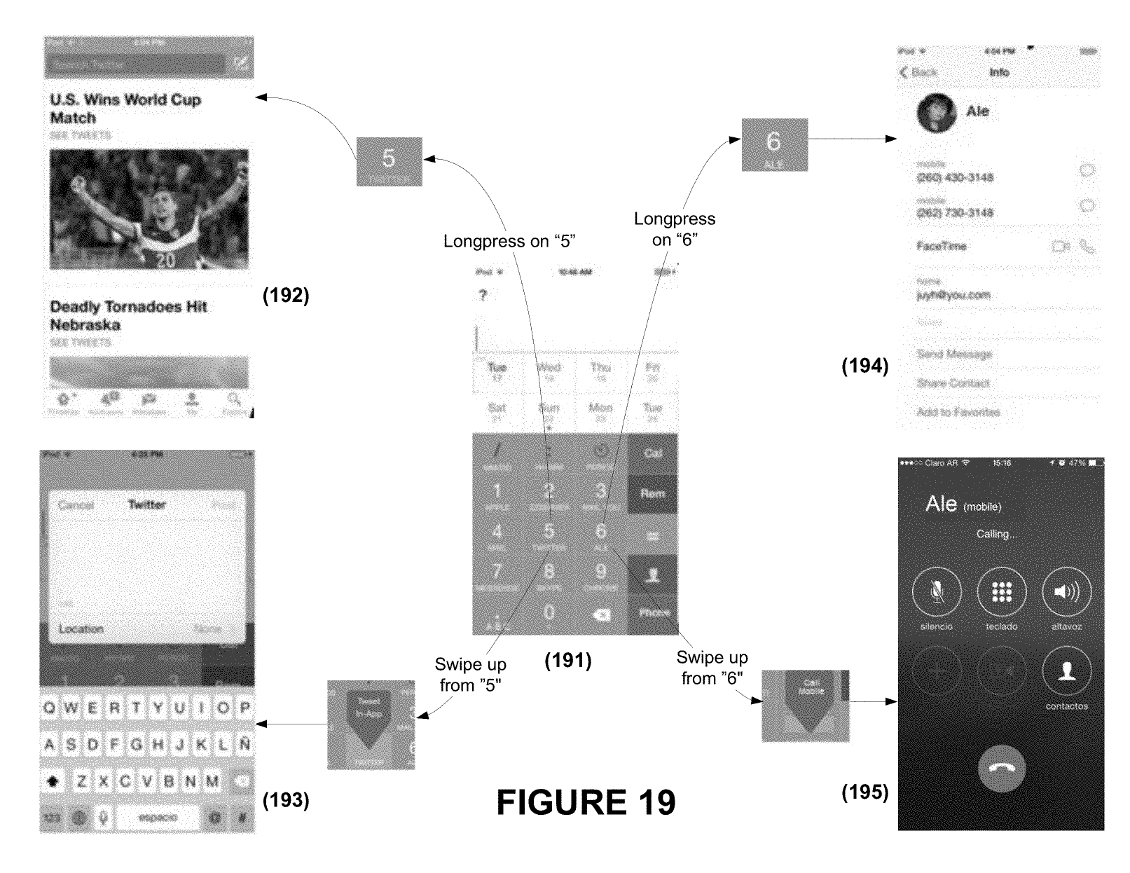

In FIG. 19, (191) shows how two actions of shortcuts (refer to the Twitter App for iOS 7) are executed from button number “5” of the numerical keypad 34 of Interface 2000. (192) shows the resultant view of having the user perform a long press action on button number “5” what will produce that Assistant 1000 require the OS to launch the Twitter App. (193) shows the resultant view of the user action of “swiping up” starting from button number “5” what makes Assistant 1000 to require the OS to bring the Twitter interface ready to write a tweet.

In like manner, (191) shows how two actions referred to Contact “Ale” are executed by two shortcuts assigned to number “6” of the numerical keypad 34. (194) shows the resultant view by a long press action on number “6” what will make that Assistant 1000 requires the OS to bring the “Contact Details interface I” of the linked Contacts App (1002c, 1003c). (195) shows the resultant view by a swipe up action on number “6” what will make that Assistant 1000 requires the OS to make a Call to “Ale” Contact to his mobile number.

Shortcuts can be assigned to the numerical Keypad 34 of Interface 2000 by directly long pressing on a desire button of the numerical keypad 34, to the extent that button has no previously be assigned as shortcut for another action. For the case that a previous shortcut had been assigned to that button, as the name of the shortcut previously assigned is display bellow the number of the button, the user would have to use the “Shortcut Manager interface” to handle this situation.

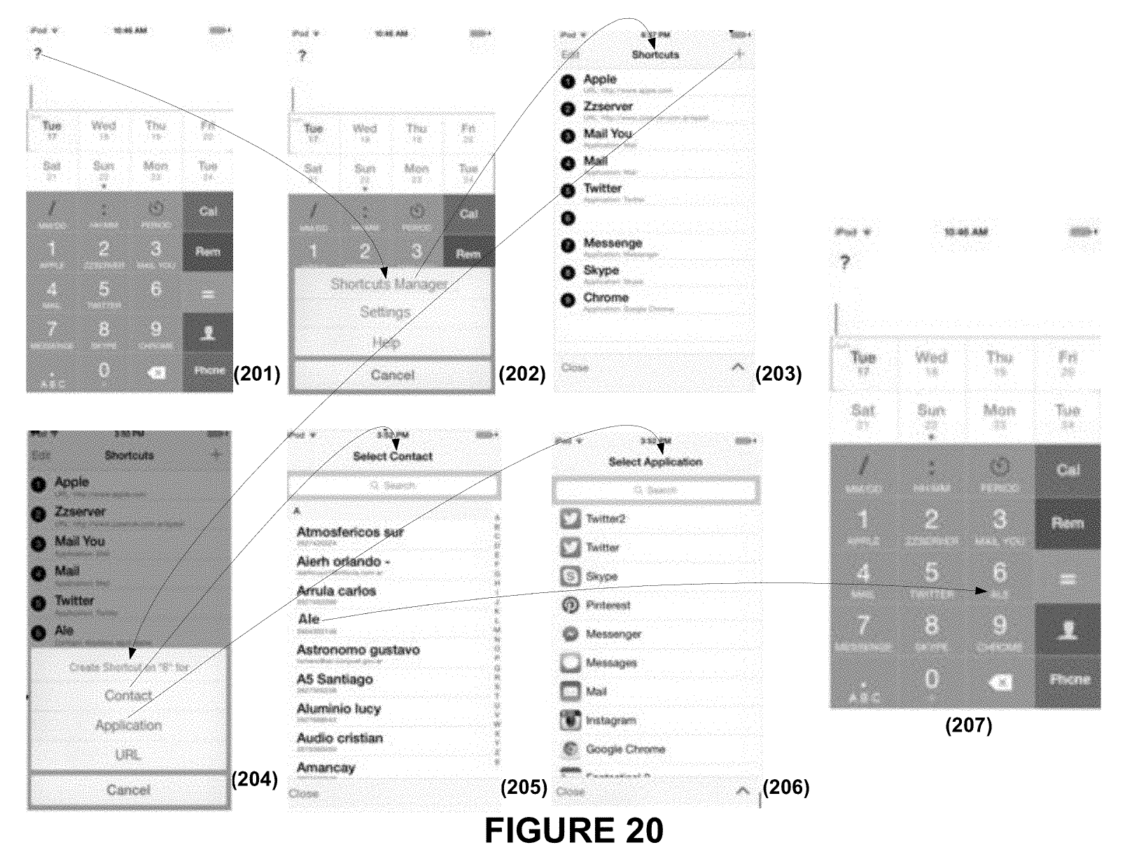

In FIG. 20, (201) shows Interface 2000 initial view with the setting “show shortcuts names bellow numbers” so the Names of the Shortcuts are displayed in the bottom area of the numerical buttons of the numerical keypad 34 and where it can be seen that number “6” does not show a shortcut name on it what indicates the user that button “6” is available to create a shortcut on it. If in (201) the user touches “?” button, a Dialog box 1255 (202) will be display where one of the options will be “Shortcut Manager” so if this option were selected the “Shortcut Manager” interface will become available (203) so if the intension of the user were to create a new shortcut on number “6” button, he or she should touch the “+” button (or registry number 6 which shows no shortcut name on it) what will make another Dialog box 1255 to appear (204) giving the user the possibility to choose whether to create a shortcut about a Contact or about an Application. (205) shows the resultant view of the user having chosen “Contact” in (204) what makes Assistant 1000 require the OS to bring the list of Contacts stored in the linked Contact App (1002c, 1003c) for the user to choose the desire Contact (205). (206) shows the case where in the dialog box 1255 (204) the user chose to create a shortcut for an Application, so Assistant 1000 will show the list of installed Applications that the OS granted access to launch it or perform an specific action of it.

As it can be seen in FIGS. 19 and 20, iOS 7 Operating System has been chosen for this explanation but as explained before in this patent application each OS has its own way and methods to allow Apps to communicate with each other.

(207) shows the case where the user in (204) chose “Contact” and in (205) chose Contact “Ale” where it can be appreciate that unlike (201), in (207) button number “6” has the label “Ale” bellow number “6” indicating to the user that a shortcut for “Ale” has been created and is available in button “6”.

The process of assignation of shortcuts through the “Shortcut Manager” cited in this patent application it is just a method to create, edit, sort and delete shortcuts to allow Assistant 1000 to execute those shortcuts, so the appearance and functionality of the Shortcut Manager should not be considered as an essential part of the invention claimed in this patent application.

Through an specific Setting, Assistant 1000 allows the user to enable and disable the Shortcuts functionality and another setting for showing or hiding the labels of the shortcut names bellow the buttons of numbers of the numerical keypad 34. Being the shortcuts enabled, a setting to show the letters bellow numbers as phone dial pads always shows, or to show no label bellow numbers of the numerical keypad 34 will be available. If shortcuts were enabled and also set to “show the Shortcuts' names bellow numbers”, in the bottom area of the “.” button 341 of the numerical keypad 34 “abc” label will be showed the and if button 341 were long pressed would make that Interface 2000 shows “letters” bellow numbers during present session but not changing the setting. In like manner, if the setting were “Shortcuts enabled” and “show letters bellow numbers”, bellow the “.” dot button 341 of the numerical keypad 34 the label “shortcuts” will be shown instead so a long press on button 341 would produce that Interface 2000 show, only during present session, the names of the shortcuts bellow numbers on each button of the numerical keypad 34 (this is useful for the case that the user wants to remember the shortcut positions on each button of the numerical keypad 34 without having to necessary change the “Show label bellow numbers” settings.

6) Managing Text Through Assistant 1000 (“TextStart” Feature):

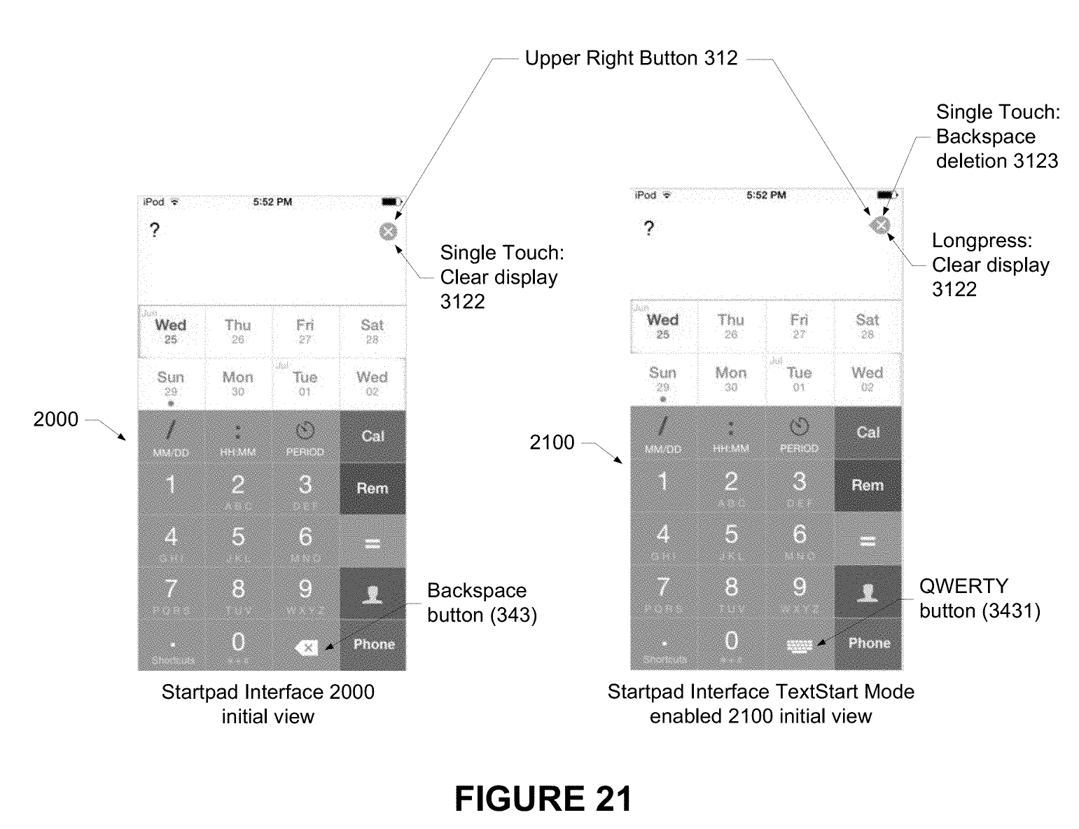

In the case that Assistant 1000 definition of product were defined with the TextStart specification “enable” to be able to start writing text through it, a minimal variation to the Standard Interface 2000 should be considered. In FIG. 21, 2100 shows Interface 2000 when “TextStart” feature is enable. In this modality, the backspace action 3123 is executed by the upper right button 312. Long press on 312 would produce the Clear All Screen Action 3122 while single touch will act as conventional backspace 3122. If the user accidentally long press this button, the display would be cleared so the upper right button 312 would become the “undo” action (not illustrated in the examples) to restore what was previously displayed. Where the Backspace Button 343 was located in Interface 2000, in “Interface 2100 (TextStart enable)” initial view the “Qwerty Keyboard” Button 3431 would be shown instead. If “Qwerty” button 3431 is touch, the Keyboard that were set as default in the OS System preferences, would be available for the user to start typing.

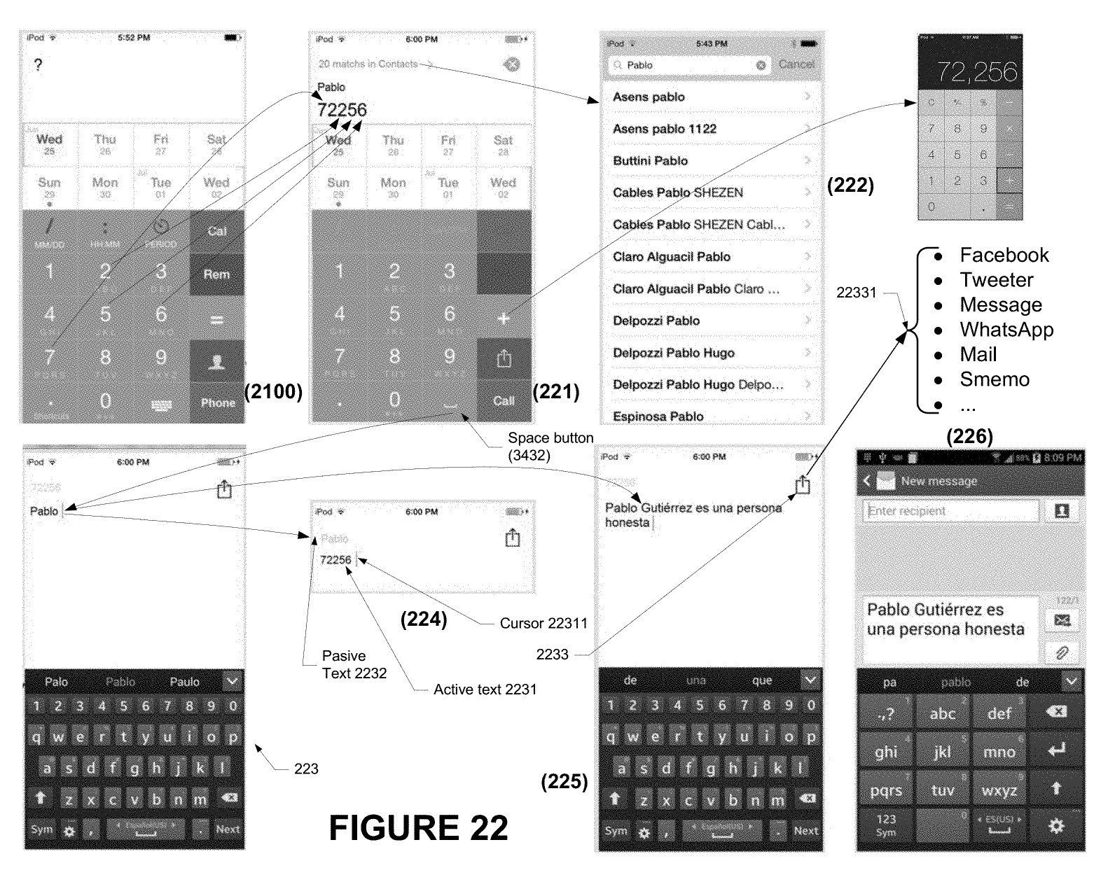

In FIG. 22, (221) shows what results if by “Interface 2100 initial view (“TextStart” enabled)“, the user entered “722556” so Assistant 1000 “Smart dial” engine would disambiguate the word “Pablo” (according to OS language settings and assuming that Spanish Language were selected) word that could also represent a user's intention to start a sentence with the word “Pablo”.

Using Assistant 1000 to Search Contacts:

As it can be observed in (221), the user entered “72256” using the “numerical Keypad” 34 what Assistant 1000 TextStart Software Component 1260 deduced “Pablo” what is shown on display (in the first line of the Main view area 313). Al the same time, Assistant 1000 Software Component 1261 (Search Engine) found 20 coincidences of “Pablo” in the phone directory of the linked Contacts App (1002c or 1003c) what is informed by the counter/notifier 311 “20 matches in Contacts” as shown in (221).

From a viewpoint, if the intension of the user were to find a contact after the word “Pablo”, in (221) if the user should touches the “counter/notifier” button 311 which in this Context Achieved 2010 also shows an “arrow to the right” to persuade the user that it is a button there so a single touch on it would require the OS to trigger the linked Contact App (1002c or 1003c) interface to be opened having preloaded the word “Pablo” (222) preloaded in its search box and showing the 20 matches in contacts (221) for the user to follow the process by the interface of the linked Contacts Apps (1002c or 1003c).

From another viewpoint, if the user's intension were not be about finding a Contact after the word “Pablo”, but to start writing being “Pablo” the first word, according to process flow and Context Achieved 2010, the “Qwerty keyboard button” 3431 would become the “Space button” 3432, necessary for the user to separate words when typing.

In (221) of FIG. 22, at the time the user touches the “Space” button 3432, Assistant 1000 would show the Text Input Interface 223. The word “Pablo” will be showed unaltered at the exact same screen location where it was previously shown in Interface 2100 (in the first line of the Main view area 313) for the user maintain his or her focus of attention.

Assistant 1000 Text Input Interface 223 and what is shown in (224) is the result of Assistant 1000 having cleaned up the Timeline Panel 32 and to require the OS to bring the System Keyboard set to write text in portrait mode. (223) shows the case where a Qwerty keyboard is the System Keyboard set in OS system preferences, if the user rotates the device to landscape, Assistant 1000 Text Input Interface 223 would change its appearance to landscape view (not exemplified).

Pay attention that Text Input Interface 223 shows the number “72256” which was resulted by user's inputs in (221) and which sequence of inputs gave the same result “Pablo” (according to Assistant 1000 Software Component 1250 (Smart dial Engine 1259). In (223) it can be seen that “72256” is shown in grey font above “Pablo”. (224) shows what happens if the user touches on “72256” in the case that his or her intension had been to write “72256” and continue writing being “72256” the first entered word instead of “Pablo”. If the user touches on “72256”, where the Text Input Interface 223 showed “Pablo” will now show “72256” in black instead (as it is the Active Text as cursor indicates) and the word “Pablo” will be shown in grey (as Passive Text 2232 (no cursor)) where previously had been shown “72256”; The cursor 22311 will prompt the user to continue writing the Active Text 2231 as desire. The User will have the possibility to revert the selection by touching the word “Pablo” (which is now Passive Text 2232 (in grey)) and the opposite process will occur as it is shown in (224).

The Active Text 2231 is the area for characters shown in black in the second line of characters of the Tex Input Interface 223.

Passive Text 2232 is the area for characters shown in grey in the first line of characters of the Tex Input Intel fare 223.

It is important to understand that Passive Text 2232 will disappear when the user enters the first character of the second word in the Active Text area as cursor indicates, but it will appear again if by backspacing Assistant 1000 restores identical situation of 223 and (224).

With the first written word on The Text Input Interface 223 or with a phrase written on it (225) the “Actions” button 2233 will be available for the user to choose (by a dialog box 1255 not illustrated in (226)) the destiny he wants to give to the written text among the Apps, services and/or actions that the OS grants Assistant 1000 to get benefit of, so the user could terminate the process with its respective interfaces.

(226) exemplifies the case where the intension of the user is to send the written text by message. In this case, after finishing writing the text, he or she will have to touch the Action button 2233 and through a Dialog Box 1255 showed by Assistant 1000 (not shown in FIG. 22) the user will have to choose “Message” among the offered options 22331 so the available Message App will be launched already showing preloaded the text originally entered through Assistant 1000 and its interfaces 2100 and/or Text Input Interface so the user could follow with the interface of the linked message App to end the process. (226) shows the case where the user chose “Message the written text” in (225) so by the available Message App Interface the user could finish the process as it is shown in (226).

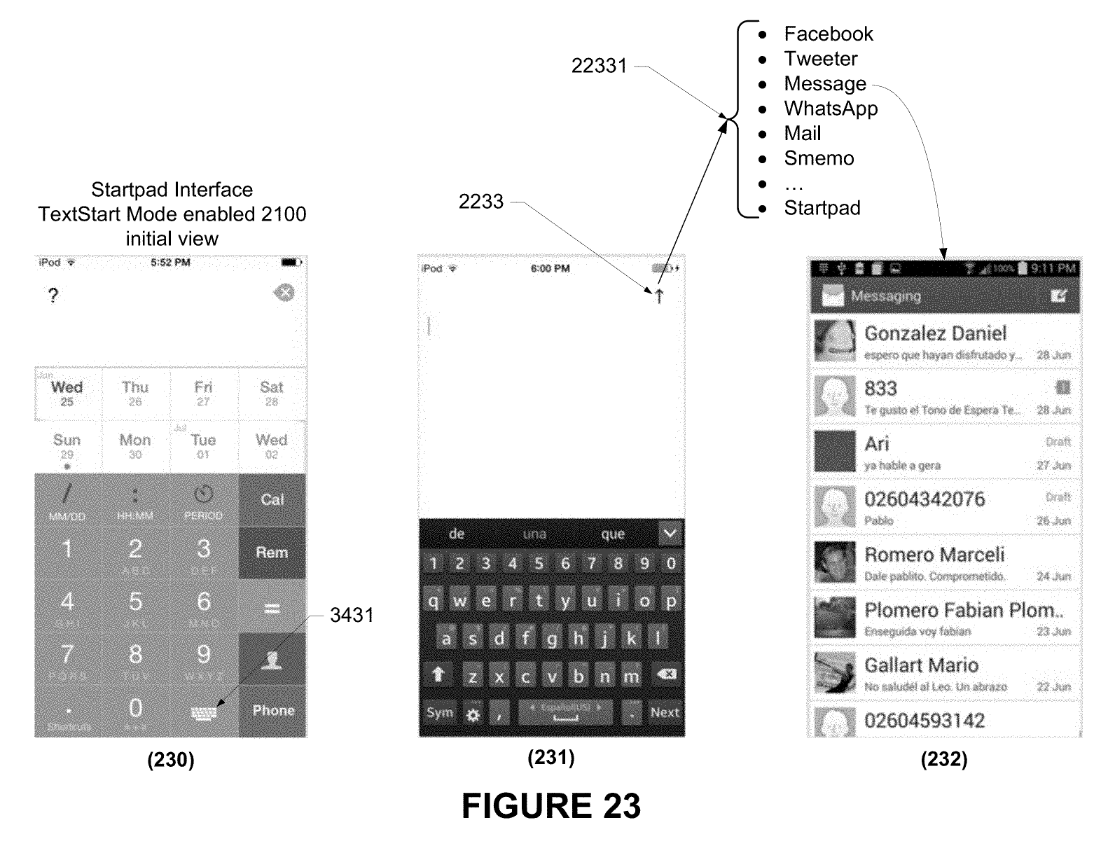

In FIG. 23, (230) shows Interface 2100(TextStart functionality enabled) initial view, where a single touch on the “Qwerty” button 3431 will make that Assistant 1000 brings the Text Input Interface 223 without any text preloaded, for the user to start writing directly from there. Through the “Action” button 2233 he or she could process his intentions in respect to the entered text and perform the consequent action.

If the user wanted to abort the process of text writing and come back from the Text Input Interface 223 to Interface 2100, the button that will produce that action depends on the principles of action of each OS where Assistant 1000 were installed. For example in some OS the “back” action has a dedicated button assigned (Android), while in others the back button must be defined as a graphical button for each situation (iOS 7). If the latest mentioned situation were the case, the return to Interface 2100 action could be included among the options of Dialog box 1255 (22331).

7) Advance Features of Time Management Through Assistant 1000:

In this section of this Patent Application it will be explain how Advance features of Time Management of Assistant 1000 results both in merely Informative Outputs (Interface 2000 as Informant 1060) according to the Context Achieved 2010 and how those Time related Outputs can be used as new user's Inputs 1004 about the Time parameters involved in the process of creation of Calendar Events, Schedule Reminders, Alarms and Timers.

For all the examples that will be cited about Advance features of Time Management through Assistant 1000, the Interface initial view will be 2000, which supposes that TextStart functionality is not enabled. However, this advance time management functionality of Assistant 1000 can also be process able with “Interface 2100 (TextStart functionality enabled)”.

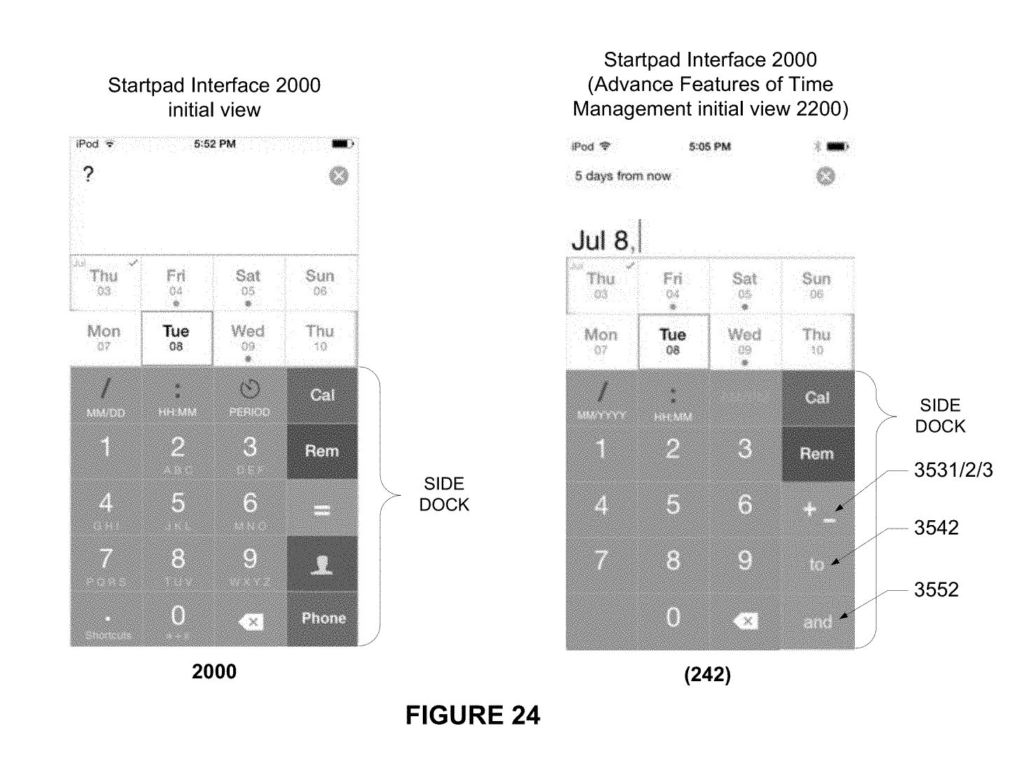

Every time Assistant 1000 recognizes that a Date or a Date-Time string has correctly been defined by the user, the “+−” 3531, “to” 3542, “and” 3552 buttons will be visible on Interface 2000 Side dock 35 and from which the user will have the chance to perform a new nature of functions about Time Management (FIG. 24).

7.1) “to” Operator 3542:

The “to” operator 3542 allows the user to define periods of time between two dates (or date/time), not mattering if those dates belong to the past or the future. It also allows the user to define periods of time between two different times without selecting a date (This is the case of irrigation system controllers where the time intervals represents “ruin times of each valve”).

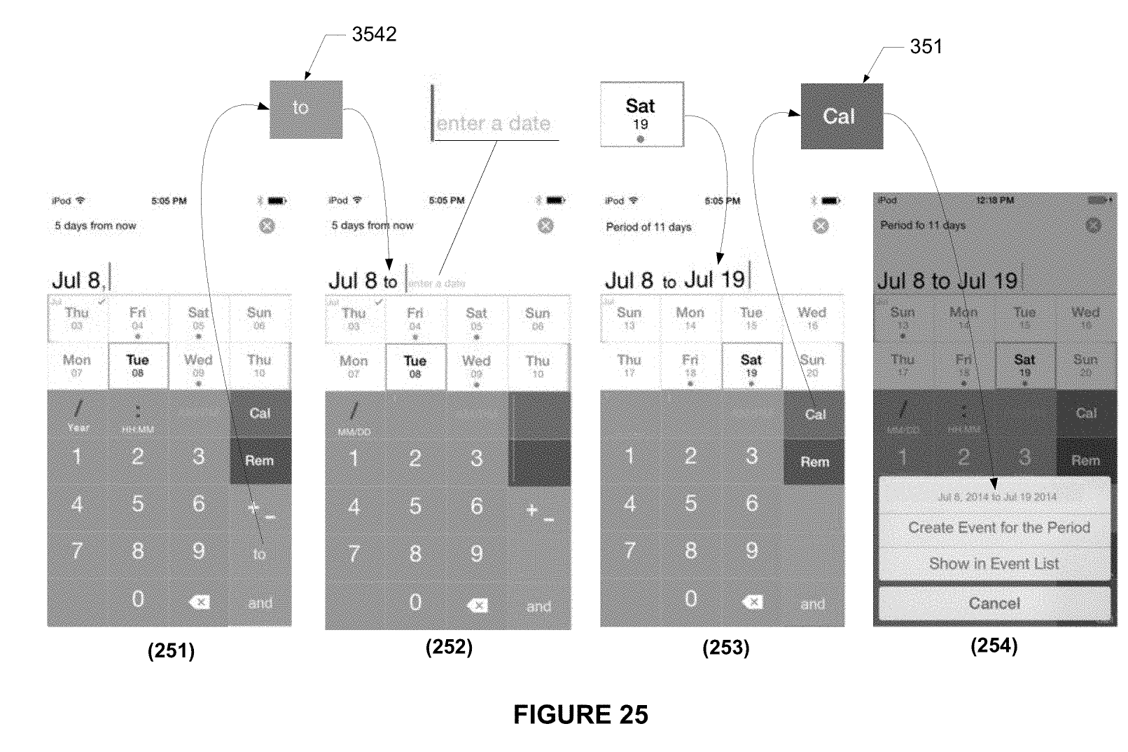

In FIG. 25, (252) shows the Process flow and Context Achieved 2010 after the user defined the date “Jul 8” by Interface 2000. In (251) if he or she touches the button “to” 3542, Display 31 will show the word “to” after the entered date by the user and the Place Holder 1254 “enter another date” persuading the user to enter another date.

Suppose that in (252) the user defined the date “Jul 19” resulting in (253) where it can be observed that the counter/notifier 311 informs “Period of 11 days” indicating how long the period results between the two dates entered by the user through the “to” operator 3542. This first of its kind Context achieved 2010 “system output” could be solely informative 1060 for the user, about the dates involved “Jul 8 to Jul 9” and about the duration of the period between them “Period of 11 days”. A real life example of this functionality it is to calculate someone's age was, is or will be at a defined date. For example, how old shall I be on July 25, 2020? To answer this question the user will have to enter his or her date of birth, then to touch the “to” 3542 button and then enter the other date (referring the other date to “Today” or to any other date, present, past or future) and Assistant 1000 will inform through the Interface 2000 counter/notifier 311 how many years, months and days is the period between those two dates, what can be interpreted as the resulting age from the date of birth to the second entered date or vice versa.

Multiple real life situations could find an answers through the “to” functionality of time Management through Assistant 1000.

It is important to add that the “to” functionality does not have “sign” as what is informed is a period between two dates, so it is the same to enter the older date first or vice versa.

Following with the example, in FIG. 25, (254) shows the Dialog Box 1255 that is showed after the user touches the Calendar button 351 In (253). In that dialog box 1255 (254), Interface 2000 will inform the user the period defined and also give he or her the possibility to create a Calendar event with the interface of the linked Calendar App (1002a or 1003a) or show the last date entered in that same linked Calendar App (1002a or 1003a).

In addition of the displayed actions of the dialog box 1255 of (254), the user could group that period with another period through the “and” operator 3552 which then appears (according to process flow and context achieved 2010) as an available button on the side dock 35 (253) (the “and” functionality 3552 will be further explained).

In an analog way, from (253) the user could manage the creation of an schedule reminder with the linked Reminders App (1002b or 1003b), with a due date between the period defined, or to show the Schedule Reminders list with the interface of the linked Reminders App (1002b or 1003b), for that purpose the user will have to touch the Rem button 352 (located on the side dock 35) (253).

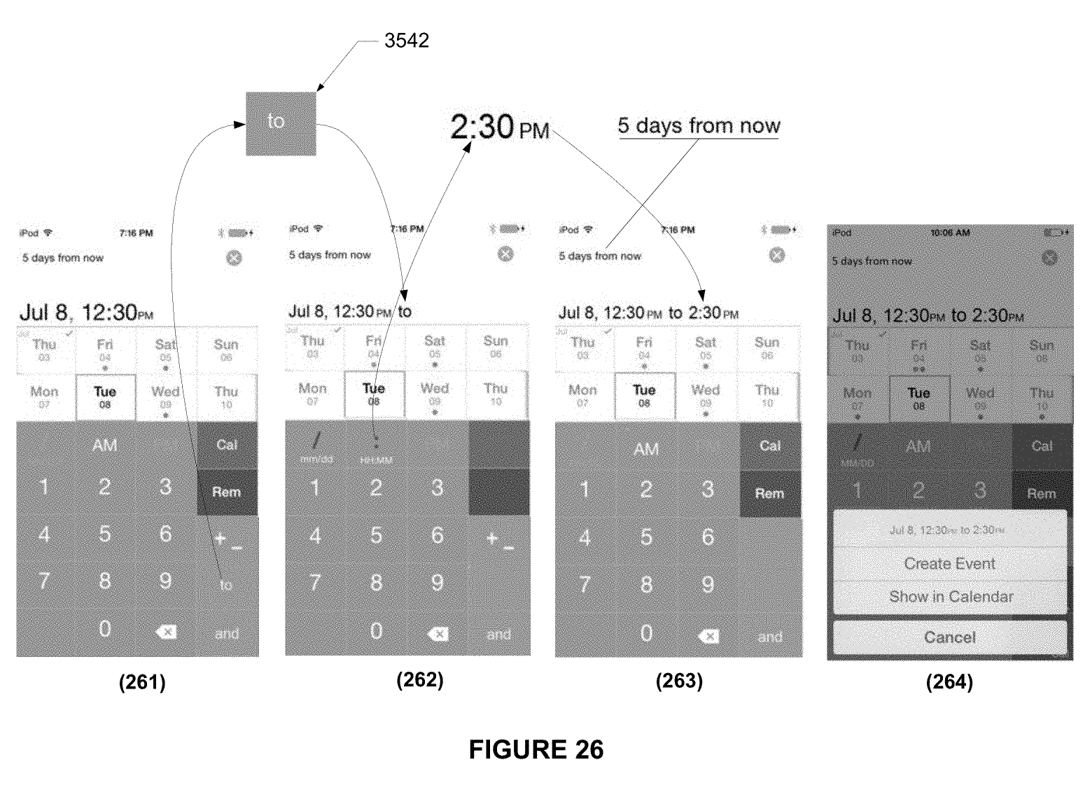

It is important to observe how the outputs of time produced by Assistant 1000 are bases for the user to perform additional inputs 1004 to the system. For example, if in (251), after the user defined date “Jul 8”, instead of defining a period of time through the “to” operator 3542, the user could enter an hour with the numerical Keypad 34 combined with the “:” operator 332, for example Jul 8, 12:30 PM (shown in FIG. 26 (261)) or instead have defined a different year through the “Year” button 3311 which is available according to process flow and context achieved 2010 in (251) of FIG. 25. In FIG. 26, (263) is the view which results of having the user previously defined an hour-min for that entered date in (261), and later in (262) having defined a second “hour-min” after the first “hour-min” entered “2:30 PM” what will define a period of time, which could result in a real life situation about “in Jul 8 from 12:30 PM to 2:30 PM” (263), and after this definition of time, the user could touch the Calendar button 351 on Interface 2000 and through a Dialog Box 1555 provided (analog to (254)), he or she could create a Calendar event on Jul 8 starting at 12:30 PM and ending at 2:30 PM; or the user could group that Date (or Date-Time) with another Date (or Date-time) through the “and” operator 3552 which then appears (according to process flow and context achieved 2010) as an available button on the side dock 35 (253) (the “and” functionality 3552 will be further explained).

7.2) “+” Operator 3531:

The “+” Operator 3531 allows the user to add a period of time to a date (or date-time) previously defined not mattering if the date predefined belongs to the past or to the future. It also allows the user to add a periods of time to a time without selecting a date (This is the case of irrigation system controllers where a certain Valve is set to start at a given time and during a period of time. The time intervals represents “run times of that valve”).

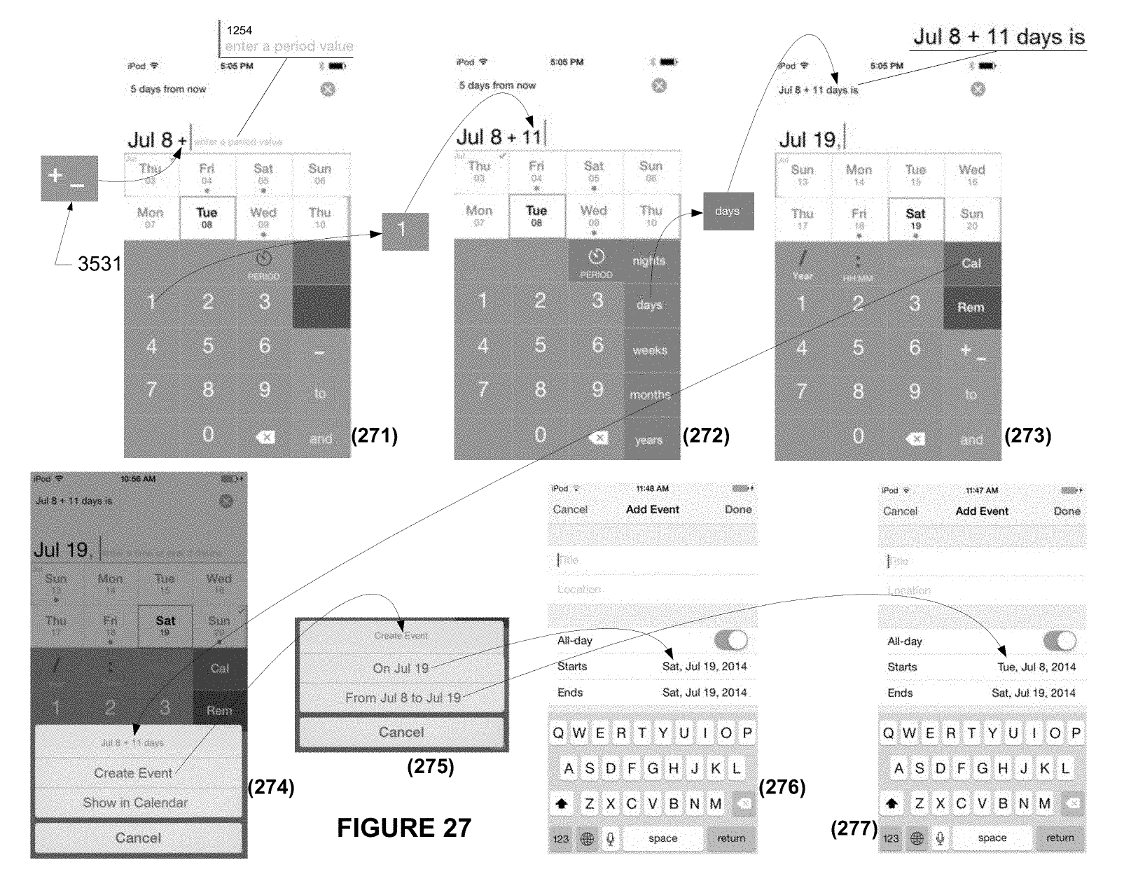

In FIG. 27, (271) is the resulting view of Interface 2000 of having the user touched the “+−” 3531 button after having entered “Jul 8”. Assistant 1000 assumes the “+” as the default operator and will show “+”in display 31 after the previously defined date “Jul 8” and after it, a place holder 1254 showing “enter a period value” will persuade the user to define a period of time that is supposed the user wants to add to the defined date (271). Pay attention in 272 that in this Context Achieved 2010 it is also available the “nights” button 3516 as a “Period” option what is about a real life situation resulting intuitive to add periods of time when the unit of increment is “night” (for example, when traveling if the user arrives to a certain City on a Date and spends there “x” nights . . . ). In (272) the user defined “11 days” which results in (273) where the “counter/notifier” 311 will inform “Jul 8+11 days is” and the resulting date “Jul 19” will be shown on Display Main View Area 313. In this Context Achieved 2010 (273), the user could perform the following actions:

(a) to define an hour for the resulting date “Jul 19” (explained in the next paragraph), “fine tune” the date according to this context achieved 2010 (273). Fine tune means that the user, after having the possibility to see by the panel of dates 32A the context of time, obligations and free days, could select another date if he or she sees more appropriate than the one previously defined. In the example of FIG. 27 as the 11 days period results on “Saturday” (Jul 19 of 2014 falls on Saturday) and maybe a weekend day is not an appropriate day of the week for a business event that would have the user had in mind;

(b) If the user in (273) touches the “Cal” button 351, through a dialog box 1255 (274), Interface 2000 will allow the user these possibilities:

(b1) To see the resultant date “Jul 19” with the linked Calendar App (1002a or 1003a) interface (not shown in FIG. 27), or to create a Calendar Event. In Dialog Box 1255 (274) the user chooses “Create Event”, another Dialog Box 1255 will be shown (275) so through it, he or she could choose:

(b1.1) To create a Calendar event on date “Jul 19” leaving the user in the New Event Creation Interface of the linked Calendar App (1002a or 1003a) to complete the desire remaining fields and consequently create the new event (276).

(b.1.2) To create a Calendar event from “Jul 8 to Jul 19” leaving the user in the new event creation interface of the linked Calendar App (1002a or 1003a) to complete the desire remaining fields and consequently create the new event (277).

(c) in 273, if the user touches the “Rem” button (not shown in FIG. 27), through an analog dialog box 1255 as the one shown in (274), he or she could perform analog actions as to the one explained in FIG. 27 but the correspondent analog dialog box 1255 showed in (274) would be not about to Show Calendar or to Create an event, but to Show the Schedule Reminders or to add a new Schedule Reminder.

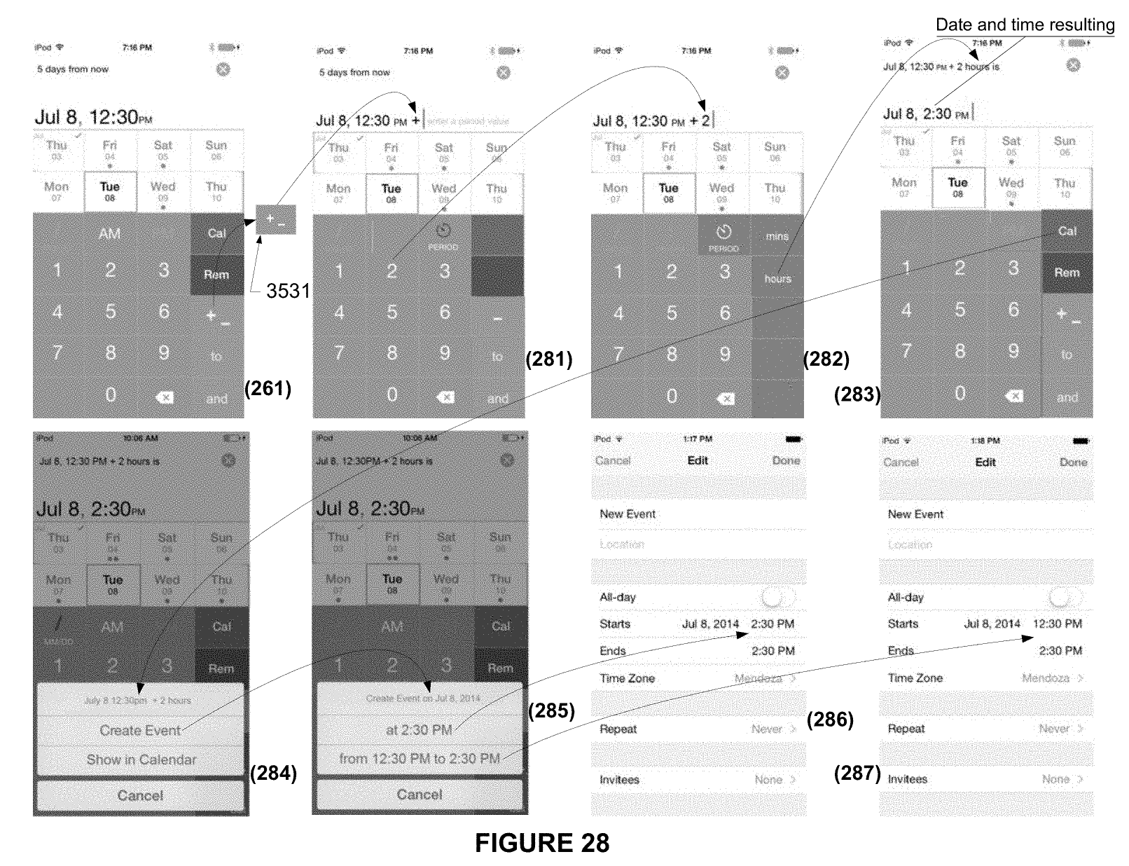

In addition, as exemplified in FIG. 28, having the user already defined date “Jul 8” but also defined a time “12:30 PM” (as (261) of FIG. 26 showed) and the user had touched the “+−” button 3531 (needed to enter the “+” operator), it will result in (281) where Interface 2000 provides the possibility to the user to define a PERIOD of time after the date and time shown in Display Main View Area 313 “Jul 8, 12:30 PM +” but also suggesting via a Place Holder 1254 “enter a period value”. Cases like this where the string of time defined were a date-time string (281), Interface 2000 will have the PERIOD options restricted to minutes and hours (282). If in (282) the user defined a period of 2 hours, it would result (283) where it can be observed that the “counter/notifier” 311 shows “Jul 8, 12:30 PM +2 hours” and the Main View Area of Display 313 will show the resulted date and time “Jul 8, 2:30 PM” as it shows (283).

From this Context Achieved 2010 (283), besides the resultant date-time “Jul 8, 12:30 PM”, it is also defined a PERIOD of time between the original date and the resultant date, then the user could:

(a) Fine tune the date and/or time (fine tune was previously explained).

(b) Then, if the user's intension were to create a calendar event, he or she would have to touch the Cal button 351 in (283) and through a dialog box 1255, choices of creating a calendar event will be shown (284), requirement that will make another dialog box 1255 appear giving the user the choice to create a calendar event on the resulted date and time “Jul 8, 2:30 PM” or create a calendar event for the period of time between the initial date and time “plus (+)” a duration (PERIOD) of two hours “On Jul 8 from 12:30 PM to 2:30 PM” (285). This way the user could complete other fields of the new event by the interface of the linked Calendar App (286) (287).

(c) By the dialog box 1255 shown in (284) the user could also choose to see the resultant date-time “Jul 8, 2:30 PM” by the interface of the linked calendar App (not shown in FIG. 28).

7.3) “−” Operator 3533:

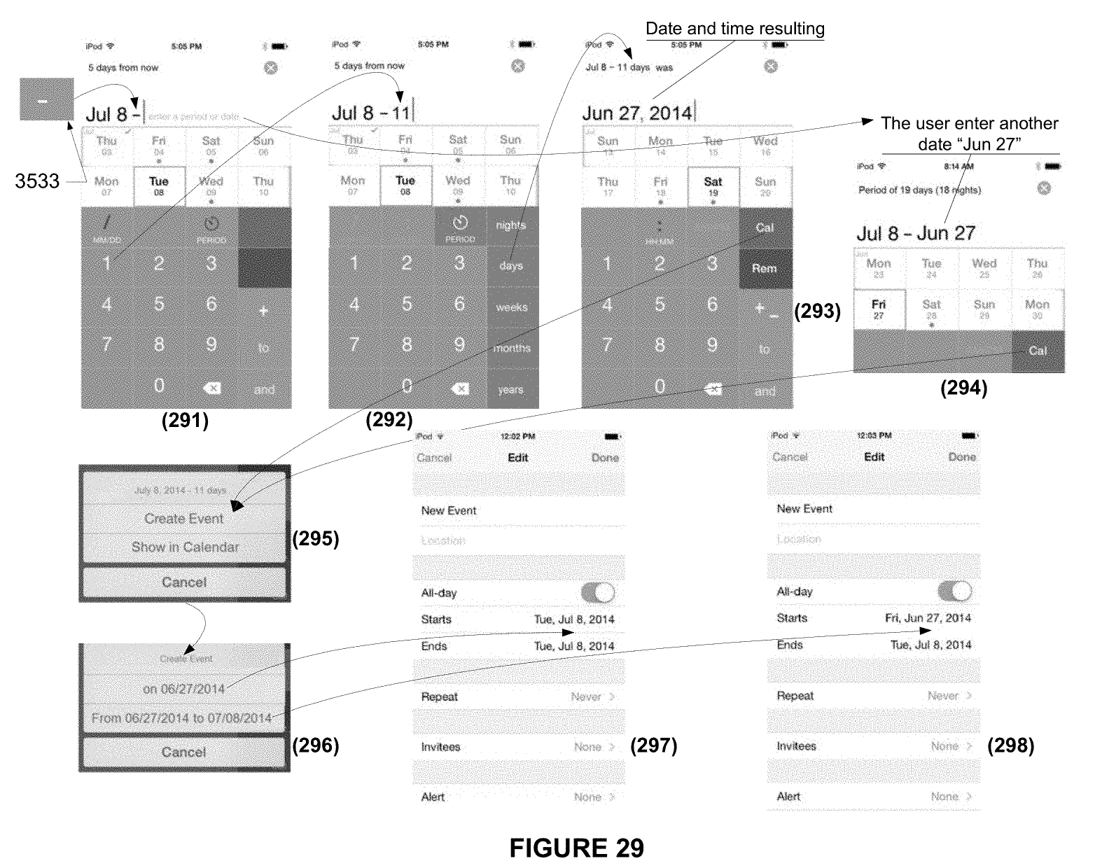

The “−”Operator 3533 allows the user to subtract a period of time from a Date (or date and time) previously defined by Interface 2000 not mattering if the predefined date belongs to the past, present or to the future. It also allows the user to add a periods of time to a time without selecting a date. To follow with the example, if in (271) of FIG. 27, after the user having entered “Jul 8”, he or she touches the “−” button 3533 (as the default first input of the “+−” button 3531 is the “+” button 3532, after the first touch to the “+−” button 3531 which means selection of “+” operator, the “+−” button 3531 becomes the “−” button 3533 and if selected becomes “+” button 3532 again and this behavior will be repeat indefinitely), so if in (271) the user touches the “−” button 3533 it would result (291) of FIG. 29 where the Main View Area 313 will show “Jul 8 −” and a place holder 1254 will appear showing “enter a period or date”.

Subtracting a date (FIG. 29): (294) is the resultant view after the user entered a second date in (291) and where the “counter/notifier” 311 informs the resultant period between those dates “Period of 19 days (18 nights)” (294).

Subtracting a Period (FIG. 29): In this case, the user will get value of the functionality of the Period button 333 defining the amount of time (nights, days, etc.) which he or she wants to subtract from the original date, which will result in a second date. In the example of FIG. 29, (293) is the resultant view having the user subtract a period of 11 days from “Jun 27, 2014” in (292). While the “counter notifier” 311 will show complementary information “Jun 8-11 days was” (293) referring to “Jun 27, 2014” (every time that a subtraction of time resulted in past time, the counter/notifier 311 will use the word “was” instead of “is”)

In FIG. 29, in (293), it can be seen that in addition to the resultant date “Jun 27, 2014”, also results “Jul 8-11 days” period defined between the original date “Jul 8” and the resultant date “Jun 27”, then the user will be able to:

a) Define an hour for the resultant date or fine tune the date (fine tune was previously explained)

b) If in (293) the user touches the “Cal” button 351, through the dialog box 1255 shown (295), Assistant 1000 will give him or her the possibility to view the resultant date “Jun 27” or create an event on it with the interface of the linked calendar App (1002a or 1003a).

If in dialog box 1255 the user touches “Create Event” (295), an additional dialog box 1255 will give the options of (296):

B1) create a calendar event on the resultant date “Jun 27, 2014” showing the user the new event creation interface of the linked calendar App (1002a or 1003a), so from there he or she complete the desired additional fields to create the event (297);

B2) create a calendar event for the duration of the PERIOD “Period of 11 days (10 nights) between the dates “Jul 8-Jun 27”, having preloaded the Start and End dates in the new event creation interface (298) of the linked calendar App(1002a or 1003a);

c) Define through Interface 2000 desired Alerts and/or a Repetition Scheme for the New Event that could the user have in mind (further explained).

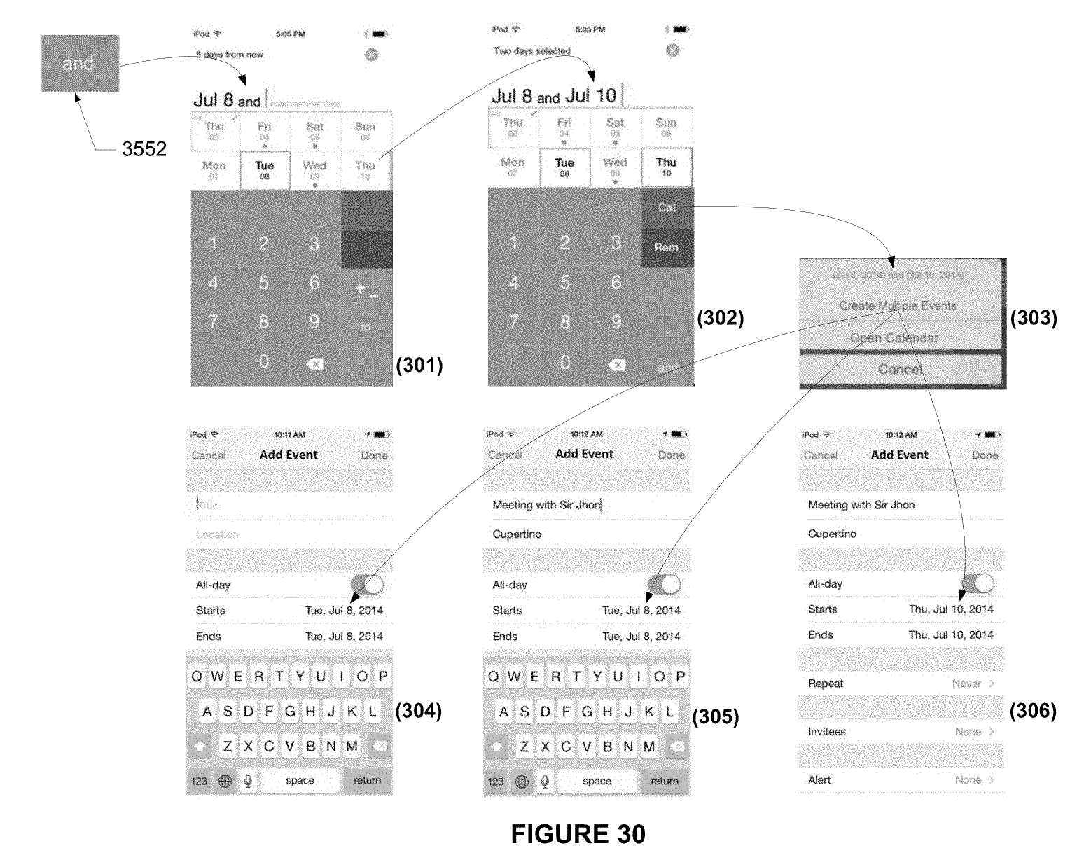

7.4) “And” Operator 3532 (FIG. 30).

The “and” operator 3552 allows the user to group different dates (or date-time) to proceed with action/'s related to the grouped dates. It also allows the user to group different times or periods of time without selecting a date. Grouping different times is useful to create multiple alarms in one process.

Following with the example of FIG. 30, (301) is the resultant view if the user in (251), after having entered “Jul 8”, touches the “and” button 3552; thus, the place holder 1254 “enter another date” will be shown persuading the user to choose another date. In (301) the user chose “Jul 10” what resulted in (302), being possible for him or her to group more than two days if desire and consequently the “counter/notifier” 311 will act as a “Counter” showing the amount of dates selected as for example “two days selected”.

During the grouping of dates process through the “and” operator 3552, every time the user defines a date through an available way (the Period functionality is disable in this Context Achieved 2010), this date will be shown as selected in the panel of dates 32A among the previously selected (grouped) dates (302), but every time the user touches a previously selected date in the panel of dates 32A this action will deselect that day and every time this process of selection and de-selection occurs, both the counter/notifier 311 and the in Display Main View Area 313 will show in accordance.

Due to “and” operator button 3552 only groups elements (dates), there is no period resulting, so the consequent user actions will be referred to the grouped elements of date or date-time. If in (302) of FIG. 30 the user touches the Cal Button 351, possible actions will be those shown by the dialog box 1255 (303):

a) Create Multiple Events: Interface 2000 will show the classic panel of new event creation of the linked Calendar App (1002a or 1003a) having preloaded the first value of date or date-time that the user grouped with the operator button “and 3552 “Jul 8” (304). Then, via the interface of the linked Calendar App (1002a or 1003a), the user will be able to define other desired fields as the title of the multiple events that are in process of creation (305) what will result in (306) (he or she will also be able to complete additional fields to that an specific event and not to all the others. Then, from the interface of the linked Calendar App (1002a or 1003a), when the user confirmed the creation of the first event (touching “Done” in (304), Assistant 1000 will require the OS to the new event creation panel of the linked calendar App having preloaded the second date or date-time initially grouped by the “and” operator button 3552 “Jul 10” what would result in (306); then from the linked Calendar App interface (1002a or 1003a), the user could proceed and terminate the creation of that “second” Calendar Event of the group.

According to own characteristics and modus operandi of both the OS and the linked Calendar App (1002a or 1003a), in some cases, Assistant 1000 could make the OS show the Event Title “Meeting with Sir John” and some other field that the user could have defined for the first date “Jul 8” (305) via the linked Calendar App (1002a or 1003a) interface, already preloaded in the subsequent panels of new event creation corresponding to the other dates “Jul 10” (306).

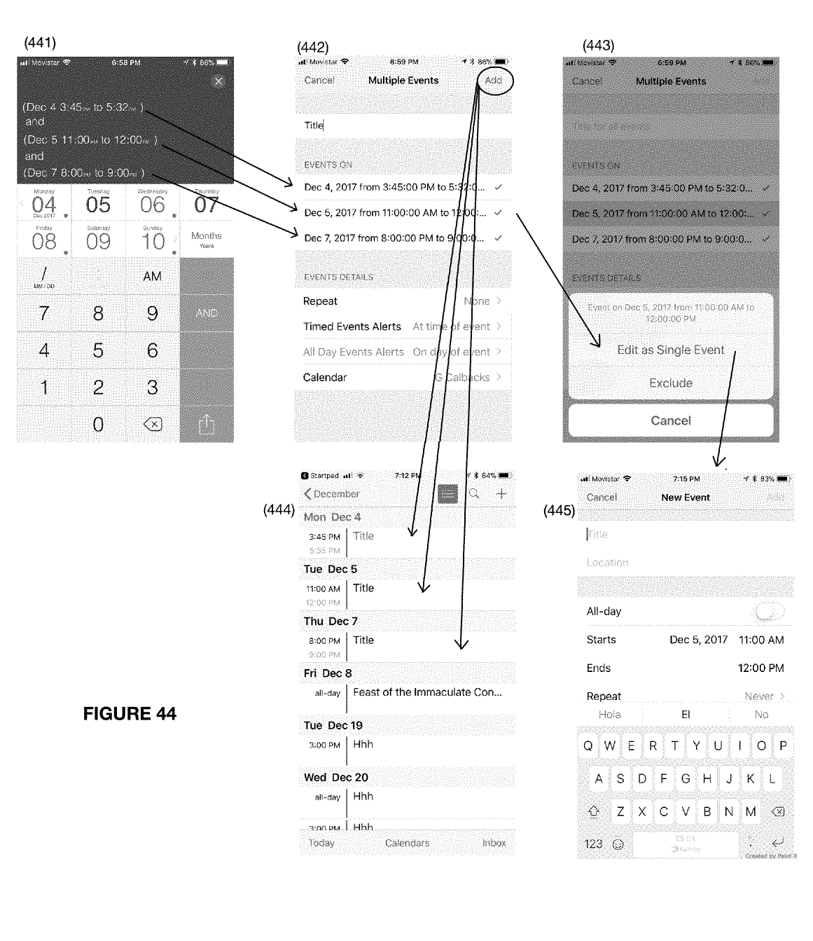

Multiple Event and Multiple Alarms panel. FIG. 44 shows a new nature method to pass information of time pre processed by Assistant 1000 to a Calendar App, having used the And operator to group different date/date time values with the intention to create multiple Calendar Events. So far, the way Calendar and Reminders Apps works, don't allow the user to create an event on one day at a given time and to repeat it in a different day/s but at a different times. So far, to process this real life situation, the user has to create as many single calendar events as the time differs between for each day. As it was demonstrated, with Assistant 1000 and Interface 2000 it is possible to define: “(Dec 4 3:45 pm to 5:30 pm) AND (Dec 5 11:00 am to 12:00 pm) AND (Dec 7 8:00 pm to 9:00 pm). In FIG. 44, (441) shows Assistant 1000 and its interface 2000 having defined this date time values grouped by the “AND” operator. (442) shows the Multiple Events Creation Panel where the date or date time values entered through interface 2000 are shown in different fields. Events Details section allows the user to define Events details that will impact in all the events to be created. The user can also enter a unique Event Title that will impact in all the events to be created. In spite of each time value could be processed in batch through the Multiple Event Panel, the user is allowed to edit any of them as single event (443) or exclude it for the batch creation. (444) shows the Calendar App view showing the three events that were created through Assistant 1000/Interface 2000 and the Multiple Event panel specifically conceived for this purpose. (445) shows the Calendar App with the date and time values as the user decided to Edit it as single event (443).

In Assistant 1000, the resultant functionality of the “and” operator 3552, at the same time it simplifies and improves the process of new calendar event creation allowing to “repeat” an event but not being limited to the classical way to setting fixed repetition schemes (daily, weekly, monthly, etc.) as dates in Assistant 1000 can be grouped specifically using the “and” operator button 3552 in a versatile and ergonomic way not seen so far.

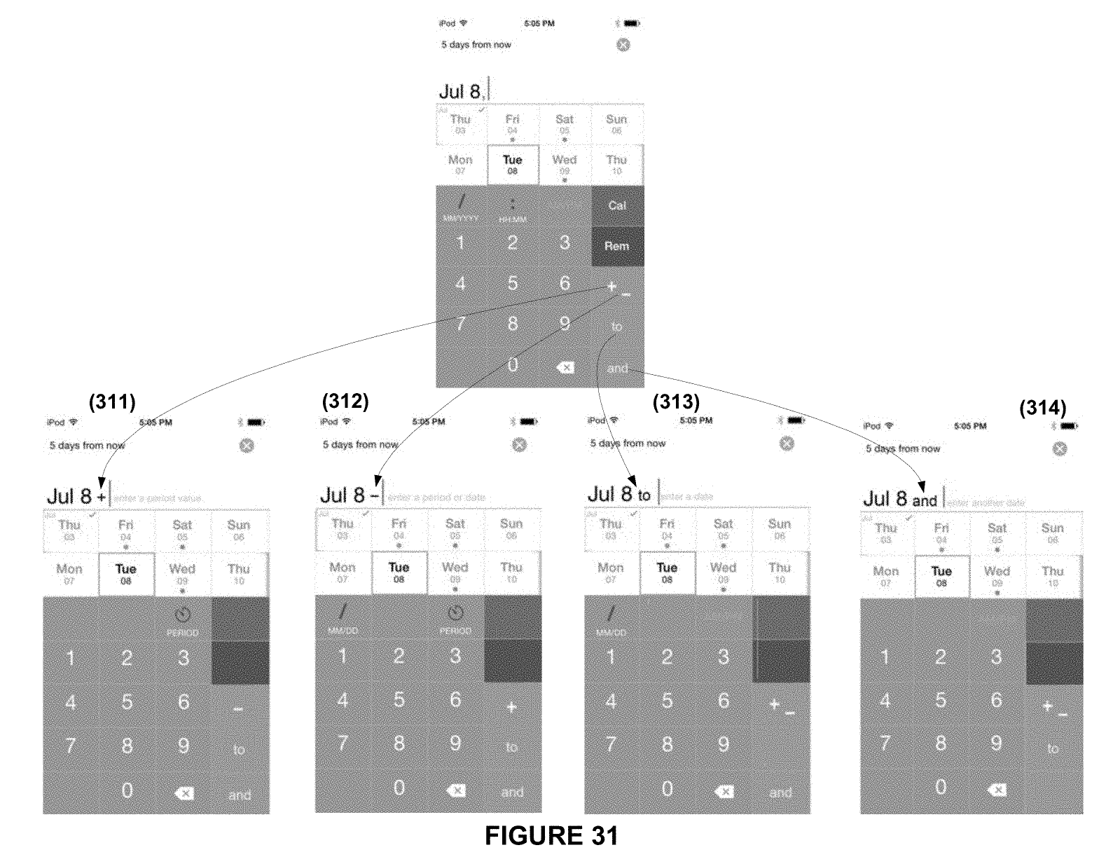

FIG. 31 synthetizes the consequent actions the user can perform through Assistant 1000 and its Interface 2000 after a previously defined a date. Observe in (311), (312), (313) y (314) how Place Holders 1254 differs according to the kind of operators “+” 3532, “−”3533, “to” 3542, “and” 3552 used.

8) Assistant 1000 Defining and Editing Time Values Involved in the Creation of Calendar Events (Regarding to: (a) Event Start/End Date and Time, (b) Event Alerts and (c) Event Repetition Scheme):

Assuming Interface 2000 as Assistant 1000 Assistant Initial View (shown in FIG. 2), having the user defined a date, for example “Jul 8” (shown in FIG. 25 (251)), Interface 2000 will allow the possibility to define values of Time involved in the Creation of Calendar Events and Schedule Reminders.

In FIG. 26, (263) shows the resultant view and Context Achieved 2010 of having the user defined “Jul 8, 12:30 PM to 2:30 PM” by using the “to” operator 3542 where that string of Date-Time defined could represent for the user the Date-Time and the Duration (period Involved) values necessaries to define the Start and End times of a possible new calendar event to be created afterwards.

8.1) Date or Date-Time definition, Contextual Information Shown and Fine Tuning of the Entered Values of Date and Time:

As was previously explained in “Time Management through Assistant 1000”, Interface 2000 allows the user to define a date or a date and time in a versatile way. After the Panel of Dates 32A not only is a means to enter dates into the system, but it also provides the user with visual information in each cell of dates about the existence of time related pieces of information (calendar events, schedule reminders, birthdays, holidays, Alarms, mainly) which are data provided by their respective linked Apps (1002 or 1003).

Having the user previously defined a Date, it is vital for the user to have contextual information necessary to make some soft changes (fine tuning) of the values of date and time defined. For example, having the user defined a period of 15 days (defined by the numerical Keypad 34 combined with the “Period” button 333, the resulting date could fall on Sunday, situation that the user will see as the panel of dates 32A auto scrolls (as a slave of the Period function 333) providing him or her in Context and commitments of time. This way the user could rearrange the date of the event to be created paying attention to the already created events or reminders that could exist as they are shown in each cell of the panel of dates 32A and according to the kind of day of the week of the selected date (Sunday in this case).

This context Achieved 2010 is directly provided by Interface 2000 acting as Informant 1060 without being necessary to the user to open the respective Calendar or Reminders Apps.

In that Context Achieved 2010 and also through Interface 2000, the user could modify the time of a string of date-time without changing the date defined or vice versa (as was previously explained)

This situation is frequent in real life situations after when the user thinks in a date or time for the creation of a calendar event but after realizing that the thought Date is not appropriate for a the creation a new calendar event he or she had in mind, the user could think in another date but still maintaining in mind the time that was previously thought to the original date. Interface 2000 provides freedom to change dates without the necessity to enter the whole date-time string again at the same time the panel of dates 32A shows calendar events, schedule reminders and birthdays and being the same panel of dates 32A a means to change the date for a more appropriate one if desired by the user.

In addition, the counter/notifier 311 provides the user complementary information with respect to the date or date-time defined showed by the Display 31 as for example about how far from Present Time it is the defined date-time or the resultant duration of a period defined through the “period functionality 333 (previously explained).

That is how Assistant 1000 generates a proper context achieved 2010 by its Interface 2000 to the user with respect to the feasibility and convenience to create a calendar event on a specific date at a specific time or if it is needed to make a change in any of the time values involved so far.

In addition to what was above explained, it will be demonstrated how Interface 2000 can also is a means to define the values of time involved in the creation of calendar events, with respect to Start and End times, alerts and repetition schemes definitions.

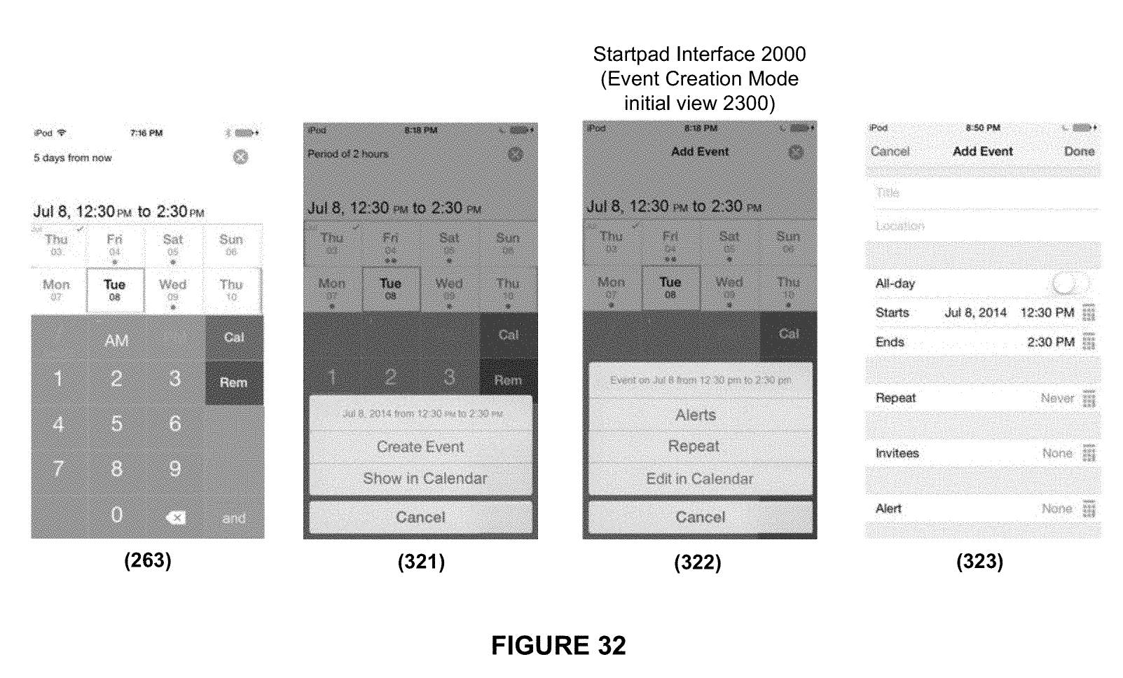

8.2) Defining the Duration of Event (Start and End times) (FIG. 32):

Having the user defined a date-time by any of the methods already explained, through the “to” operator button 3542 Interface 2000 allows the user to add a period of time (duration of the event) or to define another date or date-time or simply define the time (which would represent the End time of the event) resulting in a Process Flow and Context Achieved 2010 as exemplified in (263) where “Jul 8, 12:30 PM to 2:30 PM” was defined by the user. If the user touches the Cal button 351 of the side dock 35, Assistant 1000 will show a dialog box 1255 similar to the one shown in (321) of FIG. 32 to inform the user about the date or date-times involved so far, also giving him or her the option “Create Event” or “view in Calendar” that date or date-time. If in that dialog box 1255 the user touches “Create Event”, Interface 2000, without altering the context achieved so far 2010, will enter into “New Event Creation Mode” (322) showing on the center area of the counter/notifier 311 the “Add Event” title being this title a feedback for the user to understand that he or she is in the process of creation of a calendar event on the date and time previously defined which are displayed in Display 31.

At the same time, Interface 2000 will inform in the title of the dialog box 1255 (322) the values of start and end time of the Event, for example “Jul 8, 12:30 PM to 2:30 PM” and giving the user the following options: Alerts, Repeat, Edit in calendar, Cancel. If the user touches Cancel, Assistant 1000 will understand that the process of creation of the new event was cancel so the previous context Achieved 2010 will have to be restored to (321) and if the user touches Cancel in (321) the Context Achieved 2010 would backward restored displaying something similar to what is shown in ((263) also in FIG. 26).

In (322), if the user touches “Edit in Calendar”, Assistant 1000 will require the OS to bring the Linked Calendar App interface (1002a or 1003a) showing the values of Event Start and End times which were preloaded via Interface 2000 (323). From there the user could define other desired fields to end the process of the new event creation.

So far and through the usage and versatility of Interface 2000 “to” operator button 3542 , the user could defined the main values of Time needed to create a Calendar Event which are related to when the event starts and when it ends. This could be done from a unique interface and with the versatility to define the Start Date and Time either adding a “Period” (duration) to the Start Date-Time (Through the period button 333) or defining two different Date-Time values using the numerical Keypad 34 combined with the “/” button 331 and “:” button 332 Operators, or directly defining a date by scrolling the Panel of Dates 32A and selecting a date (by touching the cell that contains the desired date on the Panel of Dates 32A).

All the previous definitions can also be made at the same time the user is informed by the Panel of dates 32A about the existence of prior created Events, Reminders, and Birthdays, which were displayed in their respective dates (cells of the Panel of dates 32A).

In another approach, if the user wants to make use of Assistant 1000 for defining Event Alerts or Event Repetition Schemes, in the dialog box 1255 proposed by Interface 2000 in “New Event Creation Mode” (322), he or she can choose “Alerts” or “Repeat” as desired.

8.3) Defining Alerts with Interface 2000:

8.3.1) Background: Until now, many “solutions” have been approached to define alerts for event creation. The most common method is to choose among different fixed alerts options. For example, “at time of event, 1 min before, 10 min before, 30 min before, 45 min before, 1 hour before, . . . , 6 hours before, . . . , 2 days before”. In many real life situations, this method does not satisfy user's intentions when he or she pretends to be alerted in a different moment than those of the fixed options. This method neither provide the user the context of time when those alerts resulted. For example, for an event start date-time were on a given Monday at 11 PM, if the user wants to be alerted two days before, for the case that a preset of “two days before” were available, the user would not know when exactly that alert would result, having the user to estimate himself, and not having any control to fine tune the hour to be alerted two days before (normally, presets of alerts of x days before assign the same time of the Event Start time). In this example, two days before resulted on Saturday night at 11 PM and it is highly probable that a Saturday night at 11 PM is not a convenient time to be alerted of an event on Tuesday at 11 PM. It can be concluded so far that Fix Alert Preset Methods fall short in this real life situations being only acceptable options to define alerts close in time to the Start time of the event, for example, “one hour before”.

To solve this user experience limitation, various Calendar Apps have developed custom interfaces to define alerts in a more convenient way. In most cases, those methods are proprietary of their respective Apps and suppose their respective learning curves that in many cases, are complex and not intuitive.

We can conclude that there is no typical and intuitive method commonly used to define real life situation “custom” alerts.

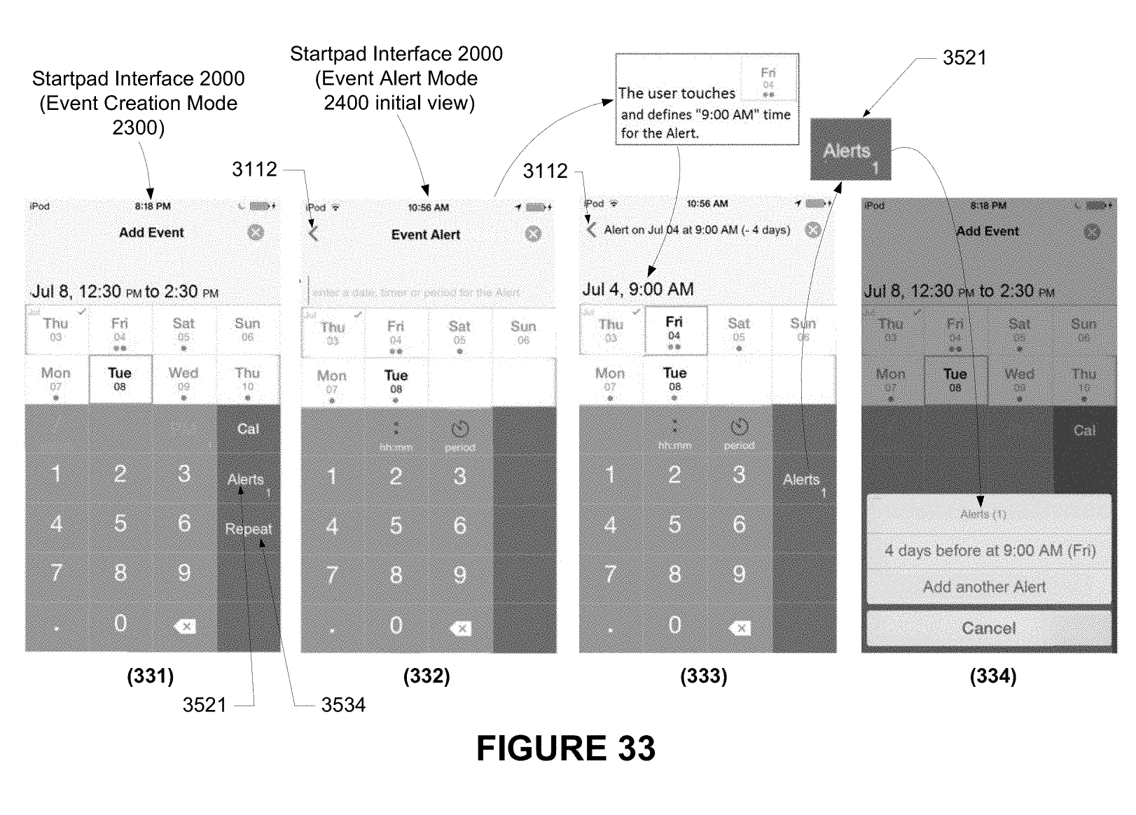

8.3.2) Defining alerts with Interface 2000: Following with the example and considering that the user wanted to use Assistant 1000 to define Event Alerts, in FIG. 32 he or she should touch the Alerts option in the dialog box 1522 (322). This user selection would result that Interface 2000 enters into “Alert Edition mode” shown in (332) of FIG. 33 visually adapting itself according to process flow and Context Achieved 2010: (a) the Title will become “Event Alert” and the “arrow to the left” button 3112 will now appear that if touched will take back “Interface 2300 (Event Creation Mode)” (331); (b) the place holder 1254 “enter a date, time or period for the Alert” will persuade the user to define a date or period for the alert (332); (c) the panel of dates 32A won't show as options upcoming dates after the event date (332) consequently not being possible to scroll the panel of dates 32A to the future (This locking is because Alerts can only be defined before the event date and dime and not after it.

In this Context Achieved 2010 (332), the panel of dates 32A will allow the user to visually have an idea of the existence of schedule events on the previous dates of the event. In (332) the user could choose any desire date prior to the event date or on the same date of the event. For example, (333) results after the user selected in the panel of dates 32A of (332) the cell corresponding to “Friday 4 of July” and also entered the exact time he or she wants to be alerted on that specific date “9:00 AM”. In (333), in a colloquial language, the “counter/notifier” 311 will inform the created Alert so, in the Side Dock 35, the Rem button 352 now becomes the Alert Button 3521 which also show a number on its bottom section indicating the quantity of alerts created by the user so far. If in (333) the user touches the arrow to the left button 3112, “Interface 2300 (Event Creation Mode) “will be shown (331).

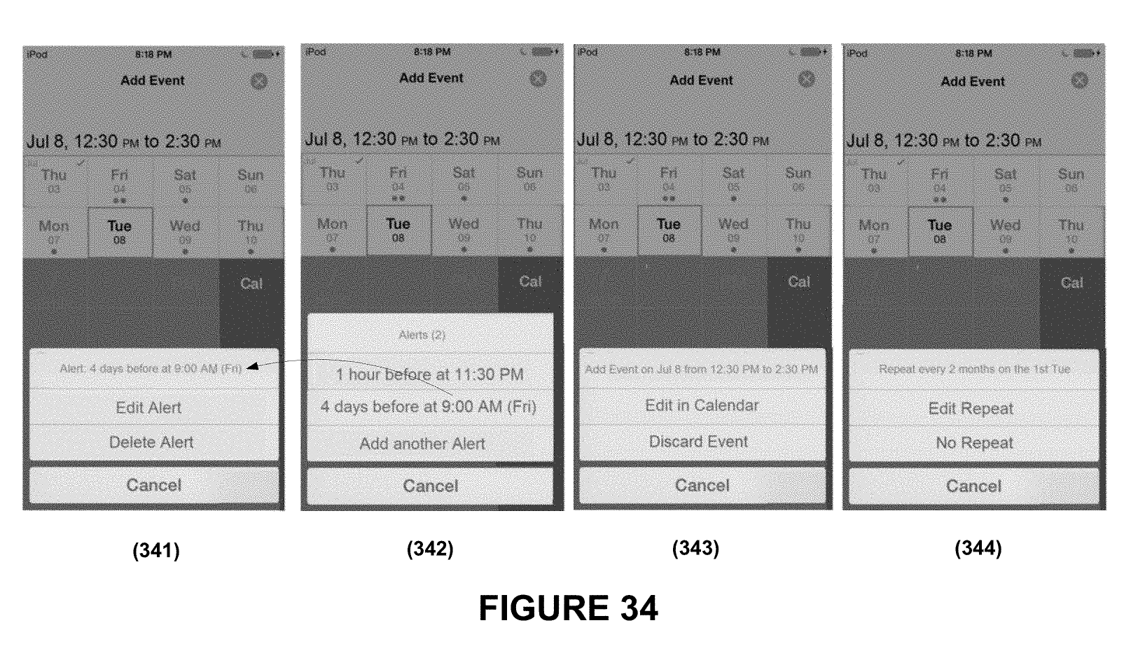

Cancellation of the “New event creation process” will be achieved every time the user touches on the upper right button area 312 the “Clear Display button” 3122 which is available according to process flow and Context Achieved 2010 what will show the dialog box 1255 shown in (343) of FIG. 34 giving the user the possibility to proceed through the linked Calendar App interface (1002a or 1003a) as it is shown in (323) of FIG. 32. If the user chooses “Discard Event” instead (shown in (343) of FIG. 34, it will result in (263) of FIG. 32 which was the context achieved 2010 taken in this example as the starting point of the process.

In FIG. 33, If in (331) or (333) the user touches the button “Alert” 3521, a dialog box 1255 will be shown with the different alerts created so far (334) also giving the user the possibility to create a new Alert. (334) shows the case where just one alert has been defined so far “4 days before at 9:00 AM” (Fri)” that if touched results in (341) of FIG. 34 showing a dialog box 1255 with the options to delete or edit the given alert.

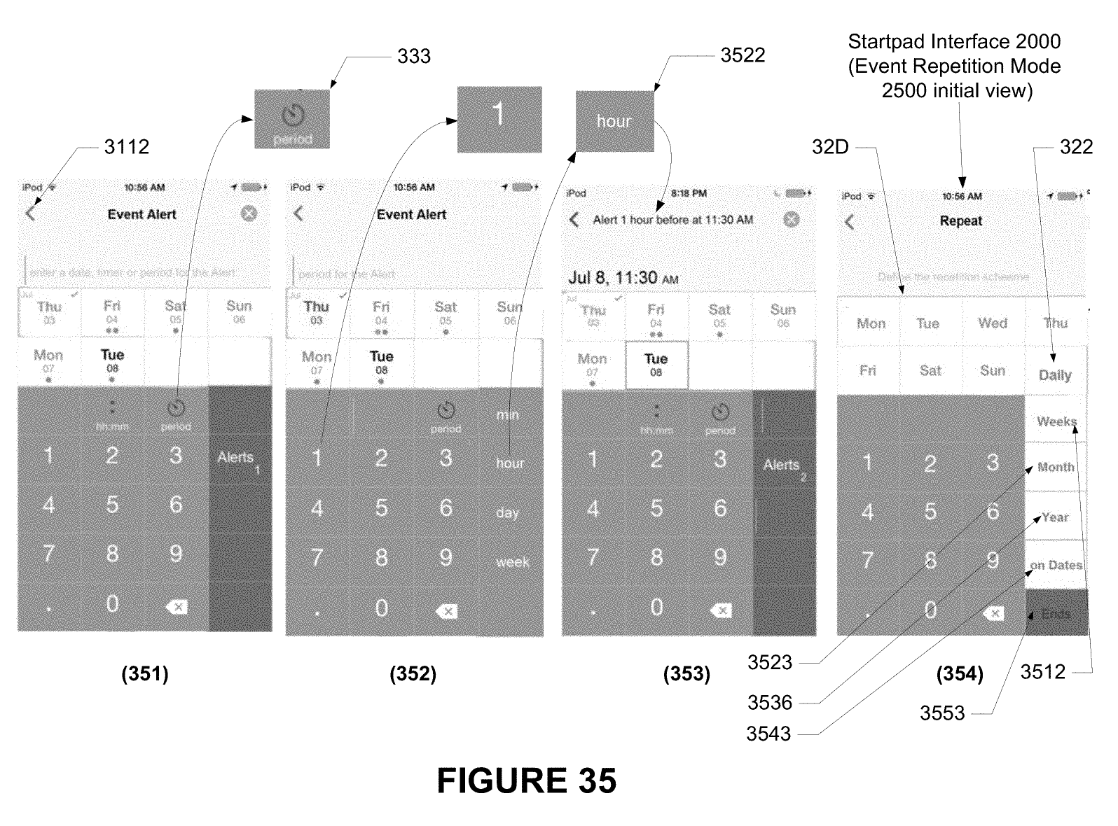

Alerts can also be defined through the “Period functionality button” 333 by choosing the correspondent button (minutes 3511, hours 3522, days 3535, weeks 3544) according to the kind of period that the user had in mind and its quantity. In the example shown in FIG. 35, from (351) and through (352), the user defined a second alert “one hour before the event” by defining a Period of “1” “hour” (352) and consequently Interface 2000 will show on the main display area 313 the date and time which corresponds to the entered period while the counter/notifier 311 will confirm the created alert giving information about it (353). Pay attention in (353) that the number inside the Alert button 3521 is now “2” indicating the user the quantity of alerts created so far. If in (353) the user touches the Alert Button 3521 (which shows number “2”), it will result in (342) of FIG. 34 where Assistant 1000, through a dialog box 1255 will show the two alerts created so far at the same time it will allow the user to manage each of those alerts by touching any of them in the dialog box 1255 (342). In FIG. 34, (341) exemplifies the case where the user chose the alert “4 days before at 9:00 AM (Fri)” in the dialog box 1255 showed in (342).

FIG. 35: Every time the user touches the “Arrow to the left button” 3112 located on the left of the “counter/notifier button” 311, or touching the same message of the “counter/notifier 311, “Interface 2300 (Event Creation Mode)” will become available (331) of FIG. 33) what will inform the creation date of the event, when it ends, and it will also allow the user to touch the “Repeat” button 3534 to define a Repetition Scheme for the event if desire (further explained) or to touch the Clear Display button 3122 to clear display.

In (331) of FIG. 33, at the moment the user touches the Cal button 351, Assistant 1000 will require the OS to bring the “New Event Creation Interface of the Linked Calendar App” (1002a or 1003a) which will be showing the time values of Creation Date and when it ends and also the Alerts that had been defined through Interface 2000 (not shown in the example). From there, by the Linked Calendar App (1002a or 1003a) interface, the user will be able to define other desired fields (title, invitees, etc.)

As it could be shown in the previous explanation, Assistant 1000 allows the definition of alerts in a versatile way while at the same time provides the user with contextual information by the panel of dates 32A according to context achieved 2010, helping the user be confident without having him or her to make estimations with his mind about when effectively falls an alert, and also being able, from a single interface (Interface 2000), to edit or delete the created alerts, and at any time having the possibility to continue the process with the linked calendar App (1002a or 1003a) to finally create the desire new calendar event.

8.3.3) Defining Repetition Schemes with Assistant 1000:

7.3.3.1) Background: A similar background as explained for Alerts, is what had happened so far about the ways of defining Repetition Schemes of Calendar Events, going from predefined schemes (Every day, every week, every 2 weeks, every months, every year) to custom interfaces which in most cases suppose the user to learn specific routines which are far from being a standard.

8.3.3.2) Different ways to Set “Repetition Schemes to Calendar Events or Schedule Reminders”:

According to what have been previously explained, if the user touches the “Repeat” button 3534 in (331) of FIG. 33 or the Repeat button 3534 on (333) of FIG. 33, Assistant 1000 will adapt its Interface 2000 entering into “Event Repetition mode” 2500 as shown in (354) of FIG. 35 allowing the user to define the desire repetition scheme in a versatile and intuitive way: (a) the Title will become “Event Alert” and the “arrow to the left” button 3112 will now appear that if touched will take back Interface 2000 to “Event Creation mode” (331) of FIG. 33; (b) the place holder 1254 “Define a repetition scheme” will persuade the user to define the desire repetition scheme for the event (354); (c) the time line panel 32 becomes the Panel of Days 32D showing the days of the week placing “Monday” on cell 1 and so on and the “Daily” button 322 will appear on Cell 8; (d) the side dock 35 will be a place for “Weeks” 3512, “Months” 3523, “Years” 3536 and “On Dates” 3543 buttons.

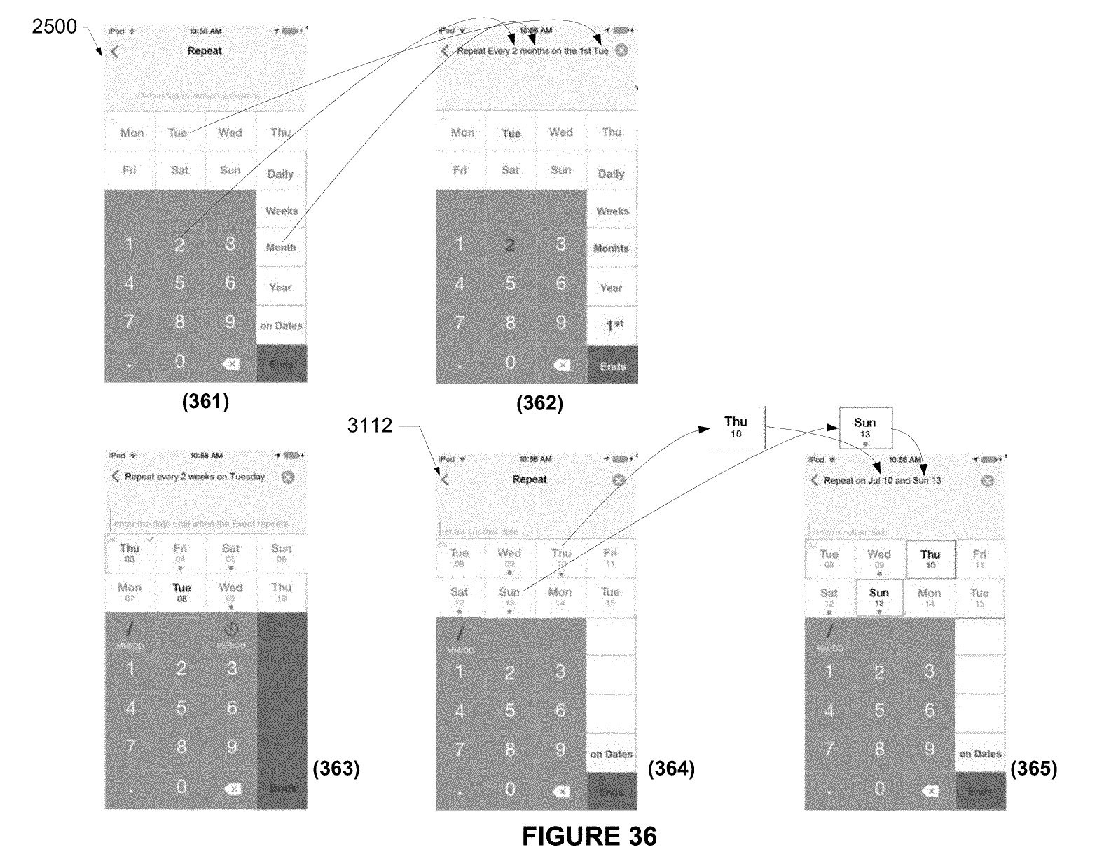

In FIG. 36, (361) shows Interface 2000 in Event Repetition Mode 2500 initial view. When the uses touches any button in (361), the touched button will change its color from grey to red (indicating selection of that button), while the message of the counter/notifier 311 will be informing the Repetition Scheme as being defined. For example, (362) results of the user having touched “Tue”, “Month” and number “2” buttons in (361).

In FIGS. 36, 37 and 38, it will be explained how from a unique interface (Interface 2000) the user will be able to define “all” possible modes of repetition involved in the process of creation of new calendar events or schedule reminders.

Following with the example, if in (361) of FIG. 35, having the user in mind to repeat the event every Tuesday, he or she should touch “Tue” and also touched the “month” button 3523 and enter number “2” by the numeric Keypad 34 so the counter/notifier 311 will inform the Repetition Scheme achieved at that moment “Repeat every two months on Tue” (not exemplified this intermediate instance). At the moment the user touches the “months” button 3523 in (361), Interface 2000 will enabled the “st/on” button 3543 which is a button that allows the user to choose the week that he or she desires to repeat the event. Each time the user touched this button, it will change among “1^{st}”, “2^{nd}”, “3^{rd}”, “4^{th}”, “Last”, “On” subsequently and repeatedly. Every time the user touches button 3543, the counter/notifier 311 will inform (in a colloquial language) the defined scheme of repetition. In the example, in (362) of FIG. 36, the message of the counter/notifier 311 is “Repeat every two months on the first Tue”. When button 3543 becomes the “On” button what will be useful when the user wants to repeat the event as for example “on Day 15^{th} of the given month and not resulting from the day of the week as it is the case of the example when “Tue” of the first week was selected (362). It is important to add that the “1^{st}”, “2^{nd}”, “3^{rd}”, “4^{th}”, “Last”, “On” buttons 3543 are enable only if the user has chosen a “Monthly” repetition scheme for the event.

For the cases in which the user desires to enter a final date until when to repeat the event, if a repetition scheme would have been defined, the button “End” 3553 will be enabled (362) of FIG. 36. At the moment the user touched the “End” button, the Panel of Days 32D becomes the Panel of Dates 32A, the “/” button 331 (needed to define a date by the numerical Keypad 34) and the “period” button 333 will be enable for the case that the user had in mind a future period to repeat the event during it (362). The user could also scroll the Panel of Dates 32A to reach future dates but scrolling to the past would be blocked after it is not logical to repeat an event backward in time, and then choose by selecting the desire Date until when he or she pretends the event to be repeated (363).

Different Repetition Schemes that are Possible to Define with Assistant 1000:

a) Daily Repetitions:

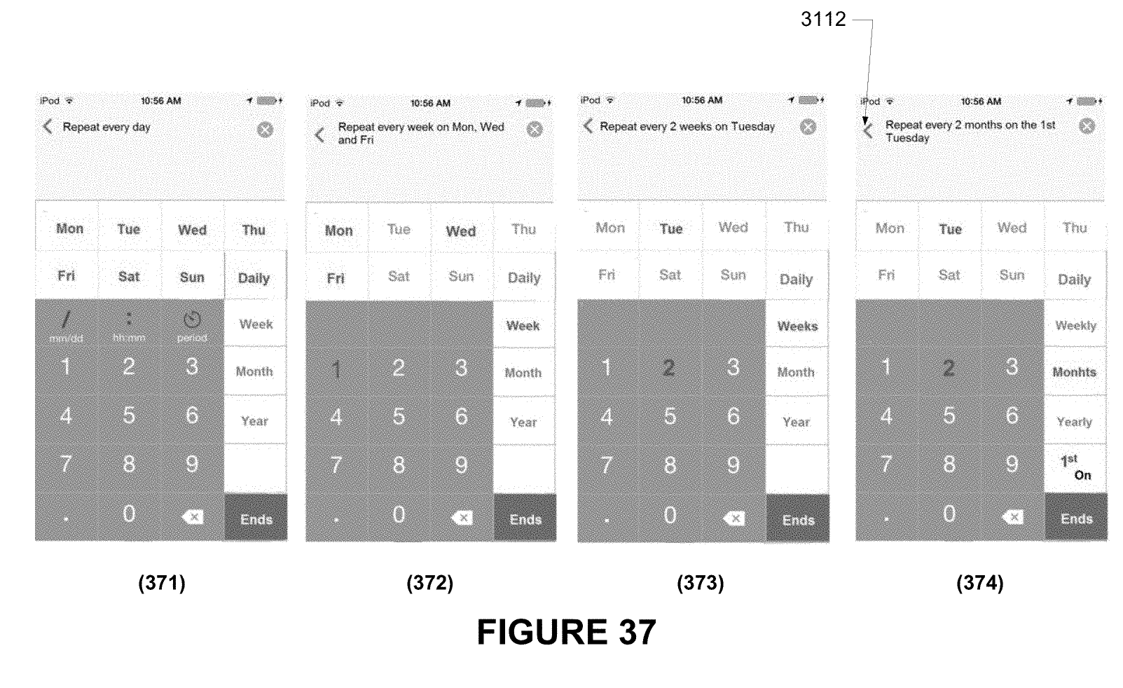

(354) of FIG. 35 shows Interface 2000 in Event Repetition Mode initial view 2500. If in (354) the user touches the “Daily” button 322, both the label of that button and the 7 days of the week buttons will be shown in red indicating that they were selected (371) of FIG. 37. If desired, the user could deselect one or more days of the week touching their respective cells of the days he or she wants to deselect so the color of those button labels will be grey again. In (372) the user deselected “Tue”, “Thu”, “Sat” and “Sun”. Consequently, the “Daily” button 322 will be deselected after the repetition scheme is not “daily” anymore at the moment the user deselects at least one day. If the user touches the “Daily” button 322 again in (372), all the days of the week will be selected again and they will be marked in red consequently resulting in (371).

The numerical Keypad 34 will allow the user to define the repetition “unit” of the defined scheme. (373) shows the case where the user defined “2” by the numerical keypad 34 which refers to the “Weeks” repeating pattern so the “weeks” 3512 button is shown in red as it was selected, and the counter/notifier 311 will inform the resultant scheme of the combination chosen “Repeat every 2 weeks on Tuesday” (373) what is an essential feedback of user's selections.

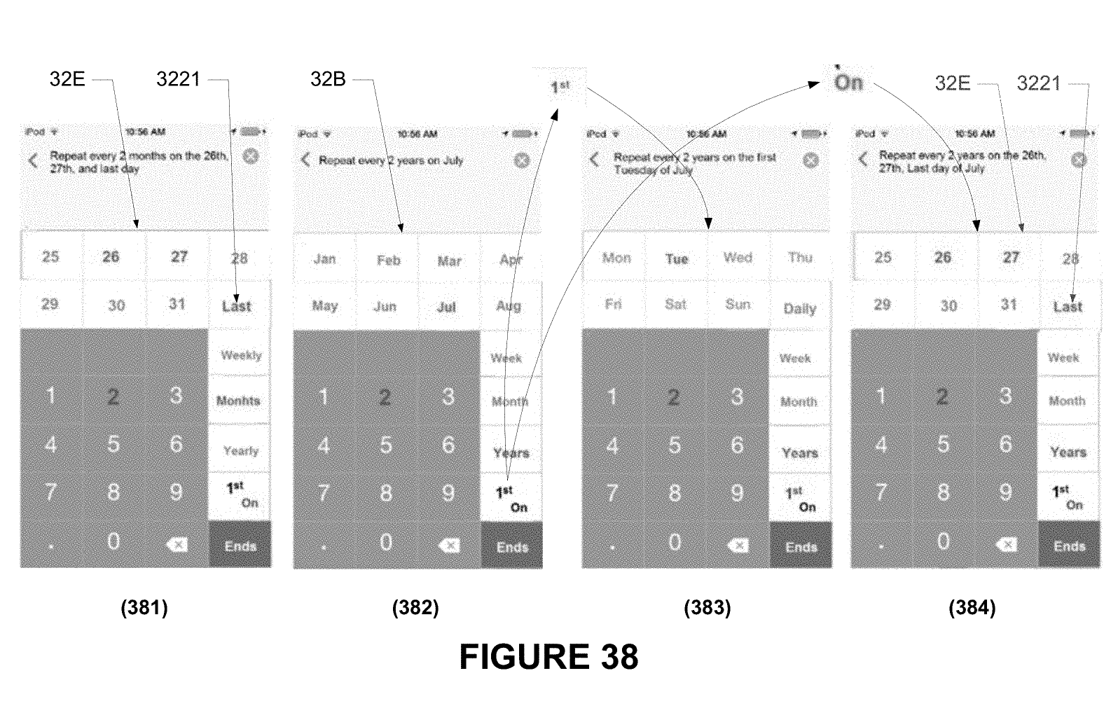

b) Monthly Repetitions: Whichever be the previous selections made by the user, at the moment he or she touches the button “month” 3523, the previous selections will be preserved but they will now refer to a “monthly” pattern. (374) shows the case where in (373) the “months” button 3523 was touched, changing the frequency from “weeks” to “months” but maintaining the selected day “Tue” and the interval “2”. (374) shows the case where the user defined a scheme of Repetition every two months on Tuesdays of the first week, what will be informed by the counter/notifier 311 as “Repeat every 2 months on the 1^{st} Tuesday” (374). At the moment the user touches the “months” button 3523, the button “st/On” 3543 is shown where the enabled option is shown in red “1^{st}” (374). If the user touches the 3523 button again, this button becomes “2^{nd}”, “3^{rd}”, “4^{th}”, “Last” and “On”. “Last” refers to the last week of a month not mattering the number of weeks that months has. When this button becomes “On”, the “timeline panel” 32 will be presented as “the days of the month Panel” 32E which is an scroll panel starting from Day number “1” ending in day “31”, giving also “Last” as an option which refers to the last day of a month not mattering how many days that month has (shown in (381) of FIG. 38). In that Context Achieved 2010 of (381), the user will be able to scroll through “The Days of The Month Panel 32E and choose the number/s of the day/s of each month he or she desires to repeat the event. (381) shows the case where the user defined a repetition scheme every two months on the 26^{th}, 27^{th} and the last day of the month.

c) Annual Repetition: (382) of FIG. 38 shows what happens at the moment the user touches the “year” 3536 button, the 12 Months of the Year will be assigned to the timeline panel 32 which now is the Panel of Months 32B which is an scroll panel starting from month “January” and ending in month “December”, which allow the user to choose the month or months he or she wants to repeat the event. (382) shows the case where the scheme desired was “Repeat every two years on July”. At the moment the user touches on a month, the button “1^{st}/On” 3543 will be shown with labels in black and if the user touches it, 3543 button will be shown in red and through it the user will be able to define which day of which week of July (1^{st}, 2^{nd}, 3^{rd}, 4^{th}, last) he or she desires to repeat the event (383). If the user prefers to choose which Number of Day of the Month, he would have to touch again the button 3543 which will show the label “On” in red and “1^{st}” in black (384). As was previously explained, when button 3543 is “On”, the Timeline panel 32 is presented as the “Days of the month Panel” 32E which will allow the user to define the number/s of the days that he or she wants to repeat the event.

d) Manual selection of dates to repeat an event: There are real life situations where the repetition of an event is not dependent on a repetition pattern but the user may want to “repeat” the event in specific dates according to real life necessities. In this cases, Assistant 1000, through Interface 2000 allows the user to define one by one the dates that he or she wants to repeat the event, being also possible to define a specific time for each date. (364) of FIG. 36 shows the case where the user touches “On Dates” 3543 on (354) of FIG. 35 so the label of the “On Dates” button will become red to indicate selection which will bring Interface 2000 to show the timeline panel 32 as the Panel of Dates 32A and where the days “Thu 10” and “Sun 13” were selected which would result in (365) what is informed by the counter/notifier 311 “Repeat on Jul 10 and Sun 13”. Observe that the Repetition Scheme defined is not about a “Classic repetition pattern”, instead it is composed by specific dates that the user wants to repeat the event on. While the “On Dates” button 3543 is active (Font in red) the user will be able to select the quantity of dates he or she wants, being the user able to scroll the panel of dates 32A to the future but locking it to the past after it is not logical to repeat an event backward in time. To deselect a date, it will be enough for the user to touch the cell of the desire date, what will deselect it.

Acceptance or Rejection of the selected Repetition Scheme defined: Through the upper right button 312 which in this context achieved 2010 is the “Clear display” button 3122, the user will be able to erase the previously defined Repetition Scheme going back to “Interface 2000 in Event Repetition Mode initial view 2500” (354) of FIG. 35.

In any screen, a touch on the counter/notifier 311 or on the “red arrow to the left” button 3112 will be enough to confirm the Repetition Scheme defined so far and at the same time it will make Interface 2000 returns to “Event Creation mode 2300” what is shown in (331) of FIG. 33. From 2300 (331), if the user touches the “Repeat” button 3534, through a dialog box 1255 he or she will be able to edit the predefined repetition scheme. It will be also possible for the user to cancel the repetition scheme defined so far (344).

Finally, from 2300 (331) of FIG. 33, if the user touches the “Cal” button (351) Assistant 1000 will require the OS) to show the New Event Creation panel Interface of the linked Calendar App (323) of FIG. 32 which would show the Repetition Scheme previously defined via Interface 2000 already preloaded.

As was previously described, it can be seen how Assistant 1000 gets value of its Interfaces 2000 (and its variations 2100, 2200, 2300, 2400, 2500 and 2700) to allow the user to define Repetition Schemes of Calendar Events and Schedule Reminders in an almost real life situation, versatile and functional way.

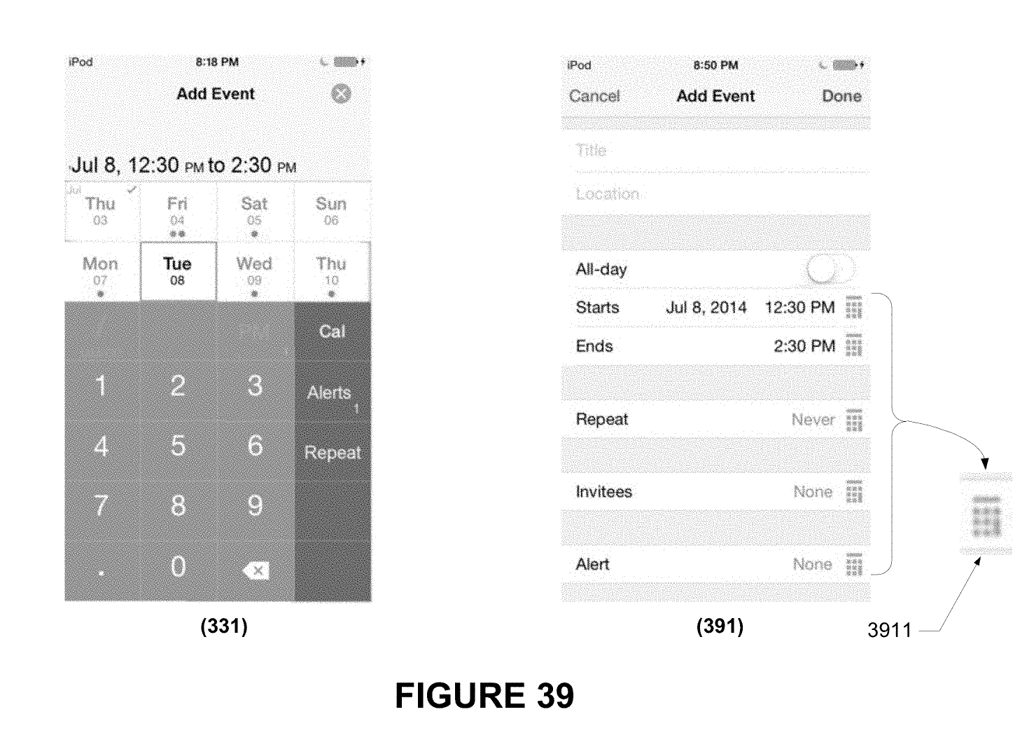

After Assistant 1000 functionality to define time values involved in the creation of Calendar Events and Schedule Reminders, Interface 2000 could also constitute itself as a means to enter time values, being a direct resource for the Operating System as it can be accessed from the same panels of creation or edition of Calendar events, schedule reminders, alarms, timers, and those functionalities to come where were necessary to define time values. FIG. 39 shows a sample panel of New Event Creation of the iOS 7 Calendar App for iPhone 5 where it has been added a button with a “keypad iso” 3911 (391.) that if it were touched would make Interface 2000 appeared in its corresponding view ready for inputs of Time values involved in the Creation of Calendar Events, Schedule Reminders, Alarms and Timers.

9) Month & Year Management Through Assistant 1000:

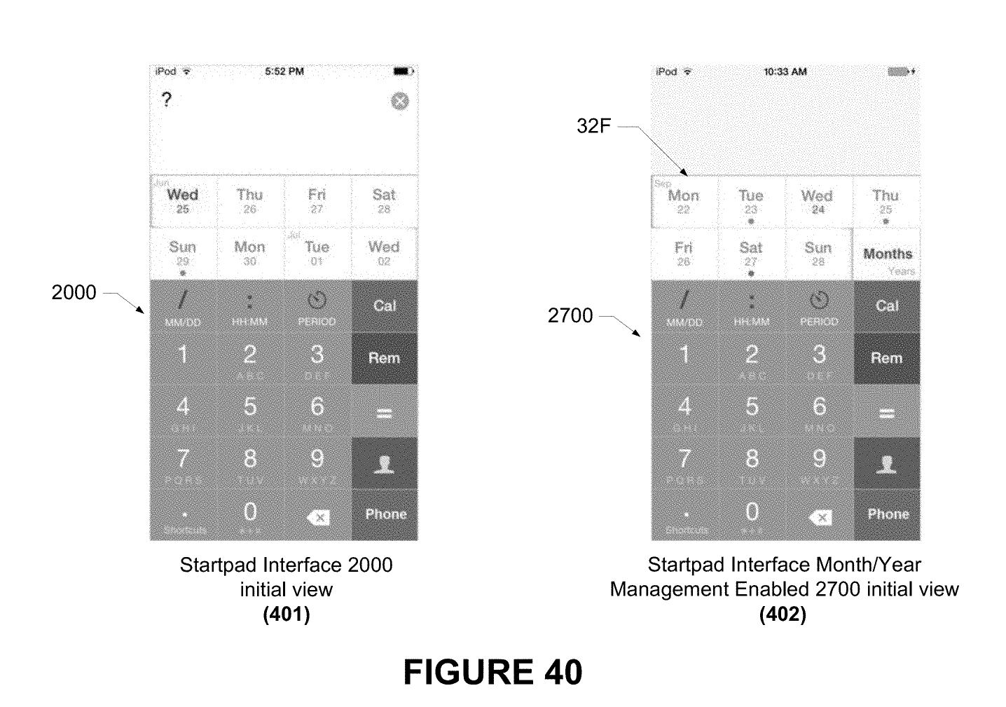

FIG. 40 shows initial view of “Interface 2700 (Month/Year Management functionality enabled)” compared to Interface 2000 initial view.

In this modality, the Timeline Panel 32 becomes the “Panel of Dates (Months-Year functionality enable)” 32F which shows the “Days of the Weeks” where cell “1” is assigned to Monday, cell “2” to Tuesday, cell 3 to Wednesday, and so on; but in Cell “8” the “Months/Year” button 32F2 (523) is enable which is a fixed button (not affected by the scroll of the timeline panel 32 (now acting as 32F). For Assistant 1000, single touch on the “Months/Years” button means “Months” and Long press means Years”.

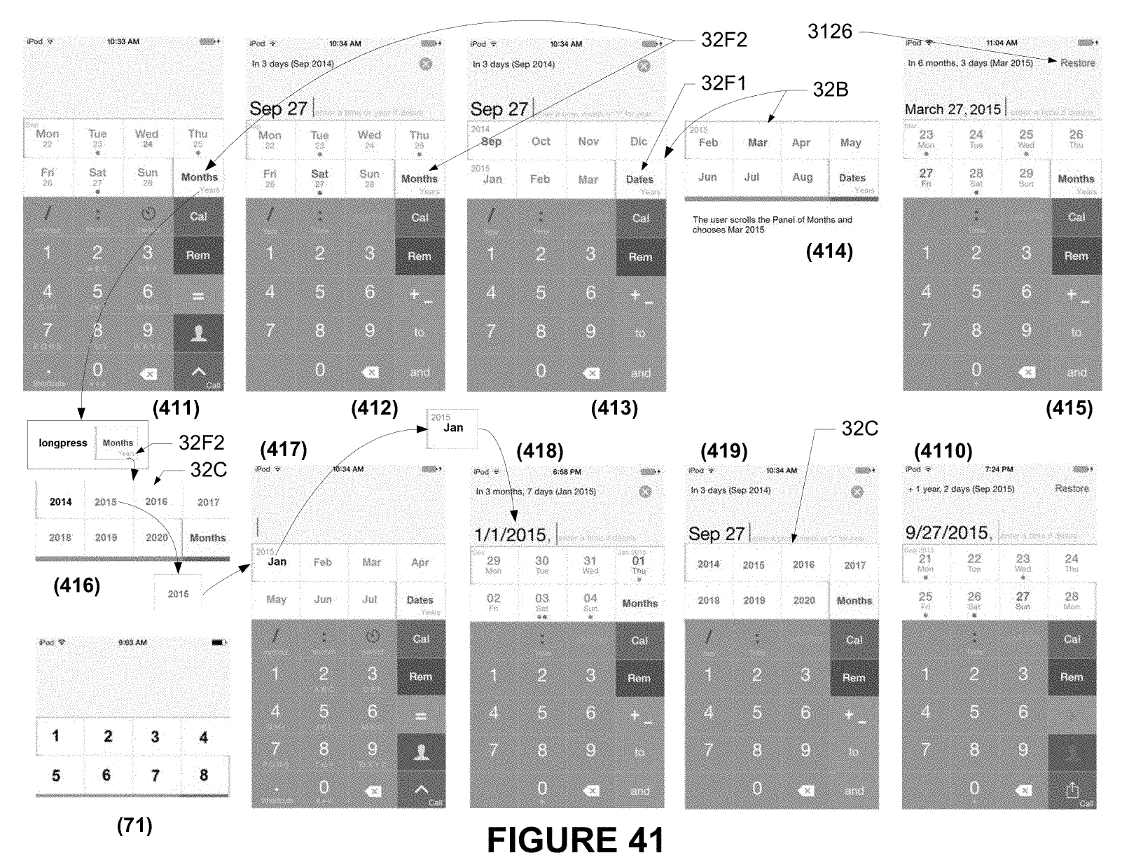

For the purpose of this explanation, in FIG. 41 selected dates are shown in light blue font.

9.1) Month Management Through the “Panel of Months” 32B of Interface 2700:

In FIG. 41, (412) shows the case where starting from Interface 2700 (411), the user defined date “Sep 27” of present year. In this Context Achieved 2010, the user will now have the “month/Year” button 32F2 available.

In (412), if the user touches button 32F2 it will result in (413) where it can be appreciate that according to process flow and Context Achieved 2010 the Timeline panel has become “The panel of months” 32B showing in cell 1 the month (in blue font) “Sep 2014” which corresponds to the previously defined date “Sep 27”, the following month on cell “2” “Oct” and so on up to in Cell 8 the button “Dates” 32F1 will be now available. For the case no date had been previously defined, at the moment enables the “panel of months” 32B after having touched the “months” button 32F1 on 32F, the display main view area 313 of Interface 2700 would display the first day of that month and from that context achieved 2010 the user could proceed (not exemplified).

In addition to the features of Assistant 1000 about Management of Time that have been previously explained in this Patent Application, the user could also get value of the versatility of the “Panel Months” 32B scroll ability to jump backward and forward in time by months in a quick and intuitive way. For example, If in (413) the user scrolls the “Panel of Months” 32B to the future, Interface 2700 main display area 313 will continue showing the originally defined number of day “27th” but according to the month which corresponds to the month shown in cell 1 of the “Panel of Months” 32B. If in (413) the user scrolls the panel of months 32B to the future and touches “Mar” (414), it would result the Context Achieved 2010 shown in (415) where it can be appreciate that the Panel of Months 32B became the “Panel of Dates 32F again showing the 27^{th} of March of 2015 as selected in Cell 5 after it corresponds to the day of the week “Fri” which falls on the “27th” day of the chosen month and the legend “March 27, 2015” will be shown on Interface 2700 display main view area 313. Pay attention that in (415), the “Dates” button 32F1 became the “Months” button 32F2 for the case that the user desires to jump quickly to another month.

Pay attention that at the moment the user started scrolling the “Panel of Months” 32B in (413), after date “Sep 27” had been previously defined in (412), as Assistant 1000 through Interface 2700 changing the months shown according to what Month is shown in cell 1of 32B in every moment of the scroll, in the upper right button area 312 the “Restore” button 3126 (415) appears that if touched by the user would produce that Assistant 1000 restores the original context achieved 2010 about date “Sep 27, 2014” (412).

9.2) Year Management Through the “Panel Years” 32F Through Interface 2700:

In FIG. 41, In an analog way as explained before, if the user long press the “Month/Year” button on the “Panel of Dates (Months-Year functionality enable)” 32F (411), the “Panel of Years” 32C will be available by interface 2700 resulting in (416) where it can be seen that the Year which correspond to present time “2014” will be shown in black font on cell 1, next year on cell 2 and so on. By the panel of years 32C, the user will be able to scroll by year forward or backward in time to quickly choose by single touch the cell that contained the desired Year that he or she could have in mind. (417) shows the case where the user selected Year “2015” by 32C where it can be seen that the panel of years 32C became the panel of month 32B showing in Cell 1 the first Month “Jan” of the Selected Year “2015” in black and that if Cell 1 were touched, it will result in Context Achieved 2010 (418) where Interface 2700 would show: (a) on Cell 4 of the “Panel of Dates 32A the 1^{st} date of the selected month “Jan 2015” (on cell “4” as “Thu” is the 4^{th} Day of the Week and after how Interface 2700 assigns the Days of the Week to Cells in 32F); (b) On display main view area 313 the resultant string of Date/Time “1/1/2015” and the place holder 1254 “enter a time if desire”; (c) the counter/notifier 311 informing how far in time is the resultant date “In 3 months, 7 days”. From that Context Achieved 2010 showed in (418) the user could proceed with his or her intentions. In addition, if in that Context Achieved 2010 of (418), the user realized that “Thu” were not a proper Day of the Week according to his or her intentions, he or she would be able to choose another Date by 32F.

For the case that the user had long pressed the “Month/Years” button 32F2 on (412) (where date “Sep 27” had been previously defined by the user), the resultant view would have been (419) were the panel of years 32C will be shown so the user would be able to change the Year but maintain the previously selected Date “Sep 27”. (4110) shows the case where the user touched “2015” in the panel of years 32C where it can be seen that “Sep 27” was preserved but now it correspond to Year “2015”. Pay attention in (4110) that the counter/notifier informs “+1 year, 2 days (Sep 2015) which is an essential piece of information in the context of time achieved 2010.

As it can be seen in (4110), in the upper right button area 312 the “Restore” button 3126 is now available, that if touched it would restore Interface 2700 to (412). If the year which corresponds to the previously selected date “2014” (shown in light blue in (419)), disappeared from view by a user action of scroll on 32C, then, “Sep 27” (the previously defined date) will start changing the year which belonged to, in favor of the year that Cell “1” shows at each moment of the scroll movement and the Restore button 3126 would allow the user to restore the context achieved 2010 what was previously shown in (419).

It can be concluded so far, that Assistant 1000 constitutes itself as a unified input method to interface with Time as functionalities of Alarms, Timers, Schedule Reminders, Calendars that up to date has been defined after their own interfaces. Assistant 1000 understanding of Time is about moments (Date and Time) along a Timeline, being those moments precisely defined by the numerical Keypad combined with “/” and “:” time operators; or via Interface 2000 intuitive Time line panel 32 acting as Panel of dates 32A, Panel of months 32B or Panel of Years 32F; or by the “Period” functionality 332.

In addition, the advance Time Management functionalities of the “to”, “+”, “−”, “and” Time operators and how Assistant 1000 allows the definition of Time parameters involved in the process of creation and edition of Calendar Events and Schedule Reminders/tasks; altogether results in a true evolution about how mankind would be able to manage TIME, as Calculators have done so far with mathematical calculations. It can be said that Assistant 1000 is the first Calculator of Time.

10) Restore Functionality:

As it has been explained so far in this patent application, the initial view of Interface 2000 and its variations 2100, 2200, 2300, 2400, 2500 and 2700 show on display no previous session information. This is after one of the main purposes of Assistant 1000 is to be ready for new user inputs.

Consequently it could be concluded that any interrupted process started in the previous session, would result in loss of that previous process flow and context achieved 2010.

In FIG. 41 it will be exemplified how Assistant 1000 handles this problem.

Suppose that Assistant 1000 were installed on a touch screen mobile phone device.

(411) shows a cropped area of Interface 2000 initial view being ready for new user inputs (session 1). (412) shows the resultant view of having the user defined the string “Oct 19, 12:30 AM” through Interface 2000. Let's suppose that an interruption is produced by an incoming call. Consequently, the App that the OS had assigned to manage incoming calls will overrides Assistant 1000 sending it to background or closing it (depending on the OS own characteristic of managing situations like this) so the user could handle the incoming phone call by the Phone App interface. Another kind of interruption could be produced by the user himself sending Assistant 1000 to background.

(413) shows the next time the user launches Assistant 1000 after been sent to background) (Session 2) where Interface 2000 initial view shows in the upper right button area 312 the “Restore” button 3126 alerting the user that a previous session process was aborted.

On one hand, for the case that the user had in mind to recover the previous session process and context achieved 2010 that was aborted in Session 1, he or she should touch the Restore button 3126 on (413) which would restore the exact view of the aborted process and Context Achieved of Session 1 resulting in (412) again so the user could retake that process at the same stage it was aborted and then proceed with his or her intentions.

On the other hand, being in Session 2, for the case the user launches Assistant 1000 but not thinking in the last session aborted process (perhaps he forgot it or simply he does not care about it) he or she would proceed with his or her new intentions not taking into account the Restore button 3126 shown in (413). (414) shows the case where in Session 2, it is assumed that the user's new intention were about entering number “856”. Pay attention that the action of entering new values by the user produces the concealment of the “Restore” button 3126, but Assistant 1000, beyond the “Restore” button 3126 is no longer visible (414), will keep in long term memory 1264 (inter-session memory) the information needed to restore the previous session aborted process and Context Achieved 2010 (412). Thus, the next time the user launches Assistant 1000 again (session 3), Interface 2000 initial view will show the “Restore” button 3126 again for him or her to touch it if desired to restore previous sessions aborted processes (415).

It is important to add that Assistant 1000 long term memory 1264 capability will be able to retain more than one session aborted process so every time Interface 2000 initial view shows the “Restore” button 3126 alerts the user about the existence of previous sessions' aborted processes which are kept ready to be shown by touching the “Restore” button 3126.

(417) shows the Interface 2000 initial view of session 4 been ready (clean) for new user inputs and at the same time the “Restore” button 3126. (417) also what result for the case that he or she touched the Restore button. Backwards implications are also exemplified by FIG. 50 connectors which shows the sequence (follow the connectors of FIG. 41 from (417) to (412)) of backward reconstruction of previous sessions aborted processes. For instance, if in (417) the user touches the Restore button 3126, (416) would be restore so the user could see if number “+5492604672713” is what he or she wants to restore. If “+5492604672713” were not what the user had in mind to restore, he or she would have to touch the Clear Display Button 3122 on (416) discarding “+5492604672713” so (414) would instantly be restored showing session 2 user input “856” (414) so if “856” what was the user wanted to recover, then he could proceed from there; but if “856” were not what he or she wanted to recover, then in (414) the user would have to touch the Clear Display Button 3122 discarding “856” as it seems it is not what he wants to restore and consequently (412) would instantly be restored showing session 1 aborted context achieved 2010 “Oct 19, 12:30 AM” for the user to retake that aborted process.

Thus, any time Interface 2000 initial view shows the Restore button 3126, it is a sign that previous sessions aborted process are kept In memory to be restore it desire. This way, the user will not have to worry about losing data of old session's aborted processes.

This is how Interface 2000 initial view being always clean of entries (been ready for new user inputs) allows the user at the same time, the possibility to restore previous session's aborted processes by the Restore button 3126.

11) Hardware and Operating System Overview:

As Interface 2000 is a graphical interface, Assistant 1000 must be implemented as software on a computing device operated by a graphical interface or touch screen graphical interface Operating System.

About linked Apps and Assistant 1000 Functionalities:

Depending on the level of access granted by the OS and Apps related to Assistant 1000 functionalities, its permissions and or URL schemes published or available, and also considering the kind of product to build after the present invention, it will result the final specification of Assistant 1000.

Due to Assistant 1000 own characteristic to be a means to Start Processes that could be ended with specific linked Apps, for those purposes it needs those Apps/Services or OS functionalities to be installed and or available on the device managed by the OS that grants Assistant 1000 to start the necessary processes by Interface 2000 and at a certain point of Assistant 1000 internal process 1250 and or according to User desires as to Context Achieved 2010, to proceed then with the respective linked App interfaces. For example, Assistant 1000 could be a means to define time values involved in the creation of new Calendar Events, as far as a Calendar/s App or functionality were installed and or enabled in the computing device where Assistant 1000 were running and with which it were able to interact.

For the cases that an OS or an specific App allowed Assistant 1000 to access, read or modify data related to data stored in the Device and/or in the cloud, but not grant access to the linked Apps own interfaces showing preloaded on them the values previously entered through Interface 2000, to achieve a satisfactory user experience it could be necessary in some cases to build specific views to allow the user to end the processes to later execute a specific action if desired. The specifics of creating such specific views are not needed for a proper understanding of the invention as described herein.

1. An Automated Assistant operating in a graphical interface operated computer device which interfaces with a user by an Adaptive Graphical User Interface to perform mathematical calculations; provide telephone operations; input of text; search contacts, define and manage of Time & dates values and their utilization in the creation or edition of Calendar Events, Schedule Reminders/Tasks, Timers and Alarms and local or remote services able to process the kind of data produced by the Assistant.

2. According to claim “1”, wherein: an input method consisting of an adaptive keypad interface managed by a system with software components to allow the user to enter and define numerical values, time & date values, words, to build useful information that can result useful by itself or to be passed to local or remote services and Apps able to process that data.

3. According to claim “2”, wherein: a Smart Adaptive Keypad Interface built around a numerical 4×3 keypad. The structure of the adaptive keypad interface consisting in: a Display which shows user inputs, system outputs and supplementary information about the outputs for a better comprehension; an scrollable panel of dates; three special buttons to define dates, times and period of times; a numerical keypad with a 4×3 layout; a dock containing buttons for actions according to the kind of input of the user, system output according to process flow.

4. According to claim “3”, wherein: the smart adaptive keypad interface, without altering its layout, adapts/conceals pertinent buttons according to user inputs and process flow as software components disambiguate user inputs and analyze process flow.

5. According to claim “3”, wherein: after time, date, date/time, numbers, phone numbers and the kind of outputs the assistant is able to produce, when obtained, action buttons to related app or services are available for the user to pass those values to perform an specific task, for example to create a calendar event on the date and time defined through the assistant by its adaptive interface.

6. According to claim “4”, where in: a “Triple Time Input Method System” which allow the user to define times, dates, date/time through three different synchronized methods.

7. According to claim “6”, wherein: one method is by writing a time, date, date/time string using the numerical keypad using the “/” to define dates and “:” to define hours and minutes according to the regional format set in the system where the assistant were installed.

8. According to claim “6”, wherein: another method is by using the numerical keypad and the “Period” functionality that allows the user to add a period of time to a defined time, date, date/time resulting in a specific future time, date or date/time. The kind of period to be added are minutes, hours, days, nights, weeks, workweeks, weekdays months, years and any other period of time representation.

9. According to claim “6”, wherein: the last method is by using the “Panel Of Dates” as an input method touching or clicking its cells, scrollable to the future and to the past.

10. According to claim “6”, wherein: the system comprises the input methods cited in claims “7”, “8” and “9”; the provision of context of time by the “Panel of Dates” as beyond being and input method is also an informative means of timed events fetch from the system (calendar events, schedule reminders, alarms and any other form of time representation available, local or remote). Thus, the user has context available at the same moment he or she defines time and date values through any of the three method cited in “7”, “8” and “9”.

11. According to claim “6”, wherein: methods of claims “7”, “8” and “9” are enabled simultaneously without order so the user can enter a date through method of claim “8” and next change that date or add an hour for that date through the numerical keypad using method of claim “7”. The use of any of the three methods of claims “7”, “8” and “9” can be performed without starting over the process already started.

12. According to claim “6” wherein: a method to define Calendar Event Alerts without limiting the user to fix preset values.

13. According to claim “6” wherein: a method to define Calendar Event Repetition Schemes without being tight to preset values.

14. According to claim “6”, wherein: A new input method and edition of time values.

15. An algebraic mathematical system to calculate time wherein: advance features of time management can be performed to calculate and/or define strings of time of different types, needed just for information and/or for calendar event creation, schedule reminders, multiple events and multiple alarms and also to pass that strings of time to remote services like booking hotels, reserve flights, etc.

16. According to claim “15”, wherein: a method comprising special time functions through operators “TO”, “AND”, “+”, “−” allowing the user to define complex time related strings.

17. According to claim 16, wherein: The “to” operator allows the user to define periods of time between two times, dates (or date/time), not mattering if those dates belong to the past or the future.

18. According to claim 16, wherein: The “+” operator allows the user to add a period of time to a time, date (or date-time) previously defined not mattering if the date predefined belongs to the past or to the future.

19. According to claim “16” wherein: The “−” operator allows the user to subtract a period of time from a time, Date (or date and time) previously defined by the assistant not mattering if the predefined date belongs to the past, present or to the future.

20. According to claim “16” wherein: The “and” operator allows the user to group different times, dates (or date-time) to proceed with action/s related to the grouped dates such as creation of multiple calendar events in a single process.
